(19) United States
(12) Patent Application Publication
(10) Pub. No.: US 2025/0056560 A1
(43) Pub. Date: Feb. 13, 2025

(54) FREQUENCY SELECTIVE BEAM MANAGEMENT

(71) Applicant: Samsung Electronics Co., Ltd., Suwon-si (KR)

(72) Inventors: Dalin Zhu, Allen, TX (US); Emad Nader Farag, Flanders, NJ (US); Eko Onggosanusi, Coppell, TX (US); Jianhua Mo, Allen, TX (US); Young Han Nam, Plano, TX (US)

(21) Appl. No.: 18/783,210

(22) Filed: Jul. 24, 2024

Related U.S. Application Data
(60) Provisional application No. 63/531,150, filed on Aug. 7, 2023.

(51) Int. Cl. H04W 72/232; H04L 5/00; H04W 72/0453

(52) U.S. Cl. CPC H04W 72/232; H04L 5/0091; H04W 72/0453

(57) ABSTRACT

Methods and apparatuses for frequency selective beam management. A method performed by a user equipment (UE) includes receiving first information related to a plurality of frequency subbands and receiving, in a first part of a downlink control information (DCI), at least one first transmission configuration indication (TCI) state and second information related to a second part of the DCI. The method further includes determining, based on the first information, a first association between the plurality of frequency subbands and the at least one first TCI state; for a first frequency subband from the plurality of frequency subbands, determining a first TCI state based on the first association; and identifying, based on the determined first TCI state, a spatial domain filter for transmitting or receiving UE-dedicated channels or signals for the first frequency subband.

### CROSS-REFERENCE TO RELATED AND CLAIM OF PRIORITY

The present application claims priority under 35 U.S.C. § 119(e) to U.S. Provisional Patent Application No. 63/531,150 filed on Aug. 7, 2023, which is hereby incorporated by reference in its entirety.

### TECHNICAL FIELD

The present disclosure relates generally to wireless communication systems and, more specifically, the present disclosure relates to methods and apparatuses for frequency selective beam management.

### BACKGROUND

Wireless communication has been one of the most successful innovations in modern history. Recently, the number of subscribers to wireless communication services exceeded five billion and continues to grow quickly. The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance. To meet the demand for wireless data traffic having increased since deployment of 4G communication systems, and to enable various vertical applications, 5G communication systems have been developed and are currently being deployed.

### SUMMARY

The present disclosure relates to frequency selective beam management.

Other technical features may be readily apparent to one skilled in the art from the following figures, descriptions, and claims.

In one embodiment, a user equipment (UE) is provided. The UE includes a transceiver configured to receive first information related to a plurality of frequency subbands and receive, in a first part of a downlink control information (DCI), at least one first transmission configuration indication (TCI) state and second information related to a second part of the DCI. The UE further includes a processor operably coupled with the transceiver. The processor is configured to determine, based on the first information, a first association between the plurality of frequency subbands and the at least one first TCI state; for a first frequency subband from the plurality of frequency subbands, determine a first TCI state based on the first association; and identify, based on the determined first TCI state, a spatial domain filter for transmitting or receiving UE-dedicated channels or signals for the first frequency subband. The at least one first TCI state is indicated by a TCI codepoint of a TCI field or by separate TCI fields.

In another embodiment, a base station (BS) is provided. The BS includes a transceiver configured to transmit first information related to a plurality of frequency subbands and transmit, in a first part of a DCI, at least one first TCI state and second information related to a second part of the DCI. The BS further includes a processor operably coupled with the transceiver. The processor is configured to determine, based on the first information, a first association between the plurality of frequency subbands and the at least one first TCI state; for a first frequency subband from the plurality of frequency subbands, determine a first TCI state based on the first association; and identify, based on the determined first TCI state, a spatial domain filter for transmitting or receiving user equipment (UE)-dedicated channels or signals for the first frequency subband. The at least one first TCI state is indicated by a TCI codepoint of a TCI field or by separate TCI fields.

In yet another embodiment, a method performed by a UE is provided. The method includes receiving first information related to a plurality of frequency subbands and receiving, in a first part of a DCI, at least one first TCI state and second information related to a second part of the DCI. The method further includes determining, based on the first information, a first association between the plurality of frequency subbands and the at least one first TCI state; for a first frequency subband from the plurality of frequency subbands, determining a first TCI state based on the first association; and identifying, based on the determined first TCI state, a spatial domain filter for transmitting or receiving UE-dedicated channels or signals for the first frequency subband. The at least one first TCI state is indicated by a TCI codepoint of a TCI field or by separate TCI fields.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example gNodeB (gNB) according to embodiments of the present disclosure;

FIG. 3 illustrates an example UE according to embodiments of the present disclosure;

FIGS. 4A and 4B illustrates an example of a wireless transmit and receive paths according to embodiments of the present disclosure;

FIG. 5A illustrates an example of a wireless system according to embodiments of the present disclosure;

FIG. 5B illustrates an example of a multi-beam operation according to embodiments of the present disclosure;

FIG. 6 illustrates an example of a transmitter structure for beamforming according to embodiments of the present disclosure;

FIG. 7 illustrates an example of an antenna array structure for hybrid beamforming according to embodiments of the present disclosure;

FIG. 8 illustrates an example of beamforming according to embodiments of the present disclosure;

FIG. 9 illustrates a diagram of an example joint phase-time array (JPTA) architecture according to embodiments of the present disclosure;

FIG. 10 illustrates an example architecture for frequency selective beamforming according to embodiments of the present disclosure;

FIG. 11 illustrates a diagram of an example two-part DCI for frequency-selective beam indication according to embodiments of the present disclosure;

FIG. 12 illustrates tables of example TCI state(s) indication in part 1 and part 2 of a two-part DCI according to embodiments of the present disclosure;

FIG. 13 illustrates tables of example TCI state(s) indication in part 1 and part 2 of a two-part DCI according to embodiments of the present disclosure;

FIG. 14 illustrates a diagram of an example two-part beam indication DCI for frequency-selective beam indication according to embodiments of the present disclosure;

FIG. 15 illustrates a diagram of an example beam application time for a two-part beam indication DCI for frequency-selective beam indication according to embodiments of the present disclosure;

FIG. 16 illustrates a diagram of an example beam application time for a two-part beam indication DCI for frequency-selective beam indication according to embodiments of the present disclosure;

FIG. 17 illustrates a diagram of an example beam application time for a two-part beam indication DCI for frequency-selective beam indication according to embodiments of the present disclosure; and

FIG. 18 illustrates an example method performed by a UE in a wireless communication system according to embodiments of the present disclosure.

### DETAILED DESCRIPTION

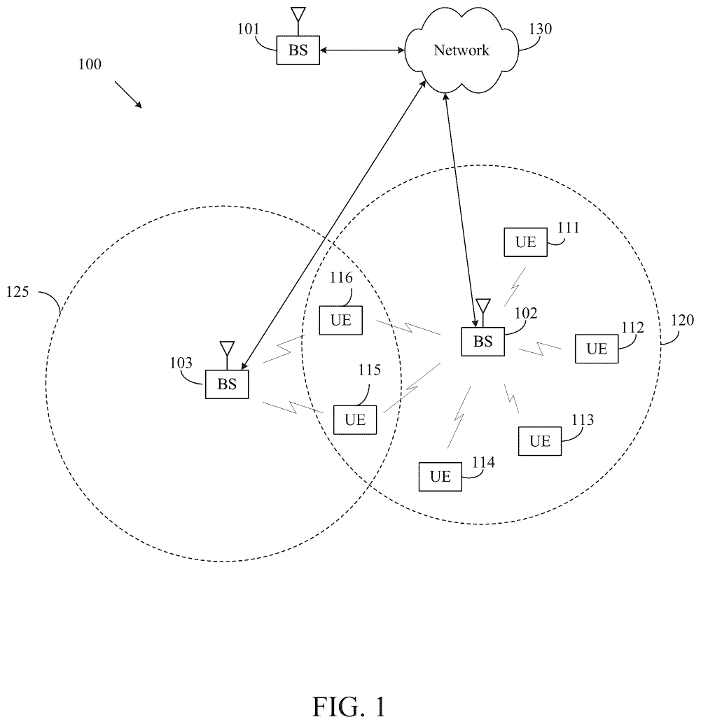

FIGS. 1-18, discussed below, and the various, non-limiting embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems, and to enable various vertical applications, 5G/NR communication systems have been developed and are currently being deployed. The 5G/NR communication system is implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G, or even later releases which may use terahertz (THz) bands.

The following documents and standards descriptions are hereby incorporated by reference into the present disclosure as if fully set forth herein: [1]3GPP TS 38.211 v16.1.0, “NR; Physical channels and modulation;” [2]3GPP TS 38.212 v16.1.0, “NR; Multiplexing and Channel coding;” [3]3GPP TS 38.213 v16.1.0, “NR; Physical Layer Procedures for Control;” [4]3GPP TS 38.214 v16.1.0, “NR; Physical Layer Procedures for Data;” [5]3GPP TS 38.321 v16.1.0, “NR; Medium Access Control (MAC) protocol specification;” and [6]3GPP TS 38.331 v16.1.0, “NR; Radio Resource Control (RRC) Protocol Specification.”

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to how different embodiments may be implemented. Different embodiments of the present disclosure may be implemented in any suitably arranged communications system.

FIG. 1 illustrates an example wireless network 100 according to embodiments of the present disclosure. The embodiment of the wireless network 100 shown in FIG. 1 is for illustration only. Other embodiments of the wireless network 100 could be used without departing from the scope of this disclosure.

As shown in FIG. 1, the wireless network 100 includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, longterm evolution (LTE), longterm evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

The dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof for utilizing frequency selective beam indication. In certain embodiments, one or more of the BSs 101-103 include circuitry, programing, or a combination thereof to support frequency selective beam indication.

Although FIG. 1 illustrates one example of a wireless network, various changes may be made to FIG. 1. For example, the wireless network 100 could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

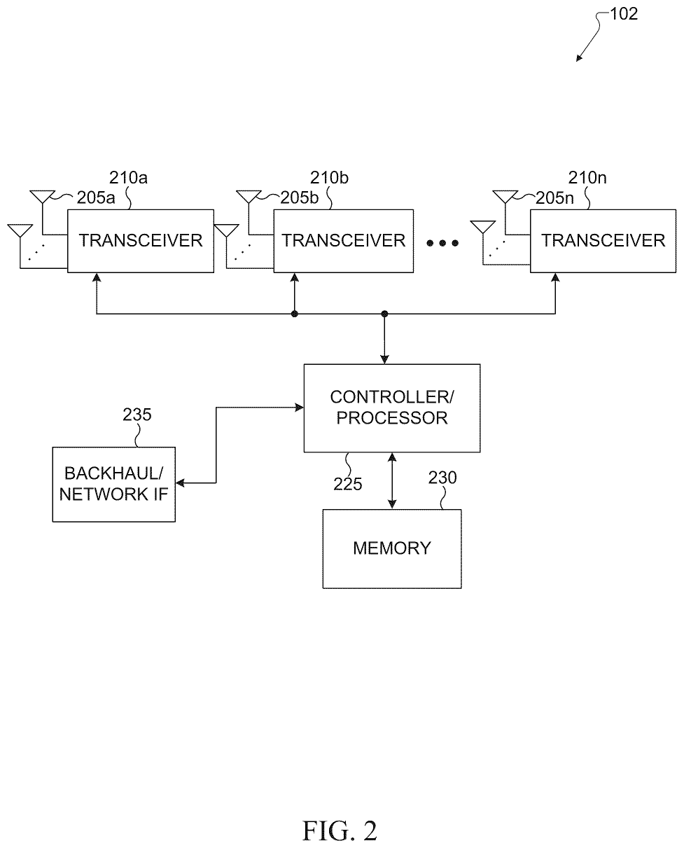

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming radio frequency (RF) signals, such as signals transmitted by UEs in the wireless network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of uplink (UL) channel signals and the transmission of downlink (DL) channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as supporting frequency selective beam indication. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

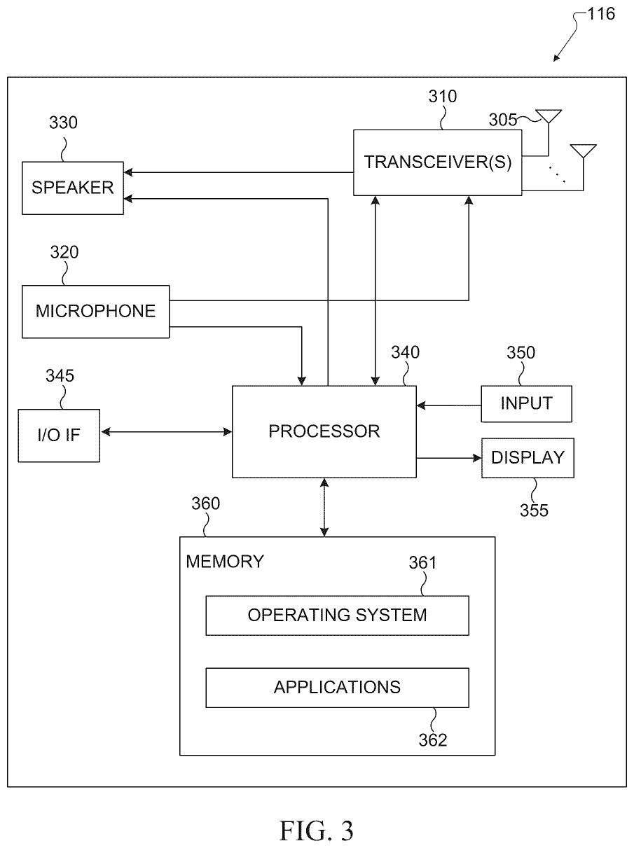

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna(s) 305, an incoming RF signal transmitted by a gNB of the wireless network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the ULE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360. For example, the processor 340 may execute processes to utilize and/or identify frequency selective beam indication as described in embodiments of the present disclosure. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes, for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

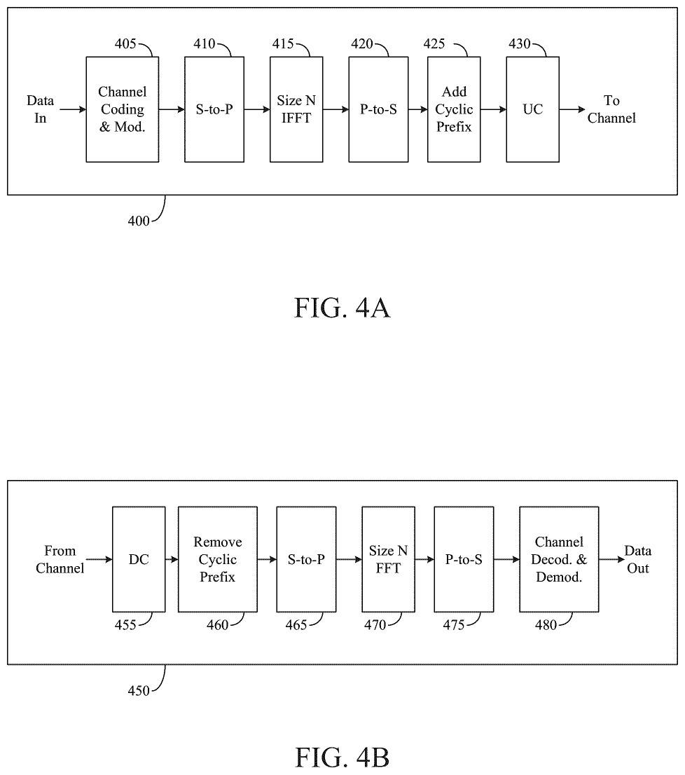

FIG. 4A and FIG. 4B illustrate an example of wireless transmit and receive paths 400 and 450, respectively, according to embodiments of the present disclosure. For example, a transmit path 400 may be described as being implemented in a gNB (such as gNB 102), while a receive path 450 may be described as being implemented in a UE (such as UE 116). However, it will be understood that the receive path 450 can be implemented in a gNB and that the transmit path 400 can be implemented in a UE. In some embodiments, the transmit path 400 and/or receive path 450 is configured to support frequency selective beam indication as described in embodiments of the present disclosure.

As illustrated in FIG. 4A, the transmit path 400 includes a channel coding and modulation block 205, a serial-to-parallel (S-to-P) block 410, a size N Inverse Fast Fourier Transform (IFFT) block 415, a parallel-to-serial (P-to-S) block 420, an add cyclic prefix block 425, and an up-converter (UC) 430. The receive path 250 includes a down-converter (DC) 455, a remove cyclic prefix block 460, a S-to-P block 465, a size N Fast Fourier Transform (FFT) block 470, a parallel-to-serial (P-to-S) block 475, and a channel decoding and demodulation block 480.

In the transmit path 400, the channel coding and modulation block 405 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 410 converts (such as de-multiplexes) the serial modulated symbols to parallel data in order to generate N parallel symbol streams, where N is the IFFT/FFT size used in the gNB 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to a RF frequency for transmission via a wireless channel. The signal may also be filtered at a baseband before conversion to the RF frequency.

As illustrated in FIG. 4B, the down-converter 455 down-converts the received signal to a baseband frequency, and the remove cyclic prefix block 460 removes the cyclic prefix to generate a serial time-domain baseband signal. The serial-to-parallel block 465 converts the time-domain baseband signal to parallel time-domain signals. The size N FFT block 470 performs an FFT algorithm to generate N parallel frequency-domain signals. The (P-to-S) block 475 converts the parallel frequency-domain signals to a sequence of modulated data symbols. The channel decoding and demodulation block 480 demodulates and decodes the modulated symbols to recover the original input data stream.

Each of the gNBs 101-103 may implement a transmit path 400 that is analogous to transmitting in the downlink to UEs 111-116 and may implement a receive path 450 that is analogous to receiving in the uplink from UEs 111-116. Similarly, each of UEs 111-116 may implement a transmit path 400 for transmitting in the uplink to gNBs 101-103 and may implement a receive path 450 for receiving in the downlink from gNBs 101-103.

Each of the components in FIGS. 4A and 4B can be implemented using only hardware or using a combination of hardware and software/firmware. As a particular example, at least some of the components in FIGS. 4A and 4B may be implemented in software, while other components may be implemented by configurable hardware or a mixture of software and configurable hardware. For instance, the FFT block 470 and the IFFT block 415 may be implemented as configurable software algorithms, where the value of size N may be modified according to the implementation.

Furthermore, although described as using FFT and IFFT, this is by way of illustration only and should not be construed to limit the scope of this disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 4A and 4B illustrate examples of wireless transmit and receive paths 400 and 450, respectively, various changes may be made to FIGS. 4A and 4B. For example, various components in FIGS. 4A and 4B can be combined, further subdivided, or omitted and additional components can be added according to particular needs. Also, FIGS. 4A and 4B are meant to illustrate examples of the types of transmit and receive paths that can be used in a wireless network. Any other suitable architectures can be used to support wireless communications in a wireless network.

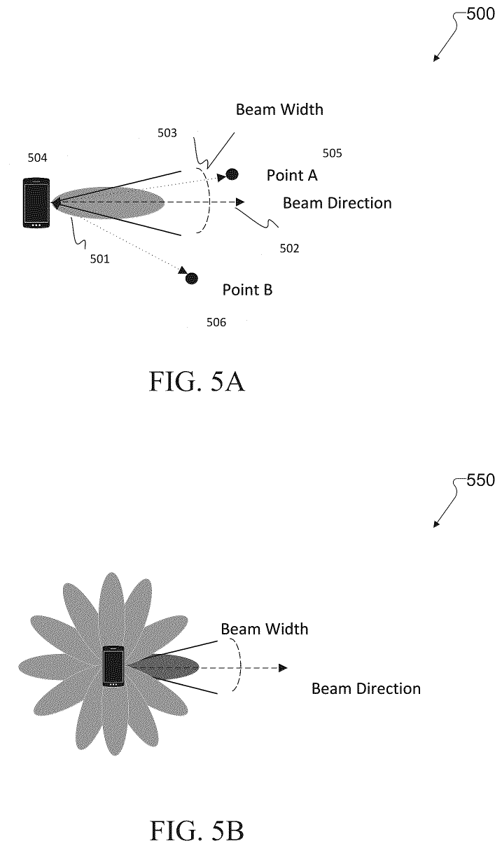

As illustrated in FIG. 5A, in a wireless system 500, a beam 501 for a device 504 can be characterized by a beam direction 502 and a beam width 503. For example, the device 504 (or UE 116) transmits RF energy in a beam direction and within a beam width. The device 504 receives RF energy in a beam direction and within a beam width. As illustrated in FIG. 5A, a device at point A 505 can receive from and transmit to device 504 as Point A is within a beam width and direction of a beam from device 504. As illustrated in FIG. 5A, a device at point B 506 cannot receive from and transmit to device 504 as Point B 506 is outside a beam width and direction of a beam from device 504. While FIG. 5A, for illustrative purposes, shows a beam in 2-dimensions (2D), it should be apparent to those skilled in the art, that a beam can be in 3-dimensions (3D), where the beam direction and beam width are defined in space.

FIG. 5B illustrates an example of a multi-beam operation 550 according to embodiments of the present disclosure. For example, the multi-beam operation 550 can be utilized by UE 116 of FIG. 3. This example is for illustration only and other embodiments can be used without departing from the scope of the present disclosure.

In a wireless system, a device can transmit and/or receive on multiple beams. This is known as “multi-beam operation”. While FIG. 5B, for illustrative purposes, a beam is in 2D, it should be apparent to those skilled in the art, that a beam can be 3D, where a beam can be transmitted to or received from any direction in space.

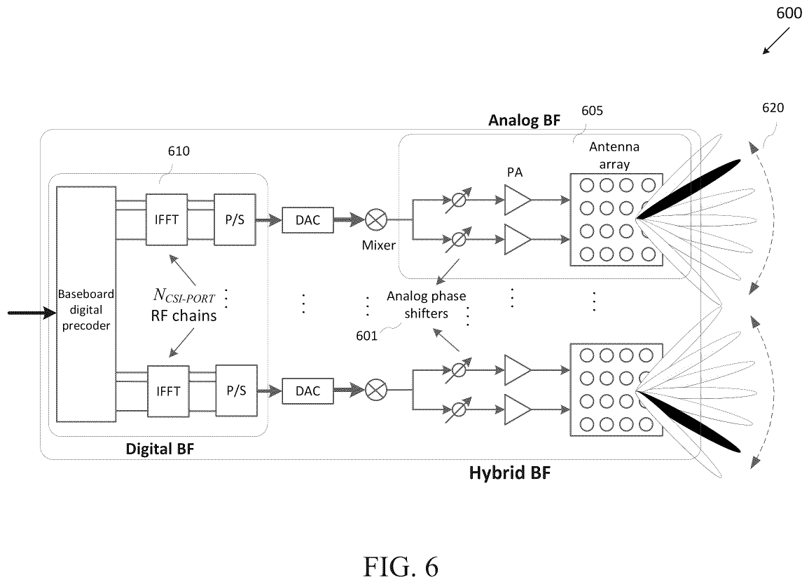

FIG. 6 illustrates an example of a transmitter structure 600 for beamforming according to embodiments of the present disclosure. In certain embodiments, one or more of gNB 102 or UE 116 includes the transmitter structure 600. For example, one or more of antenna 205 and its associated systems or antenna 305 and its associated systems can be included in transmitter structure 600. This example is for illustration only and other embodiments can be used without departing from the scope of the present disclosure.

Accordingly, embodiments of the present disclosure recognize that Rel-14 LTE and Rel-15 NR support up to 32 channel state information reference signal (CSI-RS) antenna ports which enable an eNB or a gNB to be equipped with a large number of antenna elements (such as 64 or 128). A plurality of antenna elements can then be mapped onto one CSI-RS port. For mmWave bands, although a number of antenna elements can be larger for a given form factor, a number of CSI-RS ports, that can correspond to the number of digitally precoded ports, can be limited due to hardware constraints (such as the feasibility to install a large number of analog-to-digital converters (ADCs)/digital-to-analog converters (DACs) at mmWave frequencies) as illustrated in FIG. 6. Then, one CSI-RS port can be mapped onto a large number of antenna elements that can be controlled by a bank of analog phase shifters 601. One CSI-RS port can then correspond to one sub-array which produces a narrow analog beam through analog beamforming 605. This analog beam can be configured to sweep across a wider range of angles 620 by varying the phase shifter bank across symbols or slots/subframes. The number of sub-arrays (equal to the number of RF chains) is the same as the number of CSI-RS ports N_{CSI-PORT}. A digital beamforming unit 610 performs a linear combination across N_{CSI-PORT} analog beams to further increase a precoding gain. While analog beams are wideband (hence not frequency-selective), digital precoding can be varied across frequency sub-bands or resource blocks. Receiver operation can be conceived analogously.

Since the transmitter structure 600 of FIG. 6 utilizes multiple analog beams for transmission and reception (wherein one or a small number of analog beams are selected out of a large number, for instance, after a training duration that is occasionally or periodically performed), the term “multi-beam operation” is used to refer to the overall system aspect. This includes, for the purpose of illustration, indicating the assigned DL or UL TX beam (also termed “beam indication”), measuring at least one reference signal for calculating and performing beam reporting (also termed “beam measurement” and “beam reporting”, respectively), and receiving a DL or UL transmission via a selection of a corresponding RX beam. The system of FIG. 6 is also applicable to higher frequency bands such as >52.6 GHz (also termed frequency range 4 or FR4). In this case, the system can employ only analog beams. Due to the O2 absorption loss around 60 GHz frequency (˜10 dB additional loss per 100 m distance), a larger number and narrower analog beams (hence a larger number of radiators in the array) are needed to compensate for the additional path loss.

The text and figures are provided solely as examples to aid the reader in understanding the present disclosure. They are not intended and are not to be construed as limiting the scope of the present disclosure in any manner. Although certain embodiments and examples have been provided, it will be apparent to those skilled in the art based on the disclosures herein that changes in the embodiments and examples shown may be made without departing from the scope of the present disclosure. The transmitter structure 600 for beamforming is for illustration only and other embodiments can be used without departing from the scope of the present disclosure.

Although the figures illustrate different examples of user equipment, various changes may be made to the figures. For example, the user equipment can include any number of each component in any suitable arrangement. In general, the figures do not limit the scope of this disclosure to any particular configuration(s). Moreover, while figures illustrate operational environments in which various user equipment features disclosed in this patent document can be used, these features can be used in any other suitable system.

Any of the above variation embodiments can be utilized independently or in combination with at least one other variation embodiment.

Although the present disclosure has been described with exemplary embodiments, various changes and modifications may be suggested to one skilled in the art. It is intended that the present disclosure encompass such changes and modifications as fall within the scope of the appended claims. None of the descriptions in this application should be read as implying that any particular element, step, or function is an essential element that must be included in the claims scope. The scope of subject matter is defined by the claims.

In this disclosure, a beam is determined by either of:
A TCI state that establishes a quasi-colocation (QCL) relationship between a source reference signal (e.g., synchronization signal block (SSB) and/or CSI-RS) and a target reference signal
A spatial relation information that establishes an association to a source reference signal, such as SSB or CSI-RS or sounding reference signal (SRS).

In either case, the ID of the source reference signal identifies the beam.

The TCI state and/or the spatial relation reference RS can determine a spatial Rx filter for reception of downlink channels at the UE, or a spatial TX filter for transmission of uplink channels from the UE.

This disclosure provides various design aspects for frequency-selective beam management—using a joint phase-time array (JPTA) system as an example implementation—wherein one or more (analog) beams can be simultaneously transmitted/received over one or more frequency subbands. Specifically, this disclosure provides a two-part/two-stage DCI structure along with necessary signaling support for frequency-selective beam indication in a JPTA system. Specifically, part 1 or first part of the provided two-part DCI for frequency-selective beam/TCI state indication could be of fixed payload size which indicates/provides one or more TCI states/beams for one or more frequency subbands and/or information (such as payload size) of part 2 or second part in the provided two-part DCI for frequency-selective beam/TCI state indication. The part 2 or the second part of the provided two-part DCI could be of flexible payload size which provides/indicates one or more TCI states/beams for one or more frequency subbands. The part 1 or the first part of the two-part DCI for frequency-selective beam/TCI state indication could be carried/indicated/provided in/on a different or separate channel/signaling medium from that used for carrying/indicating/providing the part 2 or the second part of the two-part DCI for frequency-selective beam/TCI state indication. The UE could use/apply the same beam/TCI state for receiving both parts/stages (i.e., part 1 and part 2) of the provided two-part DCI for frequency-selective beam/TCI state indication; alternatively, the UE could be indicated/provided by the network (e.g., via beam indication medium access control (MAC) control element (CE)/DCI) a set/group/pair of two TCI states, which can be respectively used for receiving the part 1 and the part 2 of the two-part DCI for frequency-selective beam/TCI state indication.

Due to the rising demand for traffic, wireless systems are moving towards higher frequency of operation, such as millimeter-wave (mm-wave) and terahertz (THz) frequencies, where abundant spectrum is available. However, the higher frequencies also suffer from a high channel propagation loss, and therefore require a large antenna array to create sufficient beamforming gain to ensure sufficient link budget for operation. Thus, these high frequency systems are usually built with a large antenna array at the transmitter and/or the receiver containing many individual antenna elements. At the operating bandwidths of these mm-wave and THz systems, the cost and power consumption of mixed-signal components such as analog-to-digital converters (ADCs) and/or digital-to-analog converters (DACs) also grows tremendously. Thus, fully digital transceiver implementations, where each antenna element is fed by a dedicated radio-frequency (RF) chain, are impractical. To keep the hardware cost and power consumption of such large antenna arrays manageable, typically an analog beamforming or hybrid beamforming architecture is adopted where the large antenna array is fed with a much smaller number of RF chains via the use of analog hardware such as phase-shifters. This reduces the number of mixed-signal components which significantly reduces the cost, size, and power consumption of the transceivers. When transmitting a signal at the transmitter, a combination of digital beamforming before DAC and analog beamforming using the phase-shifters is used to create the overall beam shape in the desired direction. Similarly, when receiving a signal at the receiver, a combination of analog beamforming using phase-shifters and digital beamforming after ADC is used to create the overall beam shape in the desired direction.

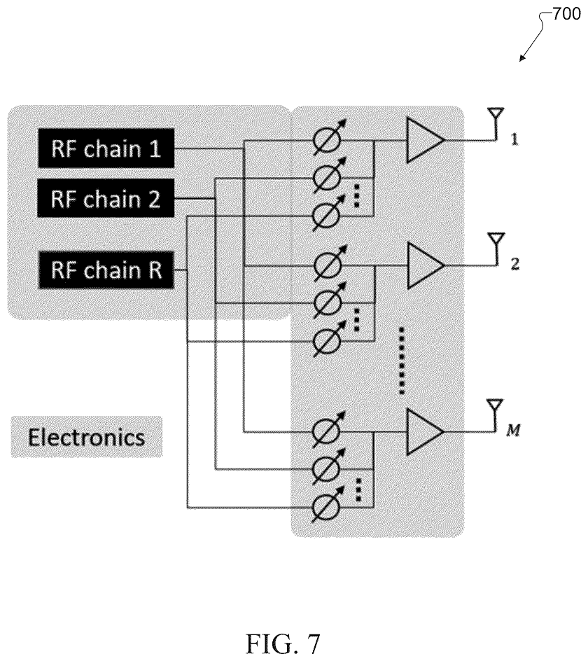

FIG. 7 illustrates an example of an antenna array structure 700 for hybrid beamforming according to embodiments of the present disclosure. For example, the antenna array structure 700 for hybrid beamforming can be implemented in the BS 102 of FIG. 2. This example is for illustration only and other embodiments can be used without departing from the scope of the present disclosure.

However, common approaches usually use a phase-shifter array or a combination of phase-shifters and switches to connect the large antenna array to a few number of RF chains. With reference to FIG. 7, an example of such an architecture is shown.

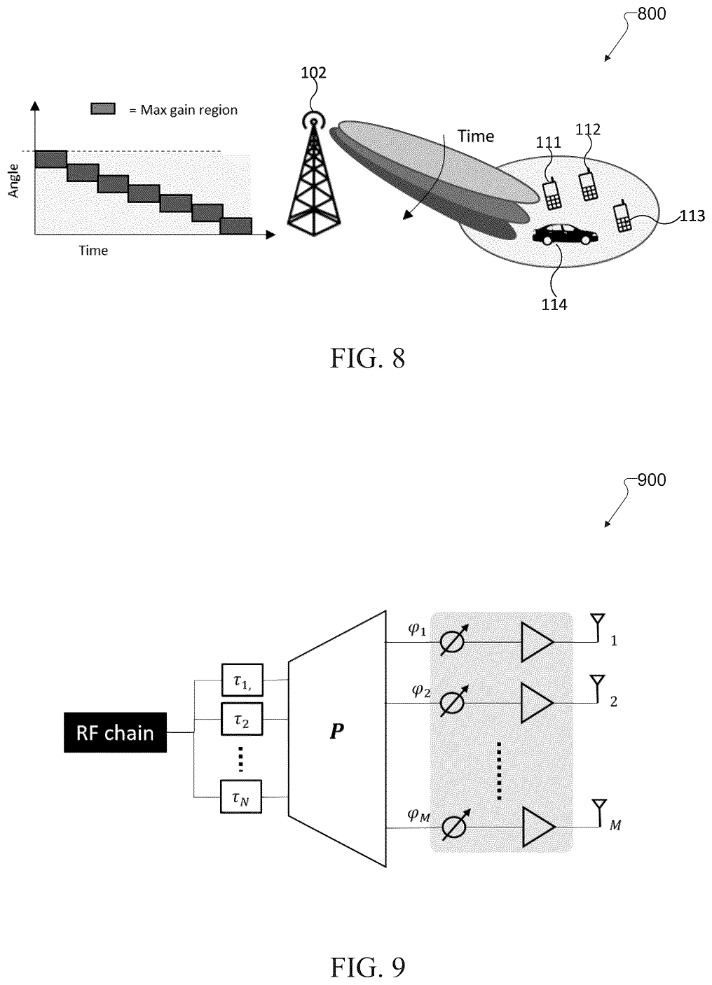

FIG. 8 illustrates an example of beamforming 800 according to embodiments of the present disclosure. For example, the beamforming 800 may be implemented by the gNB 102 and/or network 130 in the wireless network 100 of FIG. 1. This example is for illustration only and other embodiments can be used without departing from the scope of the present disclosure.

For example, various embodiments evaluate the case of hybrid beamforming at a base-station (BS) shown in FIG. 7 with a single RF chain, i.e., R=1. Note that with M antennas, the maximum beamforming gain in any direction is M. For the BS to provide signal coverage to the UEs in the cell, with reference to FIG. 8, the BS would perform beam sweeping over time for its frequency-flat beams.

FIG. 9 illustrates a diagram of an example JPTA architecture 900 according to embodiments of the present disclosure. For example, JPTA architecture 900 can be implemented in the BS 103 of FIG. 1. This example is for illustration only and other embodiments can be used without departing from the scope of the present disclosure.

An alternative to frequency-flat hybrid beamforming is frequency-dependent hybrid beamforming, which is called joint phase-time array (JPTA) beamforming. Note that, here, frequency-dependent beamforming refers to a technique where different components of the input signal may encounter a differently shaped analog beam based on their frequency. With reference to FIG. 9, an illustration of the BS JPTA architecture with 1 RF chain and single phase-shifter per antenna element is shown.

Various embodiments provide a layout with a single base-station (BS) serving many users in its coverage area and operating with a system bandwidth W around a center frequency f₀. The BS is expected to have a uniform linear antenna array having M elements, and N_{RF}=1 RF chain. Note that the disclosure can be directly extended to planar array configurations. The antenna spacing is half-wavelength at the center frequency f₀. Each of the M antennas has a dedicated phase-shifter, and they are connected to the single RF chain via a network of N≤M true time delays (TTDs) as shown in FIG. 9. Here P is a fixed M×N mapping matrix, where each row m has one non-zero entry and determines which of the N TTDs antenna m is connected to. The TTDs are expected to be configurable, with a delay variation range of 0≤τ≤κW, where κ is a design parameter to be selected. The phase-shifters are expected to have unit magnitude and have arbitrarily reconfigurable phase −π≤ϕ<π. Transmission in both uplink and downlink directions is performed using OFDM with K subcarriers indexed as

$$𝔎 = \{ ⌊ \frac{1 - K}{2} ⌋ , … , ⌊ \frac{K - 1}{2} ⌋ \} .$$

Then, the M×1 downlink TX signal on sub-carrier k∈K for a representative OFDM symbol can be expressed as

$${x}_{k} = \frac{1}{\sqrt{M}} [ \begin{matrix}{e}^{j {φ}_{1}} & … & 0 \\ ⋮ & ⋱ & ⋮ \\ 0 & … & {e}^{j {φ}_{M}}\end{matrix} ] P [ \begin{matrix}{e}^{j 2 π {f}_{k} {τ}_{1}} \\ ⋮ \\ {e}^{j 2 π {f}_{k} {τ}_{N}}\end{matrix} ] {α}_{k} {s}_{k} = {TPd}_{k} {α}_{k} {s}_{k}$$

where sₖ and αₖ are the scalar data and digital beamforming on the k-th subcarrier, fₖ is the frequency of the k-th sub-carrier (including the carrier frequency), τₙ is the delay of the n-th TTD and ϕₘ is the phase of the m phase-shifter connected to the m-th antenna. Note that from the equation above the total transmit power of the BS can be given by Pₛᵤₘ=Σ_{k∈K}|αₖ|². Note that for this JPTA architecture, the effective downlink unit-norm analog beamformer on sub-carrier k is eₖ=TPdₖ, where the M×M diagonal matrix T captures the effect of phase-shifters and the N×1 vector dₖ captures the effect of TTDs. It can be shown that the same beamformer is also applicable at the BS for uplink scenario.

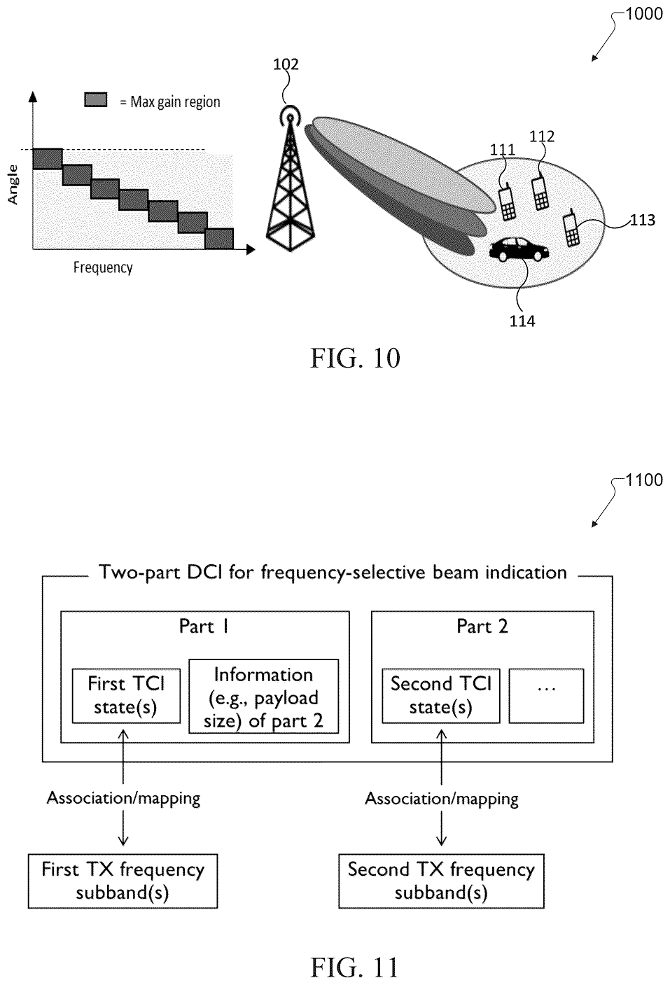

FIG. 10 illustrates an example architecture 1000 for frequency selective beamforming according to embodiments of the present disclosure. For example, the architecture 1000 for the frequency selective beamforming may be implemented by the gNB 102 and/or network 130 in the wireless network 100 of FIG. 1. This example is for illustration only and other embodiments can be used without departing from the scope of the present disclosure.

In one example behavior of JPTA beamforming, the maximum gain region of the beam sweeps over an angle range as the signal frequency varies. At any signal frequency f, the desired beam creates the maximum array-gain in one angular direction θ(f). As f varies linearly over the system bandwidth, the angular direction θ(f) also sweeps linearly over a certain angular region [θ₀−Δθ/2, θ₀+Δθ/2], as shown in FIG. 10. In this disclosure, such behavior of JPTA beamforming is expected, however it should be noted that the embodiments in this disclosure can be applied to other behaviors of JPTA beamforming as well.

It is evident that when JPTA beamforming implementation is utilized, a significant departure from common analog-based beam management occurs. That is, while common beam management uses that one analog beam applies for the entire system bandwidth or bandwidth part, JPTA beamforming implementation allows the system to use different analog beams for different parts of the system bandwidth or bandwidth part—which amounts to “frequency-selective” beam management (FSBM). Therefore, embodiments of the present disclosure recognize that there is a need for enabling frequency-selective beam management operation wherein different analog beams (associated with TCI states, source RS resources, and/or measurement RS resources) can be utilized for different parts/portions of the system bandwidth or bandwidth parts.

A unified TCI framework could indicate/include N≥1 DL TCI states and/or M≥1 UL TCI states, wherein the indicated TCI state could be at least one of: a DL TCI state and/or its corresponding/associated TCI state ID, an UL TCI state and/or its corresponding/associated TCI state ID, a joint DL and UL TCI state and/or its corresponding/associated TCI state ID, and separate DL TCI state and UL TCI state and/or their corresponding/associated TCI state ID(s).

There could be various design options/channels to indicate to the UE a beam (i.e., a TCI state) for the transmission/reception of a physical downlink control channel (PDCCH) or a physical downlink shared channel (PDSCH).
In one example, a MAC CE could be used to indicate to the UE a beam (i.e., a TCI state and/or a TCI state ID) for the transmission/reception of a PDCCH or a PDSCH.
In another example, a DCI could be used to indicate to the UE a beam (i.e., a TCI state and/or a TCI state ID) for the transmission/reception of a PDCCH or a PDSCH. For example, a DL related DCI (e.g., DCI format 1_0, DCI format 1_1 or DCI format 1_2) could be used to indicate to the UE a beam (i.e., a TCI state and/or a TCI state ID) for the transmission/reception of a PDCCH or a PDSCH, wherein the DL related DCI may or may not include a DL assignment. For another example, an UL related DCI (e.g., DCI format 0_0, DCI format 0_1, DCI format 0_2) could be used to indicate to the UE a beam (i.e., a TCI state and/or a TCI state ID) for the transmission/reception of a PDCCH or a PDSCH, wherein the UL related DCI may or may not include an UL scheduling grant. Yet for another example, a custom/purpose designed DCI format could be used to indicate to the UE a beam (i.e., a TCI state and/or a TCI state ID) for the transmission/reception of a PDCCH or a PDSCH.

Rel-17 introduced the unified TCI framework, where a unified or master or main TCI state is signaled to the UE. The unified or master or main TCI state can be one of: in case of joint TCI state indication, wherein a same beam is used for DL and UL channels, a joint TCI state that can be used at least for UE-dedicated DL channels and UE-dedicated UL channels; in case of separate TCI state indication, wherein different beams are used for DL and UL channels, a DL TCI state can be used at least for UE-dedicated DL channels; in case of separate TCI state indication, wherein different beams are used for DL and UL channels, a UL TCI state can be used at least for UE-dedicated UL channels.

The unified (master or main) TCI state is TCI state of UE-dedicated reception on PDSCH/PDCCH or dynamic-grant/configured-grant based physical uplink shared channel (PUSCH) and dedicated physical uplink control channel (PUCCH) resources. Throughout the present disclosure, the term “TCI state” or “TCI state ID” could refer to a single Rel-17 unified TCI state as discussed above (e.g., a joint DL and UL TCI state, a separate DL TCI state or a separate UL TCI state) or a pair of Rel-17 unified TCI states as discussed above (e.g., a pair of separate DL and UL TCI states).

A UE (e.g., the UE 116) could be first provided by the network, e.g., via higher layer RRC signaling (e.g., in PDSCH-Config), one or more lists of TCI states. For instance, the UE could be provided by the network, e.g., via higher layer RRC signaling (e.g., in PDSCH-Config), a list of up to Nⱼₒᵢₙₜ≥1 joint DL and UL TCI states each provided by DLorJointTCI-State and/or a list of up to Nᵤₗ≥1 separate UL TCI states each provided by UL-TCIState. The UE could also be configured/indicated/provided by the network, e.g., via higher layer RRC signaling and/or MAC CE command and/or dynamic DCI based signaling, that one or more TCI states configured/provided in one or more of the higher layer configured lists of TCI states are for frequency-selective beam indication for FSBM.

For example, the higher layer parameter that configures a list of TCI states could indicate/provide/include an indicator. If the indicator is configured or set to ‘enabled’, the corresponding list of TCI states is for frequency-selective beam indication for FSBM.

For another example, the higher layer parameter that configures a list of TCI states could indicate/provide/include a one-bit flag indicator. If the one-bit flag indicator is configured or set to ‘1’ (or ‘0’), the corresponding list of TCI states is for frequency-selective beam indication for FSBM.

Yet for another example, the higher layer parameter that configures a list of TCI states could indicate/provide/include a set of TCI state indexes/IDs, wherein the TCI states correspond to the set of TCI state indexes/IDs are for frequency-selective beam indication for FSBM.

Yet for another example, the higher layer parameter that configures a list of TCI states could indicate/provide/include a bitmap with each bit position/entry in the bitmap corresponding/associated to a TCI state configured in the list of TCI states. If a bit position/entry in the bitmap is set to ‘1’ (or ‘0’), the TCI state corresponding/associated to the bit position/entry is for frequency-selective beam indication for FSBM.

Yet for another example, the UE could receive from the network a MAC CE activation command activating one or more TCI states from the higher layer configured list(s) of TCI states for frequency-selective beam indication for FSBM.

Furthermore, the UE could receive from the network a MAC CE activation command activating one or more TCI states from the higher layer configured list(s) of TCI states. The MAC CE activated one or more TCI states are also mapped to one or more (e.g., up to N_{cp}≥1) TCI codepoints. Or equivalently, the UE could receive from the network a (unified) TCI state(s) activation/deactivation MAC CE providing/indicating/activating one or more sets of TCI states with each set comprising one or more TCI states and mapped to a TCI codepoint of a TCI field in a beam indication DCI (e.g., DCI format 1_1/1_2 with or without DL assignment). Here, a set of TCI states activated/provided/indicated by/in the (unified) TCI state(s) activation/deactivation MAC CE (mapped to a TCI codepoint of a TCI field in a beam indication DCI) or a TCI codepoint of a TCI field in a beam indication DCI could correspond to up to M≥1 joint DL and UL TCI states and/or up to M≥1 separate DL TCI states and/or up to N≥1 separate UL TCI states and/or up to M≥1 (or N≥1) pairs of separate DL and UL TCI states.

For example, a set of TCI states activated/provided/indicated by/in the (unified) TCI state(s) activation/deactivation MAC CE (mapped to a TCI codepoint of a TCI field in a beam indication DCI) or a TCI codepoint of a TCI field in a beam indication DCI could correspond to m joint DL and UL TCI states, where m∈{1, . . . , M}. For this design example, the UE could be provided/configured by the network, e.g., via higher layer RRC signaling(s)/parameter(s) and/or MAC CE command(s) and/or dynamic DCI based L1 signaling(s), a/the ‘joint’ mode for TCI state(s) configuration, activation and/or indication.

For another example, a set of TCI states activated/provided/indicated by/in the (unified) TCI state(s) activation/deactivation MAC CE (mapped to a TCI codepoint of a TCI field in a beam indication DCI) or a TCI codepoint of a TCI field in a beam indication DCI could correspond to m separate DL TCI states, where m∈{1, . . . , M}. For this design example, the UE could be provided/configured by the network, e.g., via higher layer RRC signaling(s)/parameter(s) and/or MAC CE command(s) and/or dynamic DCI based L1 signaling(s), a/the ‘separate’ mode for TCI state(s) configuration, activation and/or indication.

Yet for another example, a set of TCI states activated/provided/indicated by/in the (unified) TCI state(s) activation/deactivation MAC CE (mapped to a TCI codepoint of a TCI field in a beam indication DCI) or a TCI codepoint of a TCI field in a beam indication DCI could correspond to n separate UL TCI states, where n∈{1, . . . , N}. For this design example, the UE could be provided/configured by the network, e.g., via higher layer RRC signaling(s)/parameter(s) and/or MAC CE command(s) and/or dynamic DCI based L1 signaling(s), a/the ‘separate’ mode for TCI state(s) configuration, activation and/or indication.

Yet for another example, a set of TCI states activated/provided/indicated by/in the (unified) TCI state(s) activation/deactivation MAC CE (mapped to a TCI codepoint of a TCI field in a beam indication DCI) or a TCI codepoint of a TCI field in a beam indication DCI could correspond to m (or n) pairs of separate DL and UL TCI states, where m∈{1, . . . , M}, n∈{1, . . . , N}. For this design example, the UE could be provided/configured by the network, e.g., via higher layer RRC signaling(s)/parameter(s) and/or MAC CE command(s) and/or dynamic DCI based L1 signaling(s), a/the ‘separate’ mode for TCI state(s) configuration, activation and/or indication.

Yet for another example, a set of TCI states activated/provided/indicated by/in the (unified) TCI state(s) activation/deactivation MAC CE (mapped to a TCI codepoint of a TCI field in a beam indication DCI) or a TCI codepoint of a TCI field in a beam indication DCI could correspond to m separate DL TCI states and n separate UL TCI states, where m∈{1, . . . , M}, n∈{1, . . . , N}. For this design example, the UE could be provided/configured by the network, e.g., via higher layer RRC signaling(s)/parameter(s) and/or MAC CE command(s) and/or dynamic DCI based L1 signaling(s), a/the ‘separate’ mode for TCI state(s) configuration, activation and/or indication.

Yet for another example, a set of TCI states activated/provided/indicated by/in the (unified) TCI state(s) activation/deactivation MAC CE (mapped to a TCI codepoint of a TCI field in a beam indication DCI) or a TCI codepoint of a TCI field in a beam indication DCI could correspond to m separate DL TCI states and m (or n) pairs of separate DL and UL TCI states, where m∈{1, . . . , M}, n∈{1, . . . , N}. For this design example, the UE could be provided/configured by the network, e.g., via higher layer RRC signaling(s)/parameter(s) and/or MAC CE command(s) and/or dynamic DCI based L1 signaling(s), a/the ‘separate’ mode for TCI state(s) configuration, activation and/or indication.

Yet for another example, a set of TCI states activated/provided/indicated by/in the (unified) TCI state(s) activation/deactivation MAC CE (mapped to a TCI codepoint of a TCI field in a beam indication DCI) or a TCI codepoint of a TCI field in a beam indication DCI could correspond to n separate UL TCI states and m (or n) pairs of separate DL and UL TCI states, where m∈{1, . . . , M}, n∈{1, . . . , N}. For this design example, the UE could be provided/configured by the network, e.g., via higher layer RRC signaling(s)/parameter(s) and/or MAC CE command(s) and/or dynamic DCI based L1 signaling(s), a/the ‘separate’ mode for TCI state(s) configuration, activation and/or indication.

Throughout the present disclosure, indicating M≥1 (or N≥1) TCI states/pairs of TCI states in the MAC CE/DCI for beam indication and/or having a MAC CE activated TCI codepoint or a TCI codepoint of a TCI field in a beam indication DCI corresponding to M≥1 (or N≥1) TCI states/pairs of TCI states are the design focus; the corresponding designs, descriptions and discussions also apply for indicating m (or n) TCI state(s)/pair(s) of TCI states in the MAC CE/DCI for beam indication and/or having a MAC CE activated TCI codepoint or a TCI codepoint of a TCI field in a beam indication DCI corresponding to m (or n) TCI state(s)/pair(s) of TCI states, where m∈{1, . . . , M}, n∈{1, . . . , N}. The UE could be configured/indicated by the network, e.g., via higher layer RRC signaling and/or MAC CE command and/or dynamic DCI based signaling, that one or more of the sets of TCI states activated/provided/indicated by/in the (unified) TCI state(s) activation/deactivation MAC CE (each set mapped to a TCI codepoint of a TCI field in a beam indication DCI), or one or more of the TCI codepoints activated/provided/indicated in/by the MAC CE (each TCI codepoint could be indicated/provided by a TCI field in a beam indication DCI), are for frequency-selective beam indication for FSBM.

For example, the MAC CE activation command that activates the one or more sets of TCI states/TCI codepoints could indicate/provide/include an indicator. If the indicator is configured or set to ‘enabled’, the corresponding sets of TCI states/TCI codepoints (and therefore, the corresponding TCI states) activated by the MAC CE activation command are for frequency-selective beam indication for FSBM.

For another example, the MAC CE activation command that activates the one or more sets of TCI states/TCI codepoints could indicate/provide/include a one-bit flag indicator. If the one-bit flag indicator is configured or set to ‘1’ (or ‘0’), the corresponding sets of TCI states/TCI codepoints (and therefore, the corresponding TCI states) activated by the MAC CE activation command are for frequency-selective beam indication for FSBM.

Yet for another example, the MAC CE activation command that activates the one or more sets of TCI states/TCI codepoints could indicate/provide/include a set of TCI codepoint indexes/IDs and/or a set of TCI state(s) set indexes/IDs, wherein the TCI codepoints (and therefore, the corresponding TCI states) corresponding to the set of TCI codepoint indexes/IDs are for frequency-selective beam indication for FSBM, and/or the set of TCI states (and therefore, the corresponding TCI states) corresponding to the set of TCI state(s) set indexes/IDs are for frequency-selective beam indication for FSBM.

Yet for another example, the MAC CE activation command that activates the one or more sets of TCI states/TCI codepoints could indicate/provide/include a bitmap with each bit position/entry in the bitmap corresponding/associated to a set of TCI states/TCI codepoint activated by the MAC CE activation command. If a bit position/entry in the bitmap is set to ‘1’ (or ‘0’), the set of TCI states/TCI codepoint (and therefore, the corresponding TCI states) corresponding/associated to the bit position/entry is for frequency-selective beam indication for FSBM.

Yet for another example, the UE could receive from the network (e.g., the network 130) a dedicated MAC CE activation command indicating/providing/activating one or more sets of TCI states with each set of TCI states used to map to a TCI codepoint of a TCI field in a beam indication DCI. For this design example, the sets of TCI states (and therefore, the corresponding TCI states) provided/indicated/activated in/by the dedicated MAC CE activation command are for frequency-selective beam indication for FSBM.

Yet for another example, the UE could receive from the network a dedicated MAC CE activation command activating/selecting one or more sets of TCI states/TCI codepoints from the sets of TCI states/TCI codepoints activated/provided/indicated in/by the (unified) TCI state(s) activation/deactivation MAC CE. The set(s) of TCI states/TCI codepoint(s) activated/selected by the dedicated MAC CE activation command could be for frequency-selective beam indication for FSBM.

For/in the described design examples herein and/or the examples specified herein in the present disclosure, a MAC CE activation command could be a (unified) TCI state(s) activation/deactivation MAC CE command. Furthermore, as specified herein in the present disclosure, a set of TCI states activated/provided/indicated by a MAC CE activation command or a (unified) TCI state(s) activation/deactivation MAC CE command could be mapped to a TCI codepoint of a TCI field in a beam indication DCI.

The UE could be indicated by the network, e.g., in a MAC CE or DCI (e.g., DCI format 1_1 or 1_2 with or without DL assignment), N≥1 (or M≥1) TCI states/pairs of TCI states. For DCI based TCI state/beam indication, the TCI states/pairs of TCI states could be indicated via one or more TCI codepoints in one or more TCI fields of the corresponding DCI format. In the present disclosure, an indicated TCI state/pair of TCI states could correspond to one or more transmission (TX) frequency subbands. Different indicated TCI states/pairs of TCI states could correspond to different TX frequency subbands, wherein each TX frequency subband could be characterized by a number of physical resource blocks (PRBs) and/or a starting resource block (RB). Furthermore, a TCI state could comprise/include/indicate one or more (QCL) source RSs (e.g., with different QCL types), and is indicated for one or more target channels/signals including PDCCH, PDSCH, PUCCH, PUSCH, CSI-RS and/or SRS.

The UE could be indicated by the network, e.g., in a MAC CE or DCI (e.g., DCI format 1_1 or 1_2 with or without DL assignment), a single (i.e., N=1 or M=1) TCI state/pair of TCI states. Here, the TCI state/pair of TCI states (and therefore, the corresponding source RS(s) indicated therein) could be indicated for one or more (e.g., Nₜₓ≥1) TX frequency subbands; furthermore, each TX frequency subband could be for a set of target channels/signals including PDCCH, PDSCH, PUCCH, PUSCH, CSI-RS and/or SRS.

The UE could be first configured/indicated/provided by the network, via higher layer RRC signaling and/or MAC CE command and/or dynamic DCI based signaling, the TX frequency subband(s) including their bandwidths/sizes, starting RBs, etc. for the indicated TCI state. There are various means to indicate/configure the TX frequency subband(s) corresponding/associated to the indicated TCI state.

In one example, a higher layer parameter, e.g., that configures the TCI state, e.g., TCI-State, QCL-Info, DLorJointTCI-State or ULTCI-State, could indicate/include Nₜₓ TX frequency subband configurations. A TX frequency subband configuration could contain/comprise at least a TX frequency subband index, a frequency domain allocation of REs for a TX frequency subband and a frequency domain allocation of RBs for a TX frequency subband including at least a starting RB and a number of PRBs across which the corresponding TX frequency subband spans. Alternatively, one or more of the discussed Nₜₓ TX frequency subband configurations herein could be indicated in one or more DCIs, via one or more new DCI fields or by repurposing one or more bits/codepoints of one or more existing DCI fields in the DCI(s). Optionally, one or more of the discussed Nₜₓ TX frequency subband configurations herein could be indicated/provided/included in one or more MAC CE commands; for this case, a MAC CE command could also include/indicate/provide the corresponding TCI state ID/index and/or frequency subband index(es). The Nₜₓ TX frequency subband configurations discussed herein and the Nₜₓ TX frequency subbands for the indicated TCI state could be one-to-one mapped; for instance, the first TX frequency subband configuration could correspond to the first TX frequency subband, the second TX frequency subband configuration could correspond to the second TX frequency subband, and so on, and the Nₜₓ-th TX frequency subband configuration could correspond to the Nₜₓ-th TX frequency subband. Alternatively, the UE could be indicated/provided by the network, e.g., via higher layer RRC signaling/parameter and/or MAC CE command and/or dynamic DCI based signaling, the mapping/association between the Nₜₓ TX frequency subband configurations and the Nₜ, TX frequency subbands for the indicated TCI state.

In another example, the UE could receive from the network, via higher layer RRC signaling (e.g., in TCI-State, QCL-Info, DLorJointTCI-State or ULTCI-State) and/or MAC CE command and/or dynamic DCI based signaling, one or more bitmaps (e.g., Nₜₓ bitmaps) each for a TX frequency subband for the indicated TCI state. Each bit position/entry in a bitmap could correspond to a PRB or PRB index among the PRBs, e.g., configured within the bandwidth part (BWP)/component carrier (CC). If a bit position/entry of a bitmap is set to ‘1’ (or ‘0’), the corresponding PRB or PRB index is allocated for the TX frequency subband corresponding/associated to the bitmap. A bitmap for a TX frequency subband could contain/comprise more than one bit positions/entries set to ‘1’ (or ‘0’). The higher layer parameter(s), e.g., TCI-State, QCL-Info, DLorJointTCI-State or ULTCI-State, that provides the one or more bitmaps could also include/provide/indicate Nₜₓ TX frequency subband indexes each associated/mapped to a bitmap. If the TX frequency subband size/allocation (e.g., the one or more bitmaps discussed herein) is indicated via one or more DCIs, one or more new DCI fields can be introduced to indicate the one or more bitmaps; alternatively, one or more bits/codepoints of one or more existing DCI fields could be repurposed to indicate the one or more bitmaps. If the TX frequency subband size/allocation (e.g., the one or more bitmaps discussed herein) is indicated in one or more MAC CE commands, a MAC CE command could also indicate/provide/include the corresponding TCI state ID/index and/or TX frequency subband index(es). The Nₜₓ bitmaps discussed herein and the Nₜₓ TX frequency subbands could be one-to-one mapped; for instance, the first bitmap could correspond to the first TX frequency subband, the second bitmap could correspond to the second TX frequency subband, and so on, and the Nₜₓ-th bitmap could correspond to the Nₜₓ-th TX frequency subband. Alternatively, the UE could be indicated/provided by the network, e.g., via higher layer RRC signaling/parameter and/or MAC CE command and/or dynamic DCI based signaling, the mapping/association between the Nₜₓ bitmaps and the Nₜ, TX frequency subbands.

In yet another example, the UE could receive from the network, via higher layer RRC signaling (e.g., in TCI-State, QCL-Info, DLorJointTCI-State or ULTCI-State) and/or MAC CE command and/or dynamic DCI based signaling, a bitmap for one or more of the TX frequency subbands. Each bit position/entry in the bitmap could correspond to a PRB or PRB index among the PRBs, e.g., configured within the BWP/CC. Furthermore, each bit position/entry in the bitmap could be mapped/associated to a TX frequency subband. The mapping/association between the bit positions/entries in the bitmap and the TX frequency subbands could be fixed. For instance, the bitmap can be partitioned into Nₜₓ parts each comprising one or more bit positions/entries; for this case, the first part of the bitmap could correspond to the first TX frequency subband, the second part of the bitmap could correspond to the second TX frequency subband, and so on, and the Nₜₓ-th part of the bitmap could correspond to the Nₜₓ-th TX frequency subband; the UE could be provided/indicated/configured by the network, via higher layer RRC signaling and/or MAC CE command and/or dynamic DCI based signaling, how the bitmap is partitioned. Alternatively, the UE could be provided/indicated/configured by the network, via higher layer RRC signaling and/or MAC CE command and/or dynamic DCI based signaling, the mapping/association between the bit positions/entries in the bitmap and the TX frequency subbands. If a bit position/entry of a bitmap is set to ‘1’ (or ‘0’), the corresponding PRB or PRB index is allocated for the TX frequency subband corresponding/associated to the bit position/entry. The bitmap could contain/comprise more than one bit positions/entries set to ‘1’ (or ‘0’). The higher layer parameter(s), e.g., in TCI-State, QCL-Info, DLorJointTCI-State or ULTCI-State, that provides the bitmap could also include/provide/indicate Nₜₓ TX frequency subband indexes each associated/mapped to one or more bit positions/entries (e.g., a part discussed herein) in the bitmap. If the TX frequency subband size/allocation (e.g., the bitmap discussed herein) is indicated via one or more DCIs, one or more new DCI fields can be introduced to indicate the bitmap; alternatively, one or more bits/codepoints of one or more existing DCI fields could be repurposed to indicate the bitmap. If the frequency subband size/allocation (e.g., the bitmap discussed herein) is indicated in one or more MAC CE command(s), a MAC CE command could also indicate/provide/include the corresponding TCI state ID/index and/or TX frequency subband index(es).

In yet another example, the UE could receive from the network one or more MAC CE activation commands (e.g., Nₜ, MAC CE activation commands) each for a TX frequency subband for the indicated TCI state. Each MAC CE activation command could activate one or more PRBs or PRB indexes—from the PRBs configured, e.g., within the BWP/CC—for the corresponding/associated TX frequency subband. For this case, each MAC CE activation command could include/provide/indicate the corresponding TCI state ID/index and/or TX frequency subband index(es).

In yet another example, the UE could receive from the network a MAC CE activation command activating one or more PRBs or PRB indexes—from the PRBs configured, e.g., within the BWP/CC—for one or more of the TX frequency subbands for the indicated TCI state. For instance, the MAC CE activation command could activate one or more PRBs or PRB indexes—from the PRBs configured, e.g., within the BWP/CC—for the first TX frequency subband, one or more PRBs or PRB indexes—from the PRBs configured, e.g., within the BWP/CC—for the second TX frequency subband, and so on, and one or more PRBs or PRB indexes—from the PRBs configured, e.g., within the BWP/CC—for the Nₜₓ-th TX frequency subband. For this case, the MAC CE activation command could include/provide/indicate the corresponding TCI state ID/index.

In yet another example, the TX frequency subbands for the indicated TCI state—e.g., the Nₜₓ TX frequency subbands for the indicated TCI state—could have the same bandwidth/size. For this case, the UE could be provided by the network, via higher layer RRC signaling (e.g., in TCI-State, QCL-Info, DLorJointTCI-State or ULTCI-State) and/or MAC CE command and/or dynamic DCI based signaling, a common TX frequency subband bandwidth/size (e.g., in number of PRBs) and/or Nₜₓ and/or one or more starting RBs of one or more TX frequency subbands. In addition, the TX frequency subbands for the indicated TCI state—e.g., the Nₜ, TX frequency subbands for the indicated TCI state—could equally divide the total PRBs configured, e.g., within the BWP/CC. For this case, the UE could be provided by the network, via higher layer RRC signaling (e.g., in e.g., in TCI-State, QCL-Info, DLorJointTCI-State or ULTCI-State) and/or MAC CE command and/or dynamic DCI based signaling, Nₜₓ and/or one or more starting RBs of one or more TX frequency subbands.

In yet another example, the TX frequency subbands could correspond to the frequency subbands configured for frequency-selective beam measurement for FSBM (e.g., according to one or more examples described herein) and/or one or more reporting frequency subbands, with which one or more (frequency-selective) CSI/beam reports are associated. For instance, the TX frequency subbands could correspond to the frequency subbands configured for the k-th CSI-RS resource in a CSI resource subset/groupm, or CSI resource set or CSI resource setting for frequency-selective beam measurement for FSBM, or the frequency subbands configured for the CSI-RS resources in the k-th CSI resource subset/group in a resource set for frequency-selective beam measurement for FSBM, where k∈{1, . . . , K}. The index, k in this example, of the CSI-RS resource or CSI resource subset/group for frequency-selective beam measurement for FSBM—the corresponding measurement frequency subbands correspond to the TX frequency subbands as discussed herein, could be fixed in the system specifications and known to both the network and UE sides a prior. Alternatively, the UE could be indicated/configured/provided by the network, e.g., via higher layer RRC signaling and/or MAC CE command and/or dynamic DCI based signaling, the index, k in this example, of the CSI-RS resource or CSI resource subset/group for frequency-selective beam measurement for FSBM—the corresponding measurement frequency subbands correspond to the TX frequency subbands as discussed herein. Furthermore, the TX frequency subbands could be one-to-one mapped to the frequency subbands configured for frequency-selective beam measurement for FSBM (or the reporting frequency subbands, with which the CSI/beam reports are associated)—e.g., the first TX frequency subband is associated to the first measurement frequency subband, the second TX frequency subband is associated to the second measurement frequency subband, and so on. Optionally, the UE could be indicated/configured/provided by the network, e.g., via higher layer RRC signaling and/or MAC CE command and/or dynamic DCI based signaling, the mapping/association relationship between the TX frequency subbands and the frequency subbands configured for frequency-selective beam measurement for FSBM (or the reporting frequency subbands, with which the CSI/beam reports are associated).

In yet another example, the TX frequency subbands could correspond to the frequency subbands indicated in a DCI (e.g., DCI format 1_1 or 1_2) for DL and/or UL resource allocation. The frequency subbands for resource allocation/assignment (RA) could be indicated in the frequency domain resource allocation (FD-RA) field(s) of a DCI. The FD-RA field could contain a bitmap with each bit position/entry in the bitmap corresponding to a resource block group (RBG)—Type 0, i.e., the bitmap indicates the frequency domain resource allocation in RBG(s). The FD-RA field could contain a resource indicator value (RIV) indicating the continuous virtual resource blocks (VRBs)—Type 1; depending on the value of “VRB-to-PRB mapping”, the corresponding PRBs associated with the indicated VRBs could be identified. There could be various means to associate/map the TX frequency subbands and the frequency subbands indicated in the FD-RA field(s) for DL/UL RA.

For example, the mapping/association between the TX frequency subbands and the frequency subbands indicated in FD-RA field(s) for DL/UL RA could be fixed (e.g., in the system specifications) and known to both the network and UE sides a prior. For instance, for Type 0 RA, the first one or more bit positions/entries (and therefore the corresponding RBGs) in the bitmap could be associated to the first TX frequency subband, the second one or more bit positions/entries (and therefore, the corresponding RBGs) in the bitmap could be associated to the second TX frequency subband, and so on. For Type 1 RA, a first RIV (and therefore, the corresponding PRBs) could be associated to the first TX frequency subband, a second RIV (and therefore, the corresponding PRBs) could be associated to the second TX frequency subband, and so on.

For another example, the UE could be indicated/configured/provided by the network, e.g., via higher layer RRC signaling/parameter and/or MAC CE command and/or dynamic DCI based signaling, the mapping/association between the TX frequency subbands and the frequency subbands indicated in FD-RA field(s) for DL/UL RA. For instance, for Type 0 RA, the ULE could be indicated/configured/provided by the network, e.g., via higher layer RRC signaling/parameter and/or MAC CE command and/or dynamic DCI based signaling, the association/mapping between the TX frequency subbands and one or more bit positions/entries (and therefore, the corresponding RBGs) in the bitmap. For Type 1 RA, the UE could be indicated/configured/provided by the network, e.g., via higher layer RRC signaling/parameter and/or MAC CE command and/or dynamic DCI based signaling, the association/mapping between the TX frequency subbands and one or more RIVs (and therefore, the corresponding PRBs).

In yet another example, the UE (e.g., the UE 116) could be indicated by the network, e.g., in a DCI (e.g., DCI format 1_1 or 1_2), one or more (e.g., Nₜₓ) bitmaps in FD-RA field(s) of the DCI format each providing one or more (multiples of) RBGs and associated to a TX frequency subband. For instance, the first indicated bitmap (and therefore, the corresponding indicated RBGs) could be associated to the first TX frequency subband, the second indicated bitmap (and therefore, the corresponding indicated RBGs) could be associated to the second TX frequency subband, and so on. Alternatively, the UE could be indicated/configured/provided by the network, e.g., via higher layer RRC signaling/parameter and/or MAC CE command and/or dynamic DCI based signaling, the association/mapping between the TX frequency subbands and the one or more (e.g., Nₜₓ) bitmaps (and therefore, the corresponding RBGs) in the FD-RA field(s).

In yet another example, the UE could be indicated by the network, e.g., in a DCI (e.g., DCI format 1_1 or 1_2), one or more (e.g., Nₜₓ) RIVs in FD-RA field(s) of the DCI format each providing one or more PRBs and associated to a TX frequency subband. For instance, the first indicated RIV (and therefore, the corresponding indicated PRBs) could be associated to the first TX frequency subband, the second indicated RIV (and therefore, the corresponding indicated PRBs) could be associated to the second TX frequency subband, and so on. Alternatively, the UE could be indicated/configured/provided by the network, e.g., via higher layer RRC signaling/parameter and/or MAC CE command and/or dynamic DCI based signaling, the association/mapping between the TX frequency subbands and the one or more (e.g., Nₜₓ) RIVs (and therefore, the corresponding PRBs) in the FD-RA field(s).

In yet another example, the UE could be indicated by the network, e.g., in a DCI (e.g., DCI format 1_1 or 1_2), one or more (e.g., Nₜₓ) FD-RA fields of the DCI format each providing one or more bitmaps (each providing a number of RBGs) and/or one or more RIVs (each providing a number of PRBs); each FD-RA field is associated to a TX frequency subband. For instance, the first indicated FD-RA field (and therefore, the corresponding bitmap(s) providing a number of RBGs and RIV(s) providing a number of PRBs) could be associated to the first TX frequency subband, the second indicated FD-RA field (and therefore, the corresponding bitmap(s) providing a number of RBGs and RIV(s) providing a number of PRBs) could be associated to the second TX frequency subband, and so on. Alternatively, the UE could be indicated/configured/provided by the network, e.g., via higher layer RRC signaling/parameter and/or MAC CE command and/or dynamic DCI based signaling, the association/mapping between the TX frequency subbands and the one or more (e.g., Nₜₓ) FD-RA fields in a DCI (and therefore, the corresponding bitmap(s) providing one or more RBGs and/or RIV(s) providing one or more PRBs).

In yet another example, one or more of the described design examples herein or combinations of one or more of the described design examples herein could be used to configured/indicate the one or more TX frequency subbands for the indicated TCI state.

For the Nₜ, TX frequency subbands configured/indicated for a TCI state according to one or more of the discussed design examples herein, the UE could be further indicated/configured/provided by the network, via higher layer RRC signaling/parameter and/or MAC CE command and/or dynamic DCI based signaling, one or more of the total configured/indicated TX frequency subbands (e.g., one or more of the Nₜₓ TX frequency subbands) are active for frequency-selective beam indication for FSBM.

In one example, the UE could receive from the network, via higher layer RRC signaling/parameter and/or MAC CE command and/or dynamic DCI based signaling, a bitmap of length Nₜ with each bit position/entry in the bitmap corresponding to a TX frequency subband configured/indicated according to one or more of the herein described design examples. If a bit position/entry in the bitmap is set to ‘1’ (or ‘0’), the corresponding TX frequency subband is used/active—for the indicated TCI state—for frequency-selective beam indication for FSBM. The bitmap could comprise more than one bit positions/entries set to ‘1’ (or ‘0’) indicating that more than one configured/indicated TX frequency subbands can be used/active—for the indicated TCI state—for frequency-selective beam indication for FSBM. For example, for RRC based configuration, the bitmap could be provided in the higher layer parameter(s), e.g., TCI-State, QCL-Info, DLorJointTCI-State or ULTCI-State, that configures a TCI state. For another example, for MAC CE based indication, a MAC CE command could contain/comprise/include the bitmap; for this case, the MAC CE command could also contain/comprise/include the corresponding TCI state ID/index. Yet for another example, for dynamic DCI based signaling, one or more new DCI fields can be introduced to indicate the bitmap indicating one or more active TX frequency subbands—for the indicated TCI state—for frequency-selective beam indication for FSBM; alternatively, one or more bits/codepoints of one or more existing DCI fields could be repurposed to indicate the bitmap.

In another example, the UE could receive from the network, via higher layer RRC signaling/parameter and/or MAC CE command and/or dynamic DCI based signaling, a set of one or more TX frequency subband indexes each determined from {1, . . . , Nₜ}. For this case, the TX frequency subband(s) corresponding to the indicated/configured/provided TX frequency subband index(es) is used/active—for the indicated TCI state—for frequency-selective beam indication for FSBM. For example, for RRC based configuration, the set of one or more TX frequency subband indexes could be indicated/configured/provided in the higher layer parameter(s), e.g., TCI-State, QCL-Info, DLorJointTCI-State or ULTCI-State, that configures a TCI state. For another example, for MAC CE based indication, a MAC CE command could contain/comprise/include the set of TX frequency subband index(es); for this case, the MAC CE command could also contain/comprise/include the corresponding TCI state ID/index. Yet for another example, for dynamic DCI based signaling, one or more new DCI fields can be introduced to indicate the set of TX frequency subband index(es), wherein each set could indicate one or more TX frequency subbands—for the indicated TCI state—for frequency-selective beam indication for FSBM; alternatively, one or more bits/codepoints of one or more existing DCI fields in a DCI format could be repurposed to indicate the set of TX frequency subband index(es).

In yet another example, the UE could receive from the network (e.g., the network 130) a MAC CE activation command activating one or more of the Nₜₓ TX frequency subbands, where the activated one or more TX frequency subbands are used/active—for the indicated TCI state—for frequency-selective beam indication for FSBM. For this case, the MAC CE activation command could also contain/comprise/include the corresponding TCI state ID/index.

In yet another example, the higher layer parameter that configures a TX frequency subband for the indicated TCI state/pair of TCI states could include/indicate/comprise an indicator. If the indicator is set to ‘enabled’/‘on’ or the like, the corresponding TX frequency subband is used/active—for the corresponding indicated TCI state/pair of TCI states—for frequency-selective beam indication for FSBM. Alternatively, the indicator could correspond to a one-big flag indicator. That is, if the one-bit flag indicator is set to ‘1’ (or ‘0’) or the like, the corresponding TX frequency subband is used/active—for the corresponding indicated TCI state/pair of TCI states—for frequency-selective beam indication for FSBM.

The UE could be indicated by the network, e.g., in a MAC CE or DCI (e.g., DCI format 1_1 or 1_2 with or without DL assignment), one or more (i.e., N≥1 or M≥1) TCI states/pairs of TCI states. Here, each of the indicated TCI states/pairs of TCI states (and therefore, the corresponding source RS(s) indicated therein) could be indicated for one or more TX frequency subbands (e.g., N_{tx,m}≥1 TX frequency subbands for the m-th TCI state/pair of TCI states, where m=1, . . . , M); furthermore, each TX frequency subband could be for a set of target channels/signals including PDCCH, PDSCH, PUCCH, PUSCH, CSI-RS and/or SRS.

For an indicated TCI state/pair of TCI states among the M indicated TCI states/pairs of TCI states, the UE could be indicated/configured by the network the corresponding/associated TX frequency subbands including their bandwidths/sizes, starting RBs, etc.; this indication/configuration could be via higher layer RRC signaling and/or MAC CE command and/or dynamic DCI based signaling. There are various means to indicate/configure the TX frequency subbands for an indicated TCI state/pair of TCI states—among the M TCI states/pairs of TCI states indicated in a MAC CE/DCI.

In one example, the configuration/indication of the N_{tx,m} TX frequency subbands for the m-th (m∈{1, . . . , M}) TCI state/pair of TCI states among the M TCI states/pairs of TCI states indicated in a MAC CE/DCI could follow those specified in one or more of the design examples discussed herein in the present disclosure.

In another example, a higher layer RRC parameter, e.g., that configures a TCI state, e.g., TCI-State, QCL-Info, DLorJointTCI-State or ULTCI-State, could include/indicate M sets of TX frequency subband configurations each corresponding/associated to an indicated TCI state/pair of TCI states among the M TCI states/pairs of TCI states indicated in a MAC CE/DCI. Here, for the m-th indicated TCI state, the corresponding set of TX frequency subband configurations could contain/include/configure/provide N_{tx,m} TX frequency subband configurations. A TX frequency subband configuration could contain/comprise at least a TX frequency subband index, a frequency domain allocation of REs for a TX frequency subband and a frequency domain allocation of RBs for a TX frequency subband including at least a starting RB and a number of PRBs across which the corresponding TX frequency subband spans. For example, the M sets of TX frequency subband configurations and the M TCI states/pairs of TCI states indicated in the MAC CE/DCI are one-to-one mapped; for instance, the first set of TX frequency subband configurations could correspond to the first indicated TCI state/pair of TCI states, the second set of TX frequency subband configurations could correspond to the second indicated TCI state/pair of TCI states, and so on, and the M-th set of TX frequency subband configurations could correspond to the M-th indicated TCI state/pair of TCI states. For another example, the UE could be indicated/provided by the network, e.g., via higher layer RRC signaling/parameter and/or MAC CE command and/or dynamic DCI based signaling, the mapping/association between the M sets of TX frequency subband configurations and the M TCI states/pairs of TCI states indicated in the MAC CE/DCI. Optionally, the higher layer parameter(s)—e.g., TCI-State, QCL-Info, DLorJointTCI-State or ULTCI-State that configures a TCI state—that provides the M sets of TX frequency subband configurations could also include/provide/indicate the M TCI state IDs/indexes each associated/mapped to a set of TX frequency subband configurations discussed herein. Alternatively, one or more of the discussed M sets of TX frequency subband configurations herein could be indicated in one or more MAC CE commands/DCIs—e.g., the MAC CE/DCI (e.g., DCI format 1_1 or 1_2 with or without DL assignment) that indicates the M TCI states/pairs of TCI states; for DCI based indication, the one or more of the M sets of TX frequency subband configurations could be indicated via one or more new DCI fields or by repurposing one or more bits/codepoints of one or more existing DCI fields in the DCI(s); furthermore, the association/mapping between the MAC CE/DCI indicated M sets of TX frequency subband configurations and the M TCI states/pairs of TCI states indicated in the MAC CE/DCI could follow those discussed herein for the RRC based configuration/indication of the M sets of TX frequency subband configurations.

In yet another example, a higher layer RRC parameter, e.g., that configures a TCI state, e.g., TCI-State, QCL-Info, DLorJointTCI-State or ULTCI-State, could include/indicate K sets of bitmaps with each set comprising one or more bitmaps for an indicated TCI state/pair of TCI states (e.g., a set of N_{tx,m} bitmaps for the m-th indicated TCI state/pair of TCI states among the M TCI states/pairs of TCI states indicated in MAC CE/DCI). In this example, the configuration/indication of the one or more bitmaps in a set, and the association/mapping between the one or more bitmaps in a set and the TX frequency subband(s) for the corresponding indicated TCI state could follow one or more examples described herein. For example, the M sets of bitmaps and the M indicated TCI states/pairs of TCI states are one-to-one mapped; for instance, the first set of bitmaps could correspond to the first indicated TCI state/pair of TCI states, the second set of bitmaps could correspond to the second indicated TCI state/pair of TCI states, and so on, and the M-th set of bitmaps could correspond to the M-th indicated TCI state/pair of TCI states. For another example, the UE could be indicated/provided by the network, e.g., via higher layer RRC signaling/parameter and/or MAC CE command and/or dynamic DCI based signaling, the mapping/association between the M sets of bitmaps and the M TCI states/pairs of TCI states indicated in the MAC CE/DCI. Optionally, the higher layer parameter(s)—e.g., TCI-State, QCL-Info, DLorJointTCI-State or ULTCI-State that configures a TCI state—that provides the M sets of bitmaps could also include/provide/indicate the M TCI state IDs/indexes each associated/mapped to a set of bitmaps discussed herein. Alternatively, one or more of the discussed M sets of bitmaps herein could be indicated in one or more MAC CE commands/DCIs—e.g., the MAC CE/DCI (e.g., DCI format 1_1 or 1_2 with or without DL assignment) that indicates the M TCI states/pairs of TCI states; for DCI based indication, the one or more of the M sets of bitmaps could be indicated via one or more new DCI fields or by repurposing one or more bits/codepoints of one or more existing DCI fields in the DCI(s); furthermore, the association/mapping between the MAC CE/DCI indicated M sets of bitmaps and the M TCI states/pairs of TCI states indicated in the MAC CE/DCI could follow those discussed herein for the RRC based configuration/indication of the M sets of bitmaps.

In yet another example, a higher layer RRC parameter, e.g., that configures a TCI state, e.g., TCI-State, QCL-Info, DLorJointTCI-State or ULTCI-State, could include/indicate M bitmaps each corresponding/associated to an indicated TCI state/pair of TCI states among the M TCI states/pairs of TCI states indicated in the MAC CE/DCI. In this example, the configuration/indication of a bitmap, and the association/mapping between each bit position/entry in a bitmap and the TX frequency subband(s) for the corresponding TCI state/pair of TCI states could follow one or more examples described herein. For example, the M bitmaps and the M TCI states/pairs of TCI states indicated in the MAC CE/DCI are one-to-one mapped; for instance, the first bitmap could correspond to the first indicated TCI state/pair of TCI states, the second bitmap could correspond to the second indicated TCI state/pair of TCI states, and so on, and the M-th bitmap could correspond to the M-th indicated TCI state/pair of TCI states. For another example, the UE could be indicated/provided by the network, e.g., via higher layer RRC signaling/parameter and/or MAC CE command and/or dynamic DCI based signaling, the mapping/association between the M bitmaps and the M TCI states/pairs of TCI states indicated in the MAC CE/DCI. Optionally, the higher layer parameter(s)—e.g., TCI-State, QCL-Info, DLorJointTCI-State or ULTCI-State that configures a TCI state—that provides the K bitmaps could also include/provide/indicate the M TCI state IDs/indexes each associated/mapped to a bitmap discussed herein. Alternatively, one or more of the herein discussed M bitmaps could be indicated in one or more MAC CE commands/DCIs—e.g., the MAC CE/DCI (e.g., DCI format 1_1 or 1_2 with or without DL assignment) that indicates the M TCI states/pairs of TCI states; for DCI based indication, the one or more of the M bitmaps could be indicated via one or more new DCI fields or by repurposing one or more bits/codepoints of one or more existing DCI fields in the DCI(s); furthermore, the association/mapping between the MAC CE/DCI indicated M bitmaps and the M TCI states/pairs of TCI states indicated in the MAC CE/DCI could follow those discussed herein for the RRC based configuration/indication of the M bitmaps.

In yet another example, the ULE could receive from the network a MAC CE command/DCI indicating/providing/including K sets of bitmaps with each set comprising one or more bitmaps for an indicated TCI state/pair of TCI states (e.g., a set of N_{tx,m} bitmaps for the m-th indicated TCI state/pair of TCI states among the M TCI states/pairs of TCI states indicated in MAC CE/DCI). In this example, the configuration/indication of the one or more bitmaps in a set, and the association/mapping between the one or more bitmaps in a set and the TX frequency subband(s) for the corresponding indicated TCI state/pair of TCI states could follow one or more examples described herein. For example, the M sets of bitmaps in the MAC CE command/DCI and the M TCI states/pairs of TCI states indicated in the MAC CE/DCI are one-to-one mapped; for instance, the first set of bitmaps in the MAC CE command/DCI could correspond to the first indicated TCI state/pair of TCI states, the second set of bitmaps in the MAC CE command/DCI could correspond to the second indicated TCI state/pair of TCI states, and so on, and the M-th set of bitmaps in the MAC CE command/DCI could correspond to the M-th indicated TCI state/pair of TCI states. For another example, the UE could be indicated/provided by the network, e.g., via higher layer RRC signaling/parameter and/or MAC CE command and/or dynamic DCI based signaling, the mapping/association between the M sets of bitmaps configured in the MAC CE command/DCI and the M TCI states/pairs of TCI states indicated in the MAC CE/DCI. The MAC CE command/DCI that provides/indicates the K sets of bitmaps could also indicate the M TCI states/pairs of TCI states each associated/mapped to a set of bitmaps discussed herein.

In yet another example, a UE could receive from the network a MAC CE command/DCI indicating/providing/including M bitmaps each corresponding/associated to an indicated TCI state/pair of TCI states among the M TCI states/pairs of TCI states indicated in the MAC CE/DCI. In this example, the configuration/indication of a bitmap, and the association/mapping between each bit position/entry in a bitmap and the TX frequency subband(s) for the corresponding indicated TCI state/pair of TCI states could follow those specified in one or more examples described herein. For example, the M bitmaps indicated in the MAC CE command/DCI and the M TCI states/pairs of TCI states indicated in the MAC CE/DCI are one-to-one mapped; for instance, the first bitmap in the MAC CE command/DCI could correspond to the first indicated TCI state/pair of TCI states, the second bitmap in the MAC CE command/DCI could correspond to the second indicated TCI state/pair of TCI states, and so on, and the M-th bitmap in the MAC CE command/DCI could correspond to the M-th indicated TCI state/pair of TCI states. For another example, the UE could be indicated/provided by the network, e.g., via higher layer RRC signaling/parameter and/or MAC CE command and/or dynamic DCI based signaling, the mapping/association between the M bitmaps in the MAC CE command/DCI and the M TCI states/pairs of TCI states indicated in the MAC CE/DCI. The MAC CE command/DCI that provides/indicates the M bitmaps could also indicate the M TCI states/pairs of TCI states each associated/mapped to a bitmap discussed herein.

In yet another example, the UE could receive from the network one or more MAC CE activation commands (e.g., N_{tx,m} MAC CE activation commands) each for a TX frequency subband for an indicated TCI state/pair of TCI states (e.g., the m-th TCI state/pair of TCI states) among the M TCI states/pairs of TCI states indicated in the MAC CE/DCI. Each MAC CE activation command could activate one or more PRBs or PRB indexes—from the PRBs configured, e.g., within the BWP/CC or a frequency band/bandwidth configured for the corresponding indicated TCI state—for the corresponding/associated TX frequency subband. For this case, each MAC CE activation command could include/provide/indicate the corresponding TCI state ID/index and/or TX frequency subband index(es).

In yet another example, the UE could receive from the network one or more (e.g., M) MAC CE activation commands each activating one or more PRBs or PRB indexes—from the PRBs configured, e.g., within the BWP/CC—for one or more of the TX frequency subbands for an indicated TCI state among the M TCI states indicated in the MAC CE/DCI. For instance, the MAC CE activation command corresponding/associated to the m-th TCI state/pair of TCI states could activate one or more PRBs or PRB indexes—from the PRBs configured, e.g., within the BWP/CC—for the first TX frequency subband for the m-th TCI state/pair of TCI states, one or more PRBs or PRB indexes—from the PRBs configured, e.g., within the BWP/CC or a frequency band/bandwidth configured for the corresponding indicated TCI state—for the second TX frequency subband for the m-th TCI state/pair of TCI states, and so on, and one or more PRBs or PRB indexes—from the PRBs configured, e.g., within the BWP/CC—for the N_{tx,m}-th TX frequency subband for the m-th TCI state/pair of TCI states, where m∈{1, . . . , M}. For this case, the MAC CE activation command could include/provide/indicate the corresponding TCI state ID/index.

In yet another example, the TX frequency subbands for an indicated TCI state—e.g., the N_{tx,m} TX frequency subbands for the m-th indicated TCI state among the M indicated TCI states could have the same bandwidth/size. For this case, the UE could be provided by the network, via higher layer RRC signaling (e.g., in TCI-State, QCL-Info, DLorJointTCI-State or ULTCI-State) and/or MAC CE command and/or dynamic DCI based signaling, a common TX frequency subband bandwidth/size (e.g., in number of PRBs) for the corresponding indicated TCI state (e.g., the m-th indicated TCI state/pair of TCI states among the M indicated TCI states/pairs of TCI states) and/or N_{tx,m} and/or one or more starting RBs of one or more TX frequency subbands for the corresponding indicated TCI state (e.g., the m-th indicated TCI state/pair of TCI states among the M indicated TCI states/pairs of TCI states). In addition, the TX frequency subbands for the indicated TCI state—e.g., the N_{tx,m} TX frequency subbands for the m-th indicated TCI state among the M indicated TCI states—could equally divide the total PRBs configured, e.g., within the BWP/CC or a frequency band/bandwidth configured for the corresponding indicated TCI state. For this case, the UE could be provided by the network, via higher layer RRC signaling (e.g., in e.g., in TCI-State, QCL-Info, DLorJointTCI-State or ULTCI-State) and/or MAC CE command and/or dynamic DCI based signaling, N_{tx,m} and/or one or more starting RBs of one or more TX frequency subbands for the corresponding indicated TCI state (e.g., the m-th indicated TCI state/pair of TCI states among the M indicated TCI states/pairs of TCI states).

In yet another example, the TX frequency subbands for the M indicated TCI states could have the same bandwidth/size. For this case, the UE could be provided by the network, via higher layer RRC signaling (e.g., in TCI-State, QCL-Info, DLorJointTCI-State or ULTCI-State) and/or MAC CE command and/or dynamic DCI based signaling, a common TX frequency subband bandwidth/size (e.g., in number of PRBs) for the M indicated TCI states/pairs of TCI states and/or the number of TX frequency subbands for each of the M indicated TCI states and/or one or more starting RBs of one or more TX frequency subbands for each of the M indicated TCI states. In addition, the TX frequency subbands for the M indicated TCI states could equally divide the total PRBs configured, e.g., within the BWP/CC. For this case, the UE could be provided by the network, via higher layer RRC signaling (e.g., in e.g., in TCI-State, QCL-Info, DLorJointTCI-State or ULTCI-State) and/or MAC CE command and/or dynamic DCI based signaling, the number of TX frequency subbands for each of the M indicated TCI states and/or one or more starting RBs of one or more TX frequency subbands for each of the M indicated TCI states.

In yet another example, the TX frequency subbands for an indicated TCI state/pair of TCI states (e.g., the m-th indicated TCI state/pair of TCI states among the M indicated TCI states/pairs of TCI states) could correspond to one or more of the frequency subbands configured for frequency-selective beam measurement for FSBM (e.g., according to one or more examples described herein) and/or one or more reporting frequency subbands, with which one or more (frequency-selective) CSI/beam reports are associated. For instance, the TX frequency subbands for the m-th indicated TCI state/pair of TCI states could correspond to the frequency subbands configured for the k-th CSI-RS resource in a CSI resource subset/group or CSI resource set or CSI resource setting for frequency-selective beam measurement for FSBM, or the frequency subbands configured for the CSI-RS resources in the k-th CSI resource subset/group in a resource set for frequency-selective beam measurement for FSBM, where m∈{1, . . . , M} and k∈{1, . . . , K}. The mapping/association between one or more of the indicated TCI states (and therefore, the corresponding TX frequency subbands) and one or more of the CSI-RS resources or CSI resource subsets/groups of CSI resource sets or CSI resource settings for frequency-selective beam measurement for FSBM (and therefore, the corresponding measurement frequency subbands) could be fixed in the system specifications, and known to both the network and UE sides a prior. Alternatively, the UE could be indicated/configured/provided by the network, e.g., via higher layer RRC signaling and/or MAC CE command and/or dynamic DCI based signaling, the mapping/association between one or more of the indicated TCI states (and therefore, the corresponding TX frequency subbands) and one or more of the CSI-RS resources or CSI resource subsets/groups of CSI resource sets or CSI resource settings for frequency-selective beam measurement for FSBM (and therefore, the corresponding measurement frequency subbands). Furthermore, for the example described herein, the TX frequency subbands for the m-th indicated TCI state/pair of TCI states could be one-to-one mapped to the frequency subbands configured for the k-th CSI-RS resource in a CSI resource subset/group or CSI resource set or CSI resource setting for frequency-selective beam measurement for FSBM, or the frequency subbands configured for the CSI-RS resources in the k-th CSI resource subset/group in a resource set for frequency-selective beam measurement for FSBM, or the reporting frequency subbands with which the CSI/beam reports are associated—e.g., the first TX frequency subband is associated to the first measurement frequency subband, the second TX frequency subband is associated to the second measurement frequency subband, and so on. Optionally, the UE could be indicated/configured/provided by the network, e.g., via higher layer RRC signaling and/or MAC CE command and/or dynamic DCI based signaling, the mapping/association relationship between the TX frequency subbands for the m-th indicated TCI state/pair of TCI states and the frequency subbands configured for the k-th CSI-RS resource in a CSI resource subset/group or CSI resource set or CSI resource setting for frequency-selective beam measurement for FSBM, or the frequency subbands configured for the CSI-RS resources in the k-th CSI resource subset/group in a resource set for frequency-selective beam measurement for FSBM, or the reporting frequency subbands with which the CSI/beam reports are associated, where m∈{1, . . . , M} and k∈{1, . . . , K}.

In yet another example, the TX frequency subbands for an indicated TCI state/pair of TCI states (among the M TCI states/pairs of TCI states indicated in the MAC CE/DCI) could correspond to the frequency subbands indicated in a DCI (e.g., DCI format 1_1 or 1_2) for DL and/or UL resource allocation. The frequency subbands for resource allocation/assignment (RA) could be indicated in the frequency domain resource allocation (FD-RA) field(s) of a DCI. The FD-RA field could contain a bitmap with each bit position/entry in the bitmap corresponding to a resource block group (RBG)—Type 0, i.e., the bitmap indicates the frequency domain resource allocation in RBG(s). The FD-RA field could contain a resource indicator value (RIV) indicating the continuous virtual resource blocks (VRBs)—Type 1; depending on the value of “VRB-to-PRB mapping”, the corresponding PRBs associated with the indicated VRBs could be identified. There could be various means to associate/map the TX frequency subbands for an indicated TCI state/pairs of TCI states and the frequency subbands indicated in the FD-RA field(s) for DL/UL RA.

For example, the mapping/association between the TX frequency subbands for each of the M indicated TCI states/pairs of TCI states and the frequency subbands indicated in FD-RA field(s) for DL/UL RA could be fixed (e.g., in the system specifications) and known to both the network (e.g., the network 130) and UE sides a prior. For instance, for Type 0 RA, the first one or more bit positions/entries (and therefore the corresponding RBGs) in the bitmap could be associated to the first TX frequency subband for the m-th indicated TCI state/pair of TCI states, the second one or more bit positions/entries (and therefore, the corresponding RBGs) in the bitmap could be associated to the second TX frequency subband for the m-th indicated TCI state/pair of TCI states, and so on, where m∈{1, . . . , M}. For Type 1 RA, a first RIV (and therefore, the corresponding PRBs) could be associated to the first TX frequency subband for the m-th indicated TCI state/pair of TCI states, a second RIV (and therefore, the corresponding PRBs) could be associated to the second TX frequency subband for the m-th indicated TCI state/pair of TCI states, and so on, where m∈{1, . . . , M}.

For another example, the UE (e.g., the UE 116) could be indicated/configured/provided by the network, e.g., via higher layer RRC signaling/parameter and/or MAC CE command and/or dynamic DCI based signaling, the mapping/association between the TX frequency subbands for each of the M indicated TCI states/pairs of TCI states and the frequency subbands indicated in FD-RA field(s) for DL/UL RA. For instance, for Type 0 RA, the UE could be indicated/configured/provided by the network, e.g., via higher layer RRC signaling/parameter and/or MAC CE command and/or dynamic DCI based signaling, the association/mapping between the TX frequency subbands for each of the M indicated TCI states/pairs of TCI states and one or more bit positions/entries (and therefore, the corresponding RBGs) in the bitmap. For Type 1 RA, the UE could be indicated/configured/provided by the network, e.g., via higher layer RRC signaling/parameter and/or MAC CE command and/or dynamic DCI based signaling, the association/mapping between the TX frequency subbands for each of the M indicated TCI states/pairs of TCI states and one or more RIVs (and therefore, the corresponding PRBs).

In yet another example, the UE could be indicated by the network, e.g., in a DCI (e.g., DCI format 1_1 or 1_2), M sets of bitmaps in FD-RA field(s) of the DCI format with each set comprising one or more (e.g., N_{tx,m}) bitmaps each providing one or more (multiples of) RBGs and associated to a TX frequency subband for an indicated TCI state/pair of TCI states (e.g., the m-th indicated TCI state/pair of TCI states among the M TCI states/pairs of TCI states indicated in the MAC CE/DCI). For instance, the first indicated set of bitmaps (and therefore, the corresponding bitmaps and indicated RBGs) could be associated to the TX frequency subbands for the first indicated TCI state/pairs of TCI state, the second indicated set of bitmaps (and therefore, the corresponding bitmaps and indicated RBGs) could be associated to the TX frequency subbands for the second indicated TCI state/pairs of TCI states, and so on. Alternatively, the UE could be indicated/configured/provided by the network, e.g., via higher layer RRC signaling/parameter and/or MAC CE command and/or dynamic DCI based signaling, the association/mapping between the TX frequency subbands for each of the M TCI states/pairs of TCI states indicated in the MAC CE/DCI and the M sets of bitmaps (and therefore, the corresponding RBGs) in the FD-RA field(s).

In yet another example, the UE could be indicated by the network, e.g., in a DCI (e.g., DCI format 1_1 or 1_2), M sets of RIVs in FD-RA field(s) of the DCI format with each set comprising one or more (e.g., N_{tx,m}) RIVs each providing one or more PRBs and associated to a TX frequency subband for an indicated TCI state/pair of TCI states (e.g., the m-th indicated TCI state/pair of TCI states among the M TCI states/pairs of TCI states indicated in the MAC CE/DCI). For instance, the first indicated set of RIVs (and therefore, the corresponding RIVs and indicated PRBs) could be associated to the TX frequency subbands for the first indicated TCI state/pair of TCI states, the second indicated set of RIVs (and therefore, the corresponding RIVs and indicated PRBs) could be associated to the TX frequency subbands for the second indicated TCI state/pair of TCI states, and so on. Alternatively, the UE could be indicated/configured/provided by the network, e.g., via higher layer RRC signaling/parameter and/or MAC CE command and/or dynamic DCI based signaling, the association/mapping between the TX frequency subbands for each of the M TCI states/pairs of TCI states indicated in the MAC CE/DCI and the M sets of RIVs (and therefore, the corresponding PRBs) in the FD-RA field(s).

In yet another example, the UE could be indicated by the network, e.g., in a DCI (e.g., DCI format 1_1 or 1_2), M sets of FD-RA fields of the DCI format with each set comprising one or more (e.g., N_{tx,m}) FD-RA fields each providing one or more bitmaps (each providing a number of RBGs) and/or one or more RIVs (each providing a number of PRBs); each set of FD-RA fields is associated to the TX frequency subbands for an indicated TCI state/pair of TCI states (e.g., the m-th indicated TCI state/pair of TCI states among the M TCI states/pairs of TCI states indicated in the MAC CE/DCI). For instance, the first indicated set of FD-RA fields (and therefore, the corresponding FD-RA fields, bitmap(s) providing a number of RBGs and RIV(s) providing a number of PRBs) could be associated to the TX frequency subbands for the first indicated TCI state/pair of TCI states, the second indicated set of FD-RA fields (and therefore, the corresponding FD-RA fields, bitmap(s) providing a number of RBGs and RIV(s) providing a number of PRBs) could be associated to the TX frequency subbands for the second indicated TCI state/pair of TCI states, and so on. Alternatively, the UE could be indicated/configured/provided by the network, e.g., via higher layer RRC signaling/parameter and/or MAC CE command and/or dynamic DCI based signaling, the association/mapping between the TX frequency subbands for each of the M TCI states/pairs of TCI states indicated in the MAC CE/DCI and the M sets of FD-RA fields in a DCI (and therefore, the corresponding FD-RA fields, bitmap(s) providing one or more RBGs and/or RIV(s) providing one or more PRBs).

For the TX frequency subbands configured/indicated for an indicated TCI state/pair of TCI states among the M indicated TCI states/pairs of TCI states (e.g., the N_{tx,m} TX frequency subbands configured/indicated for the m-th indicated TCI state/pair of TCI states among the M TCI states/pairs of TCI states indicated in the MAC CE/DCI) according to one or more of the discussed design examples herein, the UE could be further indicated/configured/provided by the network, via higher layer RRC signaling/parameter and/or MAC CE command and/or dynamic DCI based signaling, one or more of the total configured/indicated TX frequency subbands for an indicated TCI state/pair of TCI states (e.g., one or more of the N_{tx,m} TX frequency subbands for the m-th indicated TCI state) are active—for the corresponding indicated TCI state/pair of TCI states—for frequency-selective beam indication for FSBM.

In one example, the configuration/indication of the TX frequency subbands—for an indicated TCI state/pair of TCI states (e.g., one or more of the N_{tx,m} TX frequency subbands for the m-th indicated TCI state/pair of TCI states among the M TCI states/pairs of TCI states indicated in the MAC CE/DCI)—for frequency-selective beam indication for FSBM could follow one or more examples described herein. Additional examples are described herein.

For example, a higher layer RRC parameter, e.g., TCI-State, QCL-Info, DLorJointTCI-State or ULTCI-State that configures a TCI state, could include/indicate a set of one or more (e.g., M) bitmaps (configuration of a bitmap could follow one or more examples described herein) each corresponding/associated to an indicated TCI state/pair of TCI states among the indicated TCI states/pairs of TCI states (e.g., the m-th indicated TCI state/pair of TCI states among the M TCI states/pairs of TCI states indicated in the MAC CE/DCI). For example, the M bitmaps are one-to-one mapped to the M TCI states/pairs of TCI states indicated in the MAC CE/DCI; for instance, the first bitmap could correspond to the first indicated TCI state/pair of TCI states, the second bitmap could correspond to the second indicated TCI state/pair of TCI states, and so on, and the M-th bitmap could correspond to the M-th indicated TCI state/pair of TCI states. For another example, the UE could be provided/indicated by the network, via higher layer RRC signaling/parameter and/or MAC CE command and/or dynamic DCI based signaling, the mapping/association between the M bitmaps and the M TCI states/pairs of TCI states indicated in the MAC CE/DCI. Optionally, the higher layer parameter(s), e.g., TCI-State, QCL-Info, DLorJointTCI-State or ULTCI-State that configures a TCI state, that provides the M bitmaps could also include/provide/indicate the M TCI state IDs/indexes each associated/mapped to a bitmap discussed herein.

For another example, a MAC CE command could contain/comprise/include/provide multiple (e.g., M) bitmaps (configuration of a bitmap could one or more examples described herein) each corresponding/associated to an indicated TCI state/pair of TCI states among the indicated TCI states/pairs of TCI states (e.g., the m-th indicated TCI state/pair of TCI states among the M TCI states/pairs of TCI states indicated in the MAC CE/DCI). For example, the M bitmaps provided in the MAC CE command are one-to-one mapped to the M TCI states/pairs of TCI states indicated in the MAC CE/DCI; for instance, the first bitmap in the MAC CE command could correspond to the first indicated TCI state/pair of TCI states, the second bitmap in the MAC CE command could correspond to the second indicated TCI state/pair of TCI states, and so on, and the M-th bitmap in the MAC CE command could correspond to the M-th indicated TCI state/pair of TCI states. For another example, the UE could be provided/indicated by the network, via higher layer RRC signaling/parameter and/or MAC CE command and/or dynamic DCI based signaling, the mapping/association between the M bitmaps indicated/configured/provided in the MAC CE command and the M TCI states/pairs of TCI states indicated in the MAC CE/DCI. Optionally, the MAC CE command that provides the M bitmaps could also include/provide/indicate the M TCI states/pairs of TCI states (e.g., the MAC CE command for beam indication) each associated/mapped to a bitmap discussed herein.

Yet for another example, one or more new DCI fields can be introduced to indicate one or more of the M bitmaps each indicating one or more TX frequency subbands—for the corresponding indicated TCI state/pair of TCI states (among the M TCI states/pairs of TCI states indicated in the MAC CE/DCI)—for frequency-selective beam indication for FSBM; alternatively, one or more bits/codepoints of one or more existing DCI fields could be repurposed to indicate one or more of the M bitmaps each indicating one or more TX frequency subbands—for the corresponding indicated TCI state/pair of TCI states (among the M TCI states/pairs of TCI states indicated in the MAC CE/DCI)—for frequency-selective beam indication for FSBM.

In another example, the configuration/indication of the TX frequency subbands—for an indicated TCI state/pair of TCI states (e.g., one or more of the N_{tx,m} TX frequency subbands for the m-th indicated TCI state/pair of TCI states among the M TCI states/pairs of TCI states indicated in the MAC CE/DCI)—for frequency-selective beam indication for FSBM could follow one or more examples described herein. Additional examples are described herein.

For example, a higher layer RRC parameter, e.g., TCI-State, QCL-Info, DLorJointTCI-State or ULTCI-State that configures a TCI state, could include/indicate one or more (e.g., M) sets of TX frequency subband indexes (configuration of a set of TX frequency subband indexes could follow one or more examples described herein) each corresponding/associated to an indicated TCI state/pair of TCI states among the indicated TCI states/pairs of TCI states (e.g., the m-th indicated TCI state/pair of TCI states among the M TCI states/pairs of TCI states indicated in the MAC CE/DCI). For example, the M sets of TX frequency subband indexes are one-to-one mapped to the M TCI states/pairs of TCI states indicated in the MAC CE/DCI; for instance, the first set of TX frequency subband indexes could correspond to the first indicated TCI state/pair of TCI states, the second set of TX frequency subband indexes could correspond to the second indicated TCI state/pair of TCI states, and so on, and the M-th set of TX frequency subband indexes could correspond to the M-th indicated TCI state/pair of TCI states. For another example, the UE could be provided/indicated by the network, via higher layer RRC signaling/parameter and/or MAC CE command and/or dynamic DCI based signaling, the mapping/association between the M sets of TX frequency subband indexes and the M TCI states/pairs of TCI states indicated in the MAC CE/DCI. Optionally, the higher layer parameter(s), e.g., TCI-State, QCL-Info, DLorJointTCI-State or ULTCI-State that configures a TCI state, that provides the M sets of TX frequency subband indexes could also include/provide/indicate the M TCI state IDs/indexes each associated/mapped to a set of TX frequency subbands discussed herein.

For another example, a MAC CE command could contain/comprise/include/provide multiple (e.g., M) sets of TX frequency subband indexes (configuration of a set of TX frequency subband indexes could follow one or more examples described herein) each corresponding/associated to an indicated TCI state/pair of TCI states among the indicated TCI states/pairs of TCI states (e.g., the m-th indicated TCI state/pair of TCI states among the M TCI states/pairs of TCI states indicated in the MAC CE/DCI). For example, the M sets of TX frequency subband indexes provided in the MAC CE command are one-to-one mapped to the M TCI states/pairs of TCI states indicated in the MAC CE/DCI; for instance, the first set of TX frequency subband indexes in the MAC CE command could correspond to the first indicated TCI state/pair of TCI states, the second set of TX frequency subband indexes in the MAC CE command could correspond to the second indicated TCI state/pair of TCI states, and so on, and the M-th set of TX frequency subband indexes in the MAC CE command could correspond to the M-th indicated TCI state/pair of TCI states. For another example, the UE could be provided/indicated by the network, via higher layer RRC signaling/parameter and/or MAC CE command and/or dynamic DCI based signaling, the mapping/association between the M sets of TX frequency subband indexes indicated/configured/provided in the MAC CE command and the M TCI states/pairs of TCI states indicated in the MAC CE/DCI. Optionally, the MAC CE command that provides the M sets of TX frequency subband indexes could also include/provide/indicate the M TCI states/pairs of TCI states (e.g., the MAC CE command for beam indication) each associated/mapped to a set of TX frequency subband indexes discussed herein.

Yet for another example, one or more new DCI fields can be introduced to indicate one or more of the M sets of TX frequency subband indexes each indicating one or more TX frequency subbands—for the corresponding indicated TCI state/pair of TCI states (among the M TCI states/pairs of TCI states indicated in the MAC CE/DCI)—for frequency-selective beam indication for FSBM; alternatively, one or more bits/codepoints of one or more existing DCI fields could be repurposed to indicate one or more of the M sets of TX frequency subband indexes each indicating one or more TX frequency subbands—for the corresponding indicated TCI state/pair of TCI states (among the M TCI states/pairs of TCI states indicated in the MAC CE/DCI)—for frequency-selective beam indication for FSBM.

In yet another example, the configuration/indication of the TX frequency subbands—for an indicated TCI state/pair of TCI states (e.g., one or more of the N_{tx,m} TX frequency subbands for the m-th indicated TCI state/pair of TCI states among the M TCI states/pairs of TCI states indicated in the MAC CE/DCI)—for frequency-selective beam indication for FSBM could follow one or more examples described herein. Additional examples are described herein.

For example, a MAC CE activation command could activate multiple (e.g., M) sets of one or more TX frequency subbands with each set corresponding/associated to an indicated TCI state/pair of TCI states among the indicated TCI states/pairs of TCI states (e.g., the m-th indicated TCI state/pair of TCI states among the M TCI states/pairs of TCI states indicated in the MAC CE/DCI). For example, the MAC CE activation command could activate the first set of one or more TX frequency subbands from the N_{tx,1} TX frequency subbands indicated/configured for the first indicated TCI state/pair of TCI states, the second set of one or more TX frequency subbands from the N_{tx,2} TX frequency subbands indicated/configured for the second indicated TCI state/pair of TCI states, and so on, and the M-th set of one or more TX frequency subbands from the N_{tx,M}TX frequency subbands indicated/configured for K-th indicated TCI state/pair of TCI states. For another example, the UE could be provided/indicated by the network, via higher layer RRC signaling/parameter and/or MAC CE command and/or dynamic DCI based signaling, the mapping/association between the M sets of TX frequency subbands activated by the MAC CE activation command and the M TCI states/pairs of TCI states indicated in the MAC CE/DCI. A set of TX frequency subbands activated by the MAC CE activation command are used/active—for the corresponding indicated TCI state/pair of TCI states—for frequency-selective beam indication for FSBM. Optionally, the MAC CE activation command that activates the M sets of TX frequency subbands could also include/provide/indicate the M TCI state IDs/indexes, each associated/mapped to a set of activated TX frequency subbands for frequency-selective beam indication for FSBM.

In yet another example, the higher layer parameter that configures a TX frequency subband for an indicated TCI state/pair of TCI states among the indicated TCI states/pairs of TCI states (e.g., the m-th indicated TCI state/pair of TCI states among the M TCI states/pairs of TCI states indicated in the MAC CE/DCI) could include/indicate/comprise an indicator. If the indicator is set to ‘enabled’/‘on’ or the like, the corresponding TX frequency subband is used/active—for the corresponding indicated TCI state/pair of TCI states—for frequency-selective beam indication for FSBM. Alternatively, the indicator could correspond to a one-big flag indicator. That is, if the one-bit flag indicator is set to ‘1’ (or ‘0’) or the like, the corresponding TX frequency subband is used/active—for the corresponding indicated TCI state/pair of TCI states—for frequency-selective beam indication for FSBM.

As discussed herein, a ULE could be indicated by the network, e.g., in a MAC CE or DCI (e.g., DCI format 1_1 or 1_2 with or without DL assignment), a single (i.e., N=1 or M=1) TCI state/pair of TCI states; furthermore, the UE could be indicated/configured/provided by the network, via higher layer RRC signaling and/or MAC CE command and/or dynamic DCI based signaling, one or more TX frequency subbands for the indicated TCI state following one or more examples described herein. Here, the indicated TCI state could indicate/provide one or more (e.g., Nᵣₛ) QCL source RSs (with the same or different QCL types)—e.g., the higher layer parameter(s) TCI-State, QCL-Info, DLorJointTCI-State or UL-TCIState that configures a TCI state could include/contain/provide the one or more (QCL) source RSs—each corresponding/associated to one or more of the TX frequency subbands configured/indicated for the indicated TCI state/pair of TCI states for frequency-selective beam indication for FSBM.

In one example, the UE could be indicated/configured/provided by the network, e.g., via higher layer RRC signaling/parameter and/or MAC CE command and/or dynamic DCI based signaling, one or more (e.g., Nᵣₛ) sets of TX frequency subband indexes each for a QCL source RS indicated in the corresponding TCI state. The indicated/configured one or more sets of TX frequency subband indexes and the QCL source RSs indicated in the corresponding TCI state could be one-to-one mapped—e.g., the first indicated/configured set of TX frequency subband indexes (and therefore, the corresponding TX frequency subbands) is associated to the first indicated QCL source RS in the TCI state, the second indicated/configured set of TX frequency subband indexes (and therefore, the corresponding TX frequency subbands) is associated to the second indicated QCL source RS in the TCI state, and so on, and the Nᵣₛ-th indicated/configured set of TX frequency subband indexes (and therefore, the corresponding TX frequency subbands) is associated to the Nᵣₛ-th indicated QCL source RS in the TCI state. Alternatively, the UE could be indicated/configured/provided by the network, e.g., via higher layer RRC signaling/parameter and/or MAC CE command and/or dynamic DCI based signaling, the association/mapping between the indicated/configured one or more sets of TX frequency subband indexes (and therefore, the corresponding TX frequency subbands) and the QCL source RSs indicated in the corresponding TCI state.

In another example, the UE could be indicated/configured/provided by the network, e.g., via higher layer RRC signaling/parameter and/or MAC CE command and/or dynamic DCI based signaling, a set of TX frequency subband indexes. The set of TX frequency subband indexes could be partitioned into one or more (e.g., Nᵣₛ) parts—each part comprises one or more of the TX frequency subband indexes in the set—each for a QCL source RS indicated in the corresponding TCI state. The partition of the set of TX frequency subband indexes into the one or more (e.g., Nᵣₛ) parts could be fixed in the system specifications and/or indicated/configured to the UE via higher layer RRC signaling and/or MAC CE command and/or dynamic DCI based signaling. The one or more parts of the indicated/configured set of TX frequency subband indexes and the QCL source RSs indicated in the corresponding TCI state could be one-to-one mapped—e.g., the first part of the indicated/configured set of TX frequency subband indexes (and therefore, the corresponding TX frequency subbands) is associated to the first indicated QCL source RS in the TCI state, the second part of the indicated/configured set of TX frequency subband indexes (and therefore, the corresponding TX frequency subbands) is associated to the second indicated QCL source RS in the TCI state, and so on, and the Nᵣₛ-th part of the indicated/configured set of TX frequency subband indexes (and therefore, the corresponding TX frequency subbands) is associated to the Nᵣₛ-th indicated QCL source RS in the TCI state. Alternatively, the UE could be indicated/configured/provided by the network, e.g., via higher layer RRC signaling/parameter and/or MAC CE command and/or dynamic DCI based signaling, the association/mapping between the one or more parts in the indicated/configured set of TX frequency subband indexes (and therefore, the corresponding TX frequency subbands) and the QCL source RSs indicated in the corresponding TCI state.

In yet another example, the UE could be indicated/configured/provided by the network, e.g., via higher layer RRC signaling/parameter and/or MAC CE command and/or dynamic DCI based signaling, one or more (e.g., Nᵣₛ) bitmaps each for a QCL source RS indicated in the corresponding TCI state. Each bit position/entry in a bitmap could correspond to a TX frequency subband configured/indicated for the corresponding indicated TCI state/pair of TCI states for frequency-selective beam indication for FSBM. If a bit position/entry of a bitmap is set to ‘1’ (or ‘0’), the TX frequency subband corresponding/associated to the bit position/entry is used/active for the QCL source RS corresponding/associated to the bitmap. The indicated/configured one or more bitmaps and the QCL source RSs indicated in the corresponding TCI state could be one-to-one mapped—e.g., the first indicated/configured bitmap (and therefore, the corresponding TX frequency subbands) is associated to the first indicated QCL source RS in the TCI state, the second indicated/configured bitmap (and therefore, the corresponding TX frequency subbands) is associated to the second indicated QCL source RS in the TCI state, and so on, and the Nᵣₛ-th indicated/configured bitmap (and therefore, the corresponding TX frequency subbands) is associated to the Nᵣₛ-th indicated QCL source RS in the TCI state. Alternatively, the UE could be indicated/configured/provided by the network, e.g., via higher layer RRC signaling/parameter and/or MAC CE command and/or dynamic DCI based signaling, the association/mapping between the indicated/configured one or more bitmaps (and therefore, the corresponding TX frequency subbands) and the QCL source RSs indicated in the corresponding TCI state.

In yet another example, the UE could be indicated/configured/provided by the network, e.g., via higher layer RRC signaling/parameter and/or MAC CE command and/or dynamic DCI based signaling, a bitmap comprising one or more (e.g., Nᵣₛ) parts each for a QCL source RS indicated in the corresponding TCI state. The partition of the bitmap into the one or more (e.g., Nᵣₛ) parts could be fixed in the system specifications and/or indicated/configured to the UE via higher layer RRC signaling and/or MAC CE command and/or dynamic DCI based signaling. Each bit position/entry in a bitmap could correspond to a TX frequency subband configured/indicated for the corresponding indicated TCI state/pair of TCI states for frequency-selective beam indication for FSBM. If a bit position/entry of a part in the bitmap is set to ‘1’ (or ‘0’), the TX frequency subband corresponding/associated to the bit position/entry is used/active for the QCL source RS corresponding/associated to the part of the bitmap. The one or more parts in the indicated/configured bitmap and the QCL source RSs indicated in the corresponding TCI state could be one-to-one mapped—e.g., the first part in the indicated/configured bitmap (and therefore, the corresponding TX frequency subbands) is associated to the first indicated QCL source RS in the TCI state, the second part in the indicated/configured bitmap (and therefore, the corresponding TX frequency subbands) is associated to the second indicated QCL source RS in the TCI state, and so on, and the Nᵣₛ-th part of the indicated/configured bitmap (and therefore, the corresponding TX frequency subbands) is associated to the Nᵣₛ-th indicated QCL source RS in the TCI state. Alternatively, the UE could be indicated/configured/provided by the network, e.g., via higher layer RRC signaling/parameter and/or MAC CE command and/or dynamic DCI based signaling, the association/mapping between the one or more parts in the indicated/configured bitmap (and therefore, the corresponding TX frequency subbands) and the QCL source RSs indicated in the corresponding TCI state.

In yet another example, the UE could receive from the network one or more (e.g., Nᵣₛ) MAC CE activation commands each activating one or more TX frequency subbands—from the TX frequency subbands configured/indicated for the indicated TCI state—for a QCL source RS indicated in the corresponding TCI state. For this case, a MAC CE activation command could also contain/include/provide the corresponding source RS resource ID/index.

In yet another example, the UE could receive from the network a MAC CE activation command activating one or more TX frequency subbands—from the TX frequency subbands configured/indicated for the indicated TCI state—for each of the Nᵣₛ QCL source RSs indicated in the corresponding TCI state. For instance, the MAC CE activation command could activate a first part of TX frequency subbands—from the TX frequency subbands configured/indicated for the indicated TCI state, a second part of TX frequency subbands—from the TX frequency subbands configured/indicated for the indicated TCI state, and so on. The one or more MAC CE activated parts of TX frequency subbands and the QCL source RSs indicated in the corresponding TCI state could be one-to-one mapped—e.g., the first MAC CE activated part of TX frequency subbands is associated to the first indicated QCL source RS in the TCI state, the second MAC CE activated part of TX frequency subbands is associated to the second indicated QCL source RS in the TCI state, and so on, and the Nᵣₛ-th MAC CE activated part of TX frequency subbands is associated to the Nᵣₛ-th indicated QCL source RS in the TCI state. Alternatively, the UE could be indicated/configured/provided by the network, e.g., via higher layer RRC signaling/parameter and/or MAC CE command and/or dynamic DCI based signaling, the association/mapping between the MAC CE activated parts of TX frequency subbands and the QCL source RSs indicated in the corresponding TCI state.

In yet another example, the UE could be indicated/configured/provided by the network, e.g., via higher layer RRC signaling/parameter and/or MAC CE command and/or dynamic DCI based signaling, the number(s) of TX frequency subbands for one or more of the Nᵣₛ QCL source RSs indicated in the corresponding TCI state and/or starting RB(s) for one or more of the Nᵣₛ QCL source RSs indicated in the corresponding TCI state.

In yet another example, one or more examples described herein could be used/configured for configuring/indicating the TX frequency subband(s) for a QCL source RS indicated in a TCI state.

As discussed herein, a UE could be indicated by the network, e.g., in a MAC CE or DCI (e.g., DCI format 1_1 or 1_2 with or without DL assignment), one or more (i.e., N≥1 or M≥1) TCI states/pairs of TCI states; furthermore, the UE could be indicated/configured/provided by the network, via higher layer RRC signaling and/or MAC CE command and/or dynamic DCI based signaling, one or more TX frequency subbands for each of the indicated TCI states/pairs of TCI states (and therefore, the corresponding source RS(s) indicated therein) following one or more examples described herein.

In one example, if an indicated TCI state (among the M TCI states indicated in the MAC CE/DCI) comprises/indicates/provides one or more (e.g., Nᵣₛ≥1 or Nᵣ≥1) QCL source RSs (with the same or different QCL types)—e.g., the higher layer parameter(s) TCI-State, QCL-Info, DLorJointTCI-State or UL-TCIState that configures the TCI state could include/contain/provide the one or more (QCL) source RSs—each corresponding/associated to one or more of the TX frequency subbands configured/indicated for the indicated TCI state/pair of TCI states for frequency-selective beam indication for FSBM, the configuration/indication of the TX frequency subband(s) for each of the QCL source RS(s) indicated in the TCI state could follow one or more examples described herein.

In another example, if an indicated TCI state (among the M TCI states indicated in the MAC CE/DCI) comprises/indicates/provides one or more (e.g., Nᵣₛ≥1 or Nᵣ=1) QCL source RSs (with the same or different QCL types)—e.g., the higher layer parameter(s) TCI-State, QCL-Info, DLorJointTCI-State or UL-TCIState that configures the TCI state could include/contain/provide the one or more (QCL) source RSs—each corresponding/associated to one or more of the TX frequency subbands configured/indicated for the indicated TCI state/pair of TCI states for frequency-selective beam indication for FSBM, the configuration/indication of the TX frequency subband(s) for each of the QCL source RS(s) indicated in the TCI state could follow one or more examples described herein.

In yet another example, the UE (e.g., the UE 116) could be configured/indicated by the network, e.g., via higher layer RRC signaling/parameter and/or MAC CE command and/or dynamic DCI based signaling, to follow one or more examples described herein.

In yet another example, if an indicated TCI state (among the M TCI states indicated in the MAC CE/DCI) comprises/indicates/provides more than one QCL source RSs, the configuration/indication of the TX frequency subband(s) for each of the QCL source RSs indicated in the TCI state follows one or more examples described herein. If an TCI state (among the M TCI states indicated in the MAC CE/DCI) comprises/indicates/provides a single QCL source RS, the configuration/indication of the TX frequency subband(s) for the QCL source RS indicated in the TCI state follows one or more examples described herein.

For an indicated TCI state/pair of TCI states, and therefore, the corresponding (QCL) source RS(s) indicated therein, the UE could be indicated/configured/provided by the network, e.g., via higher layer RRC signaling/parameter and/or MAC CE command and/or dynamic DCI based signaling, the target channel(s)/signal(s) for one or more of the TX frequency subbands configured/indicated for the corresponding indicated TCI state/pair of TCI states/QCL source RS for frequency-selective beam indication for FSBM (the configuration/indication of the TX frequency subband(s) for frequency-selective beam indication for FSBM is discussed in one or more examples described herein).

In one example, the channels/signals such as PDSCH and PUSCH that are associated to a TX frequency subband (e.g., the frequency domain resource allocation/assignment indicated in the corresponding FD-RA field(s) for the PDSCH/PUSCH is identical to the TX frequency subband) could follow the QCL assumption provided by the QCL source RS/TCI state corresponding/associated to the TX frequency subband.

In another example, the UE could be indicated/configured/provided by the network, e.g., via higher layer RRC signaling/parameter and/or MAC CE command and/or dynamic DCI based signaling, the target channel(s)/signal(s) for each of the TX frequency subbands configured/indicated for the corresponding indicated TCI state/pair of TCI states/QCL source RS(s) for frequency-selective beam indication for FSBM.

In yet another example, the UE could be indicated/configured/provided by the network, e.g., via higher layer RRC signaling/parameter and/or MAC CE command and/or dynamic DCI based signaling, the (same) target channel(s)/signal(s) for a subset of the TX frequency subbands configured/indicated for the corresponding indicated TCI state/pair of TCI states/QCL source RS(s) for frequency-selective beam indication for FSBM.

In yet another example, the UE could be indicated/configured/provided by the network, e.g., via higher layer RRC signaling/parameter and/or MAC CE command and/or dynamic DCI based signaling, one or more TX frequency subbands (and therefore, the corresponding TCI state(s)/pair(s) of TCI states/QCL source RS(s)) for a target channel/signal.

In yet another example, the UE could be indicated/configured/provided by the network, e.g., via higher layer RRC signaling/parameter and/or MAC CE command and/or dynamic DCI based signaling, one or more TX frequency subbands (and therefore, the corresponding TCI state(s)/pair(s) of TCI states/QCL source RS(s)) for one or more target channels/signals that are linked, e.g., via RRC signaling.

The UE could also be indicated/configured/provided by the network, e.g., via higher layer RRC signaling/parameter and/or MAC CE command and/or dynamic DCI based signaling, one or more UL frequencies/frequency subbands each corresponding/associated to one or more TX frequency subbands indicated/configured for one or more TCI states/pairs of TCI states/QCL source RSs according to one or more examples described herein. Furthermore, in/for one or more examples described herein, a TX frequency subband can be replaced by a set of one or more continuous and/or non-continuous time-domain resources, wherein a time-domain resource could correspond to a symbol, a slot and/or etc. Each set of the time-domain resources could be provided/indicated/configured to the UE via higher layer RRC signaling(s)/parameter(s) and/or MAC CE command(s) and/or dynamic DCI based L1 signaling(s)—e.g., via/by the TD-RA field in the corresponding DCI format; for this case, each of the configured/activated/indicated joint/DL/UL TCI state/set of TCI states as specified herein in the present disclosure could be corresponding/associated to one or more sets of time-domain resources following the method(s)—and therefore, the corresponding signaling(s) support and/or etc.—specified herein in the present disclosure for associating the configured/activated/indicated joint/DL/UL TCI state(s) to the TX frequency subband(s).

FIG. 11 illustrates a diagram of an example two-part DCI 1100 for frequency-selective beam indication according to embodiments of the present disclosure. For example, the two-part DCI 1100 for frequency-selective beam indication can be referenced by any of the UEs 111-116 of FIG. 1, such as the UE 111. This example is for illustration only and other embodiments can be used without departing from the scope of the present disclosure.

When the FSBM is enabled according to those specified herein in the present disclosure, a UE could be indicated/provided by the network, e.g., via a two-part DCI (comprising part 1 and part 2), one or more joint/DL/UL TCI states each for one or more TX frequency subbands (association/mapping between the indicated one or more joint/DL/UL TCI states and the one or more TX frequency subbands could be according to those specified herein in the present disclosure). Specifically, part 1 of the two-part DCI for frequency-selective beam indication could be of fixed payload size, and could indicate/provide at least one or more first joint/DL/UL TCI states each for one or more first TX frequency subbands and/or information such as payload size of part 2 of the two-part DCI. Part 2 of the two-part DCI for frequency-selective beam indication could be of flexible payload size, and could indicate/provide at least one or more second joint/DL/UL TCI states each for one or more second TX frequency subbands. With reference to FIG. 11, a conceptual example depicting the two-part DCI for frequency-selective beam indication is shown. Association/mapping between the indicated one or more first (or second) TCI states in part 1 (or part 2) of the two-part DCI for frequency-selective beam indication and the one or more first (or second) TX frequency subbands could be according to/based on those specified herein in the present disclosure.

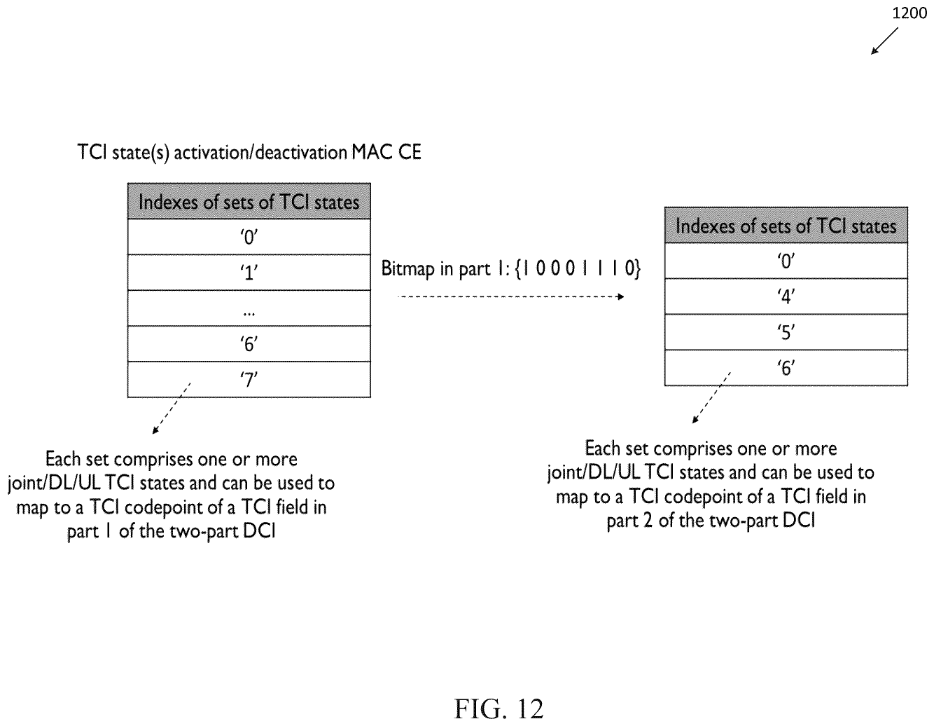

FIG. 12 illustrates tables of example TCI state(s) indication 1200 in part 1 and part 2 of a two-part DCI according to embodiments of the present disclosure. For example, tables of example TCI state(s) indication 1200 in part 1 and part 2 of a two-part DCI can be referenced by any of the UEs 111-116 of FIG. 1, such as the UE 112. This example is for illustration only and other embodiments can be used without departing from the scope of the present disclosure.

The UE could receive from the network, in/on/via a first channel/signaling, part 1 of the aforementioned two-part DCI for frequency-selective beam indication; furthermore, the UE could receive from the network, in/on/via a second channel/signaling, part 2 of the aforementioned two-part DCI for frequency-selective beam indication. Here, the first channel/signaling could be different/separate from the second channel/signaling; optionally, the first and second channels/signalings could be identical/the same. Furthermore, the UE could use identical/same TCI state(s)—e.g., indicated/provided in a beam indication MAC CE/DCI (e.g., via one or more TCI codepoints of one or more TCI fields in a beam indication DCI)—to receive both part 1 and part 2 of the two-part DCI for frequency-selective beam indication; optionally, the UE could use different/separate TCI states—e.g., indicated/provided in a beam indication MAC CE/DCI (e.g., via one or more TCI codepoints of one or more TCI fields in a beam indication DCI)—to respectively receive part 1 and part 2 of the two-part DCI for frequency-selective beam indication.

Various means of indicating the one or more first TCI states in part 1 of the two-part DCI for frequency-selective beam indication and the one or more second TCI states in part 2 of the two-part DCI for frequency-selective beam indication are provided.

In one example, the UE could be first provided/configured/indicated by the network, e.g., via higher layer RRC signaling(s)/parameter(s) and/or MAC CE command(s) and/or dynamic DCI based L1 signaling(s), a list/set/pool of TCI states/TCI state IDs. For this design example, index(es)/ID(s) of the one or more first TCI states—among the list/set/pool of TCI states/TCI state IDs—could be provided/indicated in part 1 of the two-part DCI for frequency-selective beam indication (e.g., via/by new/dedicated DCI field(s) and/or via/by repurposing one or more bits of one or more existing DCI field(s) such as TCI field(s) in part 1 of the two-part beam indication DCI). Furthermore, index(es)/ID(s) of the one or more second TCI states—among the list/set/pool of TCI states/TCI state IDs—could be provided/indicated in part 2 of the two-part DCI for frequency-selective beam indication (e.g., via/by new/dedicated DCI field(s) and/or via/by repurposing one or more bits of one or more existing DCI field(s) such as TCI field(s) in part 2 of the two-part beam indication DCI).

In another example, the UE could first receive from the network (e.g., the network 130) a MAC CE activation command—e.g., a (unified) TCI state(s) activation/deactivation MAC CE—providing/indicating/activating one or more (e.g., up to Ncp≥1, Ncp=4, 8, 16, 32, . . . ) sets of TCI states with each set comprising one or more joint/DL/UL TCI states and used to map to a TCI codepoint of a TCI field in a beam indication DCI. For this design example, the UE could be indicated/provided by the network, e.g., via/by one or more TCI codepoints of one or more TCI fields in part 1 of the two-part beam indication DCI, the one or more first TCI states, and/or the UE could be indicated/provided by the network, e.g., via/by one or more TCI codepoints of one or more TCI fields in part 2 of the two-part beam indication DCI, the one or more second TCI states. That is, (i) the UE could be indicated/provided by the network the first TCI state(s) and the second TCI state(s) respectively in part 1 and part 2 of the two-part DCI, (ii) the UE could only be indicated/provided by the network the first TCI state(s) in part 1 of the two-part DCI (or the beam indication DCI has only one/a single part); for this case, part 2 of the two-part DCI for frequency-selective beam indication could be absent, and/or the UE could use/apply the previously indicated/currently applied second TCI state(s) (along with the indicated first TCI state(s) in part 1) for frequency-selective beam indication, and/or (iii) the UE could only be indicated/provided by the network the second TCI state(s) in part 2 of the two-part DCI; for this case, part 1 of the two-part DCI for frequency-selective beam indication could only contain information (e.g., payload size) of part 2, and/or the UE could use/apply the previously indicated/currently applied first TCI state(s) (along with the indicated second TCI state(s) in part 2) for frequency-selective beam indication.

For example, the UE could be indicated/provided by the network, e.g., via/by a single TCI codepoint (comprising/corresponding to one or more joint/DL/UL TCI states) of a TCI field in part 1 of the two-part beam indication DCI, the first TCI state(s). Additionally, the UE could be indicated/provided by the network, e.g., via/by a single TCI codepoint (comprising/corresponding to one or more (e.g., multiple, i.e., greater than 1) joint/DL/UL TCI states) of a TCI field in part 2 of the two-part beam indication DCI, the second TCI state(s).

For another example, the UE could be indicated/provided by the network, e.g., via/by a single TCI codepoint (comprising/corresponding to one or more joint/DL/UL TCI states) of a TCI field in part 1 of the two-part beam indication DCI, the first TCI state(s). Additionally, the UE could be indicated/provided by the network, e.g., via/by one or more (e.g., multiple, i.e., greater than 1) TCI codepoints (each comprising/corresponding to one or more joint/DL/UL TCI states) of one or more (e.g., multiple, i.e., greater than 1) TCI fields in part 2 of the two-part beam indication DCI, the second TCI state(s).

Yet for another example, the UE could be indicated/provided by the network, e.g., via/by one or more (e.g., multiple, i.e., greater than 1) TCI codepoints (each comprising/corresponding to one or more joint/DL/UL TCI states) of one or more (e.g., multiple, i.e., greater than 1) TCI fields in part 1 of the two-part beam indication DCI, the first TCI state(s). Additionally, the UE could be indicated/provided by the network, e.g., via/by a single TCI codepoint (comprising/corresponding to one or more joint/DL/UL TCI states) of a TCI field in part 2 of the two-part beam indication DCI, the second TCI state(s).

Yet for another example, the UE could be indicated/provided by the network, e.g., via/by one or more (e.g., multiple, i.e., greater than 1) TCI codepoints (each comprising/corresponding to one or more joint/DL/UL TCI states) of one or more (e.g., multiple, i.e., greater than 1) TCI fields in part 1 of the two-part beam indication DCI, the first TCI state(s). Additionally, the UE could be indicated/provided by the network, e.g., via/by one or more (e.g., multiple, i.e., greater than 1) TCI codepoints (each comprising/corresponding to one or more joint/DL/UL TCI states) of one or more (e.g., multiple, i.e., greater than 1) TCI fields in part 2 of the two-part beam indication DCI, the second TCI state(s).

For/in the described design example(s) herein, the (unified) TCI state(s) activation/deactivation MAC CE could provide/indicate/activate one or more sets of TCI states used to map to Kcp TCI codepoints of a TCI field in a beam indication DCI. Here, the value of Kcp could be fixed or flexible, which could be indicated/provided/configured by the network to the UE via higher layer RRC signaling(s)/parameter(s) and/or MAC CE command(s) and/or dynamic DCI based L1 signaling(s).

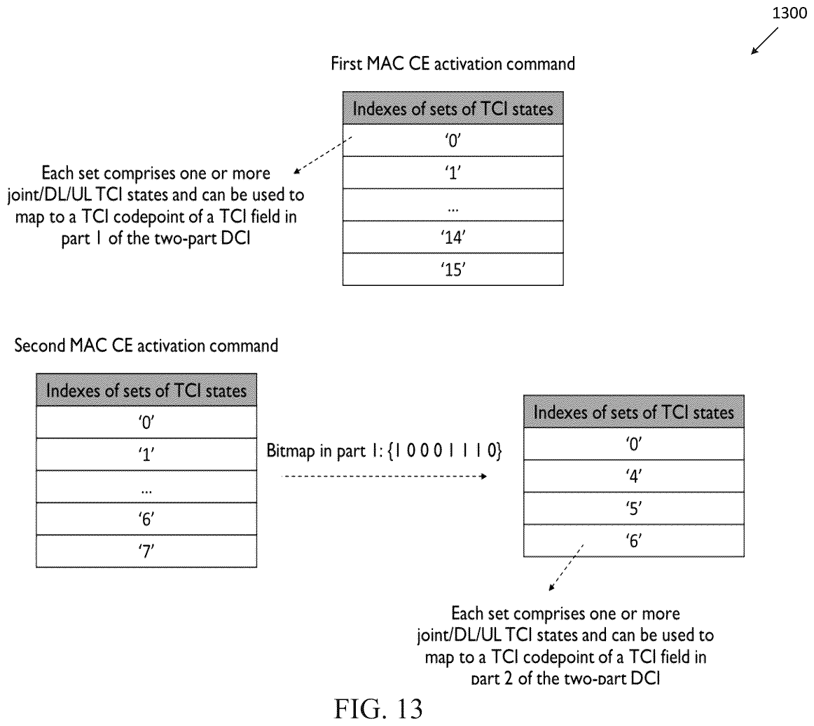

FIG. 13 illustrates tables of example TCI state(s) indication in part 1 and part 2 1300 of a two-part DCI according to embodiments of the present disclosure. For example, TCI state(s) indication in part 1 and part 2 1300 of a two-part DCI can be referenced by any of the UEs 111-116 of FIG. 1, such as the UE 113. This example is for illustration only and other embodiments can be used without departing from the scope of the present disclosure.

In yet another example, the UE could first receive from the network a first MAC CE activation command—e.g., a (unified) TCI state(s) activation/deactivation MAC CE—providing/indicating/activating one or more (e.g., up to Ncp_1≥1, Ncp_1=4, 8, 16, 32, . . . ) sets of TCI states with each set comprising one or more joint/DL/UL TCI states and used to map to a first TCI codepoint of a TCI field in part 1 of the two-part beam indication DCI, and a second MAC CE activation command—e.g., a (unified) TCI state(s) activation/deactivation MAC CE—providing/indicating/activating one or more (e.g., up to Ncp_2≥1, Ncp_2=4, 8, 16, 32, . . . ) sets of TCI states with each set comprising one or more joint/DL/UL TCI states and used to map to a second TCI codepoint of a TCI field in part 2 of the two-part beam indication DCI. For this design example, the UE could be indicated/provided by the network, e.g., via/by one or more first TCI codepoints of one or more TCI fields in part 1 of the two-part beam indication DCI, the one or more first TCI states, and/or the UE could be indicated/provided by the network, e.g., via/by one or more second TCI codepoints of one or more TCI fields in part 2 of the two-part beam indication DCI, the one or more second TCI states. That is, (i) the UE could be indicated/provided by the network the first TCI state(s) and the second TCI state(s) respectively in part 1 and part 2 of the two-part DCI, (ii) the UE could only be indicated/provided by the network the first TCI state(s) in part 1 of the two-part DCI (or the beam indication DCI has only one/a single part); for this case, part 2 of the two-part DCI for frequency-selective beam indication could be absent, and/or the UE could use/apply the previously indicated/currently applied second TCI state(s) (along with the indicated first TCI state(s) in part 1) for frequency-selective beam indication, and/or (iii) the UE could only be indicated/provided by the network the second TCI state(s) in part 2 of the two-part DCI; for this case, part 1 of the two-part DCI for frequency-selective beam indication could only contain information (e.g., payload size) of part 2, and/or the UE could use/apply the previously indicated/currently applied first TCI state(s) (along with the indicated second TCI state(s) in part 2) for frequency-selective beam indication. The first MAC CE activation command (and therefore, content(s)/set(s) of joint/DL/UL TCI state(s) provided/indicated/activated therein) and the second MAC CE activation command (and therefore, content(s)/set(s) of joint/DL/UL TCI state(s) provided/indicated/activated therein) could be identical/the same or different.

For example, the UE could be indicated/provided by the network, e.g., via/by a single first TCI codepoint (comprising/corresponding to one or more joint/DL/UL TCI states) of a TCI field in part 1 of the two-part beam indication DCI, the first TCI state(s). Additionally, the UE could be indicated/provided by the network, e.g., via/by a single second TCI codepoint (comprising/corresponding to one or more (e.g., multiple, i.e., greater than 1) joint/DL/UL TCI states) of a TCI field in part 2 of the two-part beam indication DCI, the second TCI state(s).

For another example, the UE could be indicated/provided by the network, e.g., via/by a single first TCI codepoint (comprising/corresponding to one or more joint/DL/UL TCI states) of a TCI field in part 1 of the two-part beam indication DCI, the first TCI state(s). Additionally, the UE could be indicated/provided by the network, e.g., via/by one or more (e.g., multiple, i.e., greater than 1) second TCI codepoints (each comprising/corresponding to one or more joint/DL/UL TCI states) of one or more (e.g., multiple, i.e., greater than 1) TCI fields in part 2 of the two-part beam indication DCI, the second TCI state(s).

Yet for another example, the UE could be indicated/provided by the network, e.g., via/by one or more (e.g., multiple, i.e., greater than 1) first TCI codepoints (each comprising/corresponding to one or more joint/DL/UL TCI states) of one or more (e.g., multiple, i.e., greater than 1) TCI fields in part 1 of the two-part beam indication DCI, the first TCI state(s). Additionally, the UE could be indicated/provided by the network, e.g., via/by a single second TCI codepoint (comprising/corresponding to one or more joint/DL/UL TCI states) of a TCI field in part 2 of the two-part beam indication DCI, the second TCI state(s).

Yet for another example, the UE could be indicated/provided by the network, e.g., via/by one or more (e.g., multiple, i.e., greater than 1) first TCI codepoints (each comprising/corresponding to one or more joint/DL/UL TCI states) of one or more (e.g., multiple, i.e., greater than 1) TCI fields in part 1 of the two-part beam indication DCI, the first TCI state(s). Additionally, the UE could be indicated/provided by the network, e.g., via/by one or more (e.g., multiple, i.e., greater than 1) second TCI codepoints (each comprising/corresponding to one or more joint/DL/UL TCI states) of one or more (e.g., multiple, i.e., greater than 1) TCI fields in part 2 of the two-part beam indication DCI, the second TCI state(s).

For/in the described design example(s) herein, the first MAC CE activation command could provide/indicate/activate one or more sets of TCI states used to map to Kcp_1 first TCI codepoints of a TCI field in part 1 of the two-part beam indication DCI. Here, the value of Kcp_1 could be fixed or flexible, which could be indicated/provided/configured by the network to the UE via higher layer RRC signaling(s)/parameter(s) and/or MAC CE command(s) and/or dynamic DCI based L1 signaling(s), and the second MAC CE activation command could provide/indicate/activate one or more sets of TCI states used to map to Kcp_2 second TCI codepoints of a TCI field in part 2 of the two-part beam indication DCI. Here, the value of Kcp_2 could be fixed or flexible, which could be indicated/provided/configured by the network to the UE via higher layer RRC signaling(s)/parameter(s) and/or MAC CE command(s) and/or dynamic DCI based L1 signaling(s). Furthermore, the values of Kcp_1 and Kcp_2 could be the same/identical or different.

In yet another example, the UE could first receive from the network one or more first MAC CE activation commands—e.g., each corresponding to a (unified) TCI state(s) activation/deactivation MAC CE—each providing/indicating/activating one or more (e.g., up to Ncp_1≥1, Ncp_1=4, 8, 16, 32, . . . ) sets of TCI states with each set comprising one or more joint/DL/UL TCI states and used to map to a first TCI codepoint of a TCI field in part 1 of the two-part beam indication DCI; for this case, the UE could be indicated/provided by the network, e.g., via higher layer RRC signaling(s)/parameter(s) and/or MAC CE command(s) and/or dynamic DCI based L1 signaling(s), from which of the first MAC CE activation commands—denoted by selected first MAC CE activation command(s)—the first TCI state(s) indicated/provided in part 1 of the two-part beam indication DCI is selected. The UE could also receive from the network one or more second MAC CE activation commands—e.g., each corresponding to (unified) TCI state(s) activation/deactivation MAC CE—each providing/indicating/activating one or more (e.g., up to Ncp_2≥1, Ncp_2=4, 8, 16, 32, . . . ) sets of TCI states with each set comprising one or more joint/DL/UL TCI states and used to map to a second TCI codepoint of a TCI field in part 2 of the two-part beam indication DCI; for this case, the UE could be indicated/provided by the network, via higher layer RRC signaling(s)/parameter(s) and/or MAC CE command(s) and/or dynamic DCI based L1 signaling(s), from which of the second MAC CE activation commands—denoted by selected second MAC CE activation command(s)—the second TCI state(s) indicated/provided in part 2 of the two-part beam indication DCI is selected. For this design example, the UE could be indicated/provided by the network, e.g., via/by one or more first TCI codepoints (each pointing to a set of TCI states provided/indicated/activated in a selected first MAC CE activation command) of one or more TCI fields in part 1 of the two-part beam indication DCI, the one or more first TCI states, and/or the UE could be indicated/provided by the network, e.g., via/by one or more second TCI codepoints (each pointing to a set of TCI states provided/indicated/activated in a selected second MAC CE activation command) of one or more TCI fields in part 2 of the two-part beam indication DCI, the one or more second TCI states. That is, (i) the UE could be indicated/provided by the network the first TCI state(s) and the second TCI state(s) respectively in part 1 and part 2 of the two-part DCI, (ii) the UE could only be indicated/provided by the network the first TCI state(s) in part 1 of the two-part DCI (or the beam indication DCI has only one/a single part); for this case, part 2 of the two-part DCI for frequency-selective beam indication could be absent, and/or the UE could use/apply the previously indicated/currently applied second TCI state(s) (along with the indicated first TCI state(s) in part 1) for frequency-selective beam indication, and/or (iii) the UE could only be indicated/provided by the network the second TCI state(s) in part 2 of the two-part DCI; for this case, part 1 of the two-part DCI for frequency-selective beam indication could only contain information (e.g., payload size) of part 2, and/or the UE could use/apply the previously indicated/currently applied first TCI state(s) (along with the indicated second TCI state(s) in part 2) for frequency-selective beam indication. The one or more first MAC CE activation commands (and therefore, content(s)/set(s) of joint/DL/UL TCI state(s) provided/indicated/activated therein) and the one or more second MAC CE activation commands (and therefore, content(s)/set(s) of joint/DL/UL TCI state(s) provided/indicated/activated therein) could be identical/the same or different. For a single selected first MAC CE activation command as specified herein in the present disclosure, and/or a single selected second MAC CE activation command as specified herein in the present disclosure, one or more examples are described herein.

For example, the UE could be indicated/provided by the network, e.g., via/by a single first TCI codepoint (pointing to a set of one or more joint/DL/UL TCI states provided/indicated/activated in the selected first MAC CE activation command) of a TCI field in part 1 of the two-part beam indication DCI, the first TCI state(s). And/or, the UE could be indicated/provided by the network, e.g., via/by a single second TCI codepoint (pointing to a set of one or more (e.g., multiple, i.e., greater than 1) joint/DL/UL TCI states provided/indicated/activated in the selected second MAC CE activation command) of a TCI field in part 2 of the two-part beam indication DCI, the second TCI state(s).

For another example, the UE could be indicated/provided by the network, e.g., via/by a single first TCI codepoint (pointing to a set of one or more joint/DL/UL TCI states provided/indicated/activated in the selected first MAC CE activation command) of a TCI field in part 1 of the two-part beam indication DCI, the first TCI state(s). And/or, the UE could be indicated/provided by the network, e.g., via/by one or more (e.g., multiple, i.e., greater than 1) second TCI codepoints (each pointing to a set of one or more joint/DL/UL TCI states provided/indicated/activated in the selected second MAC CE activation command) of one or more (e.g., multiple, i.e., greater than 1) TCI fields in part 2 of the two-part beam indication DCI, the second TCI state(s).

Yet for another example, the UE could be indicated/provided by the network, e.g., via/by one or more (e.g., multiple, i.e., greater than 1) first TCI codepoints (each pointing to a set of one or more joint/DL/UL TCI states provided/indicated/activated in the selected first MAC CE activation command) of one or more (e.g., multiple, i.e., greater than 1) TCI fields in part 1 of the two-part beam indication DCI, the first TCI state(s). And/or, the UE could be indicated/provided by the network, e.g., via/by a single second TCI codepoint (pointing to a set of one or more (e.g., multiple, i.e., greater than 1) joint/DL/UL TCI states provided/indicated/activated in the selected second MAC CE activation command) of a TCI field in part 2 of the two-part beam indication DCI, the second TCI state(s).

Yet for another example, the UE could be indicated/provided by the network, e.g., via/by one or more (e.g., multiple, i.e., greater than 1) first TCI codepoints (each pointing to a set of one or more joint/DL/UL TCI states provided/indicated/activated in the selected first MAC CE activation command) of one or more (e.g., multiple, i.e., greater than 1) TCI fields in part 1 of the two-part beam indication DCI, the first TCI state(s). And/or, the UE could be indicated/provided by the network, e.g., via/by one or more (e.g., multiple, i.e., greater than 1) second TCI codepoints (each pointing to a set of one or more joint/DL/UL TCI states provided/indicated/activated in the selected second MAC CE activation command) of one or more (e.g., multiple, i.e., greater than 1) TCI fields in part 2 of the two-part beam indication DCI, the second TCI state(s).

For multiple or more than one selected first MAC CE activation commands as specified herein in the present disclosure, and/or multiple or more than one selected second MAC CE activation commands as specified herein in the present disclosure, one or more examples are described herein.

For example, the UE (e.g., the UE 116) could be indicated/provided by the network, e.g., via/by a single first TCI codepoint (pointing to a set of one or more joint/DL/UL TCI states provided/indicated/activated in one of the selected first MAC CE activation commands) of a TCI field in part 1 of the two-part beam indication DCI, the first TCI state(s). And/or, the UE could be indicated/provided by the network, e.g., via/by a single second TCI codepoint (pointing to a set of one or more (e.g., multiple, i.e., greater than 1) joint/DL/UL TCI states provided/indicated/activated in one of the selected second MAC CE activation commands) of a TCI field in part 2 of the two-part beam indication DCI, the second TCI state(s).

For another example, the UE could be indicated/provided by the network, e.g., via/by a single first TCI codepoint (pointing to a set of one or more joint/DL/UL TCI states provided/indicated/activated in one of the selected first MAC CE activation commands) of a TCI field in part 1 of the two-part beam indication DCI, the first TCI state(s). And/or, the UE could be indicated/provided by the network, e.g., via/by one or more (e.g., multiple, i.e., greater than 1) second TCI codepoints (each pointing to a set of one or more joint/DL/UL TCI states provided/indicated/activated in one of the selected second MAC CE activation commands) of one or more (e.g., multiple, i.e., greater than 1) TCI fields in part 2 of the two-part beam indication DCI, the second TCI state(s).

Yet for another example, the UE could be indicated/provided by the network, e.g., via/by one or more (e.g., multiple, i.e., greater than 1) first TCI codepoints (each pointing to a set of one or more joint/DL/UL TCI states provided/indicated/activated in one of the selected first MAC CE activation command) of one or more (e.g., multiple, i.e., greater than 1) TCI fields in part 1 of the two-part beam indication DCI, the first TCI state(s). And/or, the UE could be indicated/provided by the network, e.g., via/by a single second TCI codepoint (pointing to a set of one or more (e.g., multiple, i.e., greater than 1) joint/DL/UL TCI states provided/indicated/activated in one of the selected second MAC CE activation commands) of a TCI field in part 2 of the two-part beam indication DCI, the second TCI state(s).

Yet for another example, the UE could be indicated/provided by the network, e.g., via/by one or more (e.g., multiple, i.e., greater than 1) first TCI codepoints (each pointing to a set of one or more joint/DL/UL TCI states provided/indicated/activated in one of the selected first MAC CE activation commands) of one or more (e.g., multiple, i.e., greater than 1) TCI fields in part 1 of the two-part beam indication DCI, the first TCI state(s). And/or, the UE could be indicated/provided by the network, e.g., via/by one or more (e.g., multiple, i.e., greater than 1) second TCI codepoints (each pointing to a set of one or more joint/DL/UL TCI states provided/indicated/activated in one of the selected second MAC CE activation commands) of one or more (e.g., multiple, i.e., greater than 1) TCI fields in part 2 of the two-part beam indication DCI, the second TCI state(s).

The UE could be indicated/provided/configured by the network, e.g., via higher layer RRC signaling(s)/parameter(s) and/or MAC CE command(s) and/or dynamic DCI based L1 signaling(s), association(s)/mapping(s) between the first MAC CE activation command(s) and the first TCI codepoint(s)—and therefore, the corresponding TCI field(s)—indicated/provided by/in part 1 of the two-part beam indication DCI, and/or association(s)/mapping(s) between the second MAC CE activation command(s) and the second TCI codepoint(s)—and therefore, the corresponding TCI field(s)—indicated/provided by/in part 2 of the two-part beam indication DCI. For instance, the 1-st first TCI codepoint, 2-nd first TCI codepoint, etc. indicated/provided in their corresponding TCI fields in part 1 of the two-part beam indication DCI could point/correspond to sets of joint/DL/UL TCI state(s) respectively from the (selected) 1-st first MAC CE activation command, 2-nd first MAC CE activation command, etc.; the 1-st second TCI codepoint, 2-nd second TCI codepoint, etc. indicated/provided in their corresponding TCI fields in part 2 of the two-part beam indication DCI could point/correspond to sets of joint/DL/UL TCI state(s) respectively from the (selected) 1-st second MAC CE activation command, 2-nd second MAC CE activation command, etc. For/in the described design example(s) herein, a (selected) first MAC CE activation command could provide/indicate/activate one or more sets of TCI states used to map to Kcp_1 first TCI codepoints of a TCI field in part 1 of the two-part beam indication DCI. Here, the value of Kcp_1 could be fixed or flexible, which could be indicated/provided/configured by the network to the UE via higher layer RRC signaling(s)/parameter(s) and/or MAC CE command(s) and/or dynamic DCI based L1 signaling(s), and a (selected) second MAC CE activation command could provide/indicate/activate one or more sets of TCI states used to map to Kcp_2 second TCI codepoints of a TCI field in part 2 of the two-part beam indication DCI. Here, the value of Kcp_2 could be fixed or flexible, which could be indicated/provided/configured by the network to the UE via higher layer RRC signaling(s)/parameter(s) and/or MAC CE command(s) and/or dynamic DCI based L1 signaling(s). Furthermore, the values of Kcp_1 and Kcp_2 could be the same/identical or different.

In yet another example, the UE could first receive from the network (e.g., the network 130) a MAC CE activation command—e.g., a (unified) TCI state(s) activation/deactivation MAC CE—providing/indicating/activating one or more (e.g., up to Ncp≥1, Ncp=4, 8, 16, 32, . . . ) sets of TCI states with each set comprising one or more joint/DL/UL TCI states and used to map to a TCI codepoint of a TCI field in a beam indication DCI. For this design example, the UE could be indicated/provided/configured by the network, e.g., via higher layer RRC signaling(s)/parameter(s) and/or MAC CE command(s) and/or dynamic DCI based L1 signaling(s), which of the one or more sets of TCI states provided/indicated in the MAC CE activation command—denoted by candidate set(s) of TCI state(s) in the MAC CE activation command—could be used to map to a TCI codepoint of a TCI field in part 2 of the two-part beam indication DCI. For instance, part 1 of the two-part DCI for frequency-selective beam indication could provide/indicate/comprise/include/contain a bitmap with each bit/bit position corresponding/associated to a set of joint/DL/UL TCI state(s) provided/indicated in the MAC CE activation command; for this case, when/if a bit/bit position of the bitmap is set to ‘1’ (or ‘0’), the corresponding/associated set of joint/DL/UL TCI state(s) in the MAC CE activation command—i.e., a candidate set of joint/DL/UL TCI state(s) in the MAC CE activation command—could be used to map to a TCI codepoint of a TCI field in part 2 of the two-part beam indication DCI. With reference to FIG. 12, one conceptual example depicting the described design procedure herein and the corresponding signaling support is shown. For this design example, the UE could be indicated/provided by the network, e.g., via/by one or more TCI codepoints of one or more TCI fields in part 1 of the two-part beam indication DCI, the one or more first TCI states, and/or the UE could be indicated/provided by the network, e.g., via/by one or more TCI codepoints (each pointing to a candidate set of TCI state(s) provided/indicated in the MAC CE activation command) of one or more TCI fields in part 2 of the two-part beam indication DCI, the one or more second TCI states. That is, (i) the UE could be indicated/provided by the network the first TCI state(s) and the second TCI state(s) respectively in part 1 and part 2 of the two-part DCI, (ii) the UE could only be indicated/provided by the network the first TCI state(s) in part 1 of the two-part DCI (or the beam indication DCI has only one/a single part); for this case, part 2 of the two-part DCI for frequency-selective beam indication could be absent, and/or the UE could use/apply the previously indicated/currently applied second TCI state(s) (along with the indicated first TCI state(s) in part 1) for frequency-selective beam indication, and/or (iii) the UE could only be indicated/provided by the network the second TCI state(s) in part 2 of the two-part DCI; for this case, part 1 of the two-part DCI for frequency-selective beam indication could only contain information (e.g., payload size) of part 2, and/or the UE could use/apply the previously indicated/currently applied first TCI state(s) (along with the indicated second TCI state(s) in part 2) for frequency-selective beam indication.

For example, the UE could be indicated/provided by the network, e.g., via/by a single TCI codepoint (comprising/corresponding to one or more joint/DL/UL TCI states) of a TCI field in part 1 of the two-part beam indication DCI, the first TCI state(s). Additionally, the UE could be indicated/provided by the network, e.g., via/by a single TCI codepoint (pointing to a candidate set of one or more (e.g., multiple, i.e., greater than 1) joint/DL/UL TCI states provided/indicated in the MAC CE activation command as specified herein in the present disclosure) of a TCI field in part 2 of the two-part beam indication DCI, the second TCI state(s).

For another example, the UE could be indicated/provided by the network, e.g., via/by a single TCI codepoint (comprising/corresponding to one or more joint/DL/UL TCI states) of a TCI field in part 1 of the two-part beam indication DCI, the first TCI state(s). Additionally, the UE could be indicated/provided by the network, e.g., via/by one or more (e.g., multiple, i.e., greater than 1) TCI codepoints (each pointing to a candidate set of one or more joint/DL/UL TCI states provided/indicated in the MAC CE activation command as specified herein in the present disclosure) of one or more (e.g., multiple, i.e., greater than 1) TCI fields in part 2 of the two-part beam indication DCI, the second TCI state(s).

Yet for another example, the UE could be indicated/provided by the network, e.g., via/by one or more (e.g., multiple, i.e., greater than 1) TCI codepoints (each comprising/corresponding to one or more joint/DL/UL TCI states) of one or more (e.g., multiple, i.e., greater than 1) TCI fields in part 1 of the two-part beam indication DCI, the first TCI state(s). Additionally, the UE could be indicated/provided by the network, e.g., via/by a single TCI codepoint (pointing to a candidate set of one or more joint/DL/UL TCI states provided/indicated in the MAC CE activation command as specified herein in the present disclosure) of a TCI field in part 2 of the two-part beam indication DCI, the second TCI state(s).

Yet for another example, the UE could be indicated/provided by the network, e.g., via/by one or more (e.g., multiple, i.e., greater than 1) TCI codepoints (each comprising/corresponding to one or more joint/DL/UL TCI states) of one or more (e.g., multiple, i.e., greater than 1) TCI fields in part 1 of the two-part beam indication DCI, the first TCI state(s). Additionally, the UE could be indicated/provided by the network, e.g., via/by one or more (e.g., multiple, i.e., greater than 1) TCI codepoints (each pointing to a candidate set of one or more joint/DL/UL TCI states provided/indicated in the MAC CE activation command as specified herein in the present disclosure) of one or more (e.g., multiple, i.e., greater than 1) TCI fields in part 2 of the two-part beam indication DCI, the second TCI state(s).

For/in the described design example(s) herein, the (unified) TCI state(s) activation/deactivation MAC CE could provide/indicate/activate one or more sets of TCI states used to map to Kcp TCI codepoints of a TCI field in a beam indication DCI. Here, the value of Kcp could be fixed or flexible, which could be indicated/provided/configured by the network to the UE via higher layer RRC signaling(s)/parameter(s) and/or MAC CE command(s) and/or dynamic DCI based L1 signaling(s). Furthermore, the bitwidth of a TCI field in part 2 of the two-part beam indication DCI could be ┌log₂ L┐, where L corresponds to the number of candidate set(s) of TCI state(s) in the MAC CE activation command.

In yet another example, the UE could first receive from the network a first MAC CE activation command—e.g., a (unified) TCI state(s) activation/deactivation MAC CE—providing/indicating/activating one or more (e.g., up to Ncp_1≥1, Ncp_1=4, 8, 16, 32, . . . ) sets of TCI states with each set comprising one or more joint/DL/UL TCI states and used to map to a first TCI codepoint of a TCI field in part 1 of the two-part beam indication DCI, and a second MAC CE activation command—e.g., a (unified) TCI state(s) activation/deactivation MAC CE—providing/indicating/activating one or more (e.g., up to Ncp_2≥1, Ncp_2=4, 8, 16, 32, . . . ) sets of TCI states with each set comprising one or more joint/DL/UL TCI states. For this design example, the UE could be indicated/provided/configured by the network, e.g., via higher layer RRC signaling(s)/parameter(s) and/or MAC CE command(s) and/or dynamic DCI based L1 signaling(s), which of the one or more sets of TCI states provided/indicated in the second MAC CE activation command—denoted by candidate set(s) of TCI state(s) in the second MAC CE activation command—could be used to map to a TCI codepoint of a TCI field in part 2 of the two-part beam indication DCI. For instance, part 1 of the two-part DCI for frequency-selective beam indication could provide/indicate/comprise/include/contain a bitmap with each bit/bit position corresponding/associated to a set of joint/DL/UL TCI state(s) provided/indicated in the second MAC CE activation command; for this case, when/if a bit/bit position of the bitmap is set to ‘1’ (or ‘0’), the corresponding/associated set of joint/DL/UL TCI state(s) in the second MAC CE activation command—i.e., a candidate set of joint/DL/UL TCI state(s) in the second MAC CE activation command—could be used to map to a TCI codepoint of a TCI field in part 2 of the two-part beam indication DCI. With reference to FIG. 13, one conceptual example depicting the described design procedure herein and the corresponding signaling support is shown. For this design example, the UE could be indicated/provided by the network, e.g., via/by one or more first TCI codepoints of one or more TCI fields in part 1 of the two-part beam indication DCI, the one or more first TCI states, and/or the UE could be indicated/provided by the network, e.g., via/by one or more second TCI codepoints (each pointing to a candidate set of TCI state(s) provided/indicated in the second MAC CE activation command) of one or more TCI fields in part 2 of the two-part beam indication DCI, the one or more second TCI states. That is, (i) the UE could be indicated/provided by the network the first TCI state(s) and the second TCI state(s) respectively in part 1 and part 2 of the two-part DCI, (ii) the UE could only be indicated/provided by the network the first TCI state(s) in part 1 of the two-part DCI (or the beam indication DCI has only one/a single part); for this case, part 2 of the two-part DCI for frequency-selective beam indication could be absent, and/or the UE could use/apply the previously indicated/currently applied second TCI state(s) (along with the indicated first TCI state(s) in part 1) for frequency-selective beam indication, and/or (iii) the UE could only be indicated/provided by the network the second TCI state(s) in part 2 of the two-part DCI; for this case, part 1 of the two-part DCI for frequency-selective beam indication could only contain information (e.g., payload size) of part 2, and/or the UE could use/apply the previously indicated/currently applied first TCI state(s) (along with the indicated second TCI state(s) in part 2) for frequency-selective beam indication. The first MAC CE activation command (and therefore, content(s)/set(s) of joint/DL/UL TCI state(s) provided/indicated/activated therein) and the second MAC CE activation command (and therefore, content(s)/set(s) of joint/DL/UL TCI state(s) provided/indicated/activated therein) could be identical/the same or different.

For example, the UE could be indicated/provided by the network, e.g., via/by a single first TCI codepoint (comprising/corresponding to one or more joint/DL/UL TCI states) of a TCI field in part 1 of the two-part beam indication DCI, the first TCI state(s). Additionally, the UE could be indicated/provided by the network, e.g., via/by a single second TCI codepoint (pointing to a candidate set of one or more (e.g., multiple, i.e., greater than 1) joint/DL/UL TCI states in the second MAC CE activation command) of a TCI field in part 2 of the two-part beam indication DCI, the second TCI state(s).

For another example, the UE could be indicated/provided by the network, e.g., via/by a single first TCI codepoint (comprising/corresponding to one or more joint/DL/UL TCI states) of a TCI field in part 1 of the two-part beam indication DCI, the first TCI state(s). Additionally, the UE could be indicated/provided by the network, e.g., via/by one or more (e.g., multiple, i.e., greater than 1) second TCI codepoints (each pointing to a candidate set of one or more joint/DL/UL TCI states in the second MAC CE activation command) of one or more (e.g., multiple, i.e., greater than 1) TCI fields in part 2 of the two-part beam indication DCI, the second TCI state(s).

Yet for another example, the UE could be indicated/provided by the network, e.g., via/by one or more (e.g., multiple, i.e., greater than 1) first TCI codepoints (each comprising/corresponding to one or more joint/DL/UL TCI states) of one or more (e.g., multiple, i.e., greater than 1) TCI fields in part 1 of the two-part beam indication DCI, the first TCI state(s). Additionally, the UE could be indicated/provided by the network, e.g., via/by a single second TCI codepoint (pointing to a candidate set of one or more joint/DL/UL TCI states in the second MAC CE activation command) of a TCI field in part 2 of the two-part beam indication DCI, the second TCI state(s).

Yet for another example, the UE could be indicated/provided by the network, e.g., via/by one or more (e.g., multiple, i.e., greater than 1) first TCI codepoints (each comprising/corresponding to one or more joint/DL/UL TCI states) of one or more (e.g., multiple, i.e., greater than 1) TCI fields in part 1 of the two-part beam indication DCI, the first TCI state(s). Additionally, the UE could be indicated/provided by the network, e.g., via/by one or more (e.g., multiple, i.e., greater than 1) second TCI codepoints (each pointing to a candidate set of one or more joint/DL/UL TCI states in the second MAC CE activation command) of one or more (e.g., multiple, i.e., greater than 1) TCI fields in part 2 of the two-part beam indication DCI, the second TCI state(s).

For/in the described design example(s) herein, the first MAC CE activation command could provide/indicate/activate one or more sets of TCI states used to map to Kcp_1 first TCI codepoints of a TCI field in part 1 of the two-part beam indication DCI. Here, the value of Kcp_1 could be fixed or flexible, which could be indicated/provided/configured by the network to the UE via higher layer RRC signaling(s)/parameter(s) and/or MAC CE command(s) and/or dynamic DCI based L1 signaling(s), and the second MAC CE activation command could provide/indicate/activate one or more sets of TCI states used to map to (up to) Kcp_2 second TCI codepoints of a TCI field in part 2 of the two-part beam indication DCI. Here, the value of Kcp_2 could be fixed or flexible, which could be indicated/provided/configured by the network to the UE via higher layer RRC signaling(s)/parameter(s) and/or MAC CE command(s) and/or dynamic DCI based L1 signaling(s). Furthermore, the values of Kcp_1 and Kcp_2 could be the same/identical or different. Furthermore, the bitwidth of a TCI field in part 2 of the two-part beam indication DCI could be ┌log₂ L┐, where L corresponds to the number of candidate set(s) of TCI state(s) in the second MAC CE activation command.

In the described design examples herein or the design examples throughout the present disclosure, a TCI field in part 1 or part 2 of the two-part beam indication DCI could be a new/dedicated TCI field or via/by repurposing one or more bits of one or more existing DCI fields such as TCI field(s) in the corresponding DCI format(s). Furthermore, in the described design examples herein or the design examples throughout the present disclosure, a single TCI field could indicate/provide a single TCI codepoint.

As specified herein in the present disclosure, a DCI (e.g., DCI format 1_1/1_2) for frequency-selective beam indication could comprise two parts—i.e., part 1 and part 2. Part 1 could be of fixed payload size, and could indicate/provide/comprise one or more joint/DL/UL TCI states (e.g., via one or more TCI codepoints of one or more TCI fields in part 1 of the two-part beam indication DCI) and information (e.g., payload size) of part 2 in the two-part beam indication DCI. Part 2 could be of flexible payload size, and could indicate/provide/comprise one or more joint/DL/UL TCI states (e.g., via one or more TCI codepoints of one or more TCI fields in part 2 of the two-part beam indication DCI). Optionally, a DCI (e.g., DCI format 1_1/1_2) for frequency-selective beam indication could only comprise one or a single part (e.g., the beam indication DCI comprises only part 1 according to those specified herein in the present disclosure while part 2 according to those specified herein in the present disclosure is absent). Whether a beam indication DCI for FSBM comprises one/a single part or two parts (part 1 and part 2 according to those specified herein in the present disclosure) could be based on one or more of the following conditions.

In one example, a UE could be indicated/provided/configured by the network, e.g., via higher layer RRC signaling(s)/parameter(s) and/or MAC CE command(s) and/or dynamic DCI based L1 signaling(s), whether a DCI for frequency-selective beam indication comprises one (or a single) part or two parts (e.g., part 1 and part 2).

For example, when/if the frequency-selective beam management (FSBM) is configured/enabled according to those specified herein in the present disclosure, and/or when/if a UE receives from the network a dedicated parameter, e.g., a dedicated higher layer parameter twoPartDCI set to ‘enabled’, indicating that a two-part DCI could be used for frequency-selective beam indication, the UE could expect that a beam indication DCI could comprise two parts—i.e., part 1 and part 2.

For another example, a (one-bit) indicator could be provided/configured in higher layer parameter(s) ControlResourceSet, PDCCH-Config, SearchSpaceSet and/or etc. and/or MAC CE command(s) and/or dynamic DCI based L1 signaling(s) to indicate whether a DCI for frequency-selective beam indication could comprise a single part or two parts. For instance, when/if the (one-bit) indicator provided/configured in ControlResourceSet that configures/provides a CORESET is set to ‘1’ (or ‘0’), the UE could expect that a beam indication DCI received in the CORESET could comprise two parts (part 1 and part 2 according to those specified herein in the present disclosure); and when/if the (one-bit) indicator provided/configured in ControlResourceSet that configures/provides a CORESET is set to ‘0’ (or ‘1’), the UE could expect that a beam indication DCI received in the CORESET could comprise one or a single part.

Yet for another example, when/if a UE receives from the network one or more MAC CE activation commands—e.g., each corresponding to a (unified) TCI state(s) activation/deactivation MAC CE command—dedicated/designed/customized for frequency-selective beam indication for FSBM according to those specified herein in the present disclosure, the UE could expect that the DCI for frequency-selective beam indication could comprise two parts (i.e., part 1 and part 2 as specified herein in the present disclosure); otherwise, the UE could expect that the beam indication DCI could comprise only one (or a single) part.

Yet for another example, when/if a DCI for frequency-selective beam indication or part 1 of a DCI for frequency-selective beam indication indicates/provides valid information (e.g., information indicating/implying a non-zero payload size of part 2 and/or information related to second TCI state(s) in part 2 such as a bitmap shown in FIG. 12 and FIG. 13 for indicating one or more candidate sets of TCI states for frequency-selective beam indication) of part 2, the UE could expect that the DCI for frequency-selective beam indication could comprise two parts—i.e., part 1 and part 2 according to those specified herein in the present disclosure.

Yet for another example, when/if a DCI for frequency-selective beam indication or part 1 of a DCI for frequency-selective beam indication does not indicate/provide any information related to part 2, the UE could expect that the DCI for frequency-selective beam indication could comprise one or a single part.

Yet for another example, when/if a DCI for frequency-selective beam indication or part 1 of a DCI for frequency-selective beam indication explicitly indicates that, e.g., by setting a (one-bit) indicator indicated/provided in part 1 of the beam indication DCI to ‘0’ or ‘1’, part 2 is absent/not present in the beam indication DCI, the UE could expect that the DCI for frequency-selective beam indication could comprise one or a single part.

Yet for another example, when/if a DCI for frequency-selective beam indication or part 1 of a DCI for frequency-selective beam indication indicates/provides information (e.g., a zero payload size of part 2) indicating/implying that part 2 is absent/not present in the beam indication DCI, the UE could expect that the DCI for frequency-selective beam indication could comprise one or a single part.

In another example, whether a DCI for frequency-selective beam indication comprises one (or a single) part or two parts (e.g., part 1 and part 2) could be based on one or more fixed rule(s)/condition(s).

For example, when/if the number of joint/DL/UL TCI states configured by the network via higher layer RRC signaling/parameter, and/or activated/provided/indicated by the network via MAC CE activation command(s), and/or indicated/provided by the network via one or more TCI codepoints of one or more TCI fields in a beam indication DCI for frequency-selective beam indication is greater than or equal to (or less than or equal to) a threshold, the UE could expect that the DCI for frequency-selective beam indication could comprise two parts (i.e., part 1 and part 2 as specified herein in the present disclosure); otherwise, the UE could expect that the beam indication DCI could comprise only one (or a single) part. Here, the threshold could be determined according to (i) a fixed value, (ii) network's configuration(s)/indication(s), e.g., via higher layer RRC signaling(s)/parameter(s) and/or MAC CE command(s) and/or dynamic DCI based L1 signaling(s), and/or (iii) UE's autonomous selection/decision, which could also be sent to the network, e.g., in part of a beam/CSI report and/or UE's capability signaling(s).

For another example, when/if the number of set(s) of joint/DL/LL TCI state(s) provided/indicated in/by a (unified) TCI state(s) activation/deactivation MAC CE is greater than or equal to (or less than or equal to) a threshold, the UE could expect that the beam indication DCI could comprise two parts (i.e., part 1 and part 2 as specified herein in the present disclosure); otherwise, the UE could expect that the DCI for frequency-selective beam indication could comprise only one (or a single) part. As specified herein in the present disclosure, the (unified) TCI state(s) activation/deactivation MAC CE here could correspond a first MAC CE activation command or a second MAC CE activation command as specified herein in the present disclosure; furthermore, a set of joint/DL/UL TCI state(s) provided/indicated in/by a (unified) TCI state(s) activation/deactivation MAC CE could be used to map to a TCI codepoint of a TCI field in part 1/part 2 of a beam indication DCI, and the threshold could be determined according to (i) a fixed value, (ii) network's configuration(s)/indication(s), e.g., via higher layer RRC signaling(s)/parameter(s) and/or MAC CE command(s) and/or dynamic DCI based L1 signaling(s), and/or (iii) UE's autonomous selection/decision, which could also be sent to the network, e.g., in part of a beam/CSI report and/or UE's capability signaling(s).

Yet for another example, when/if the number of TX frequency subbands configured/indicated/provided for FSBM according to those specified herein in the present disclosure is greater than or equal to (or less than or equal to) a threshold, the UE could expect that the DCI for frequency-selective beam indication comprises two parts (i.e., part 1 and part 2 as specified herein in the present disclosure); otherwise, the UE could expect that the beam indication DCI could comprise only one (or a single) part. the threshold could be determined according to (i) a fixed value, (ii) network's configuration(s)/indication(s), e.g., via higher layer RRC signaling(s)/parameter(s) and/or MAC CE command(s) and/or dynamic DCI based L1 signaling(s), and/or (iii) UE's autonomous selection/decision, which could also be sent to the network, e.g., in part of a beam/CSI report and/or UE's capability signaling(s).

Yet for another example, when/if the maximum number of joint/DL/LL TCI states in a set of TCI state(s) among the sets of TCI states in a (unified) TCI state(s) activation/deactivation MAC CE is greater than or equal to (or less than or equal to) a threshold, the UE could expect that the beam indication DCI could comprise two parts (i.e., part 1 and part 2 as specified herein in the present disclosure); otherwise, the UE could expect that the DCI for frequency-selective beam indication could comprise only one (or a single) part. As specified herein in the present disclosure, the (unified) TCI state(s) activation/deactivation MAC CE here could correspond a first MAC CE activation command or a second MAC CE activation command as specified herein in the present disclosure; furthermore, a set of joint/DL/UL TCI state(s) provided/indicated in/by a (unified) TCI state(s) activation/deactivation MAC CE could be used to map to a TCI codepoint of a TCI field in part 1/part 2 of a beam indication DCI, and the threshold could be determined according to (i) a fixed value, (ii) network's configuration(s)/indication(s), e.g., via higher layer RRC signaling(s)/parameter(s) and/or MAC CE command(s) and/or dynamic DCI based L1 signaling(s), and/or (iii) UE's autonomous selection/decision, which could also be sent to the network, e.g., in part of a beam/CSI report and/or UE's capability signaling(s).

Yet for another example, when/if the number of (unified) TCI state(s) activation/deactivation MAC CE commands received during/within a time duration/window (e.g., in a/same slot) is greater than or equal to (or less than or equal to) a threshold, the UE (e.g., the UE 116) could expect that the beam indication DCI could comprise two parts (i.e., part 1 and part 2 as specified herein in the present disclosure); otherwise, the UE could expect that the DCI for frequency-selective beam indication could comprise only one (or a single) part. The (unified) TCI state(s) activation/deactivation MAC CE command(s) received in the time duration/window could comprise one or more first MAC CE activation commands and/or one or more second MAC CE activation commands as specified herein in the present disclosure; furthermore, the threshold and/or the time duration/window could be determined according to (i) fixed value(s) specified/provided in system specification(s), (ii) network's configuration(s)/indication(s), e.g., via higher layer RRC signaling(s)/parameter(s) and/or MAC CE command(s) and/or dynamic DCI based L1 signaling(s), and/or (iii) UE's autonomous selection(s)/decision(s), which could also be sent to the network, e.g., in part of a beam/CSI report and/or UE's capability signaling(s).

Yet for another example, when/if the number of joint/DL/UL TCI state(s) of a TCI codepoint provided/indicated in a TCI field of a beam indication DCI (e.g., in part 1 of the beam indication DCI) is greater than or equal to (or less than or equal to) a threshold, the UE could expect that the beam indication DCI could comprise two parts (i.e., part 1 and part 2 as specified herein in the present disclosure); otherwise, the UE could expect that the DCI for frequency-selective beam indication could comprise only one (or a single) part. Here, a TCI codepoint could point to a set of joint/DL/UL TCI states provided/indicated in/by a (unified) TCI state(s) activation/deactivation MAC CE command, which could correspond to a first MAC CE activation command or a second MAC CE activation command according to those specified herein in the present disclosure. Furthermore, the threshold could be determined according to (i) fixed value(s) specified/provided in system specification(s), (ii) network's configuration(s)/indication(s), e.g., via higher layer RRC signaling(s)/parameter(s) and/or MAC CE command(s) and/or dynamic DCI based L1 signaling(s), and/or (iii) UE's autonomous selection(s)/decision(s), which could also be sent to the network, e.g., in part of a beam/CSI report and/or UE's capability signaling(s).

Yet for another example, when/if the number of TCI codepoints provided/indicated in one or more TCI fields of a beam indication DCI (e.g., in part 1 of the beam indication DCI) is greater than or equal to (or less than or equal to) a threshold, the UE could expect that the beam indication DCI could comprise two parts (i.e., part 1 and part 2 as specified herein in the present disclosure); otherwise, the UE could expect that the DCI for frequency-selective beam indication could comprise only one (or a single) part. Here, a TCI codepoint could point to a set of joint/DL/UL TCI states provided/indicated in/by a (unified) TCI state(s) activation/deactivation MAC CE command, which could correspond to a first MAC CE activation command or a second MAC CE activation command according to those specified herein in the present disclosure. Furthermore, the threshold could be determined according to (i) fixed value(s) specified/provided in system specification(s), (ii) network's configuration(s)/indication(s), e.g., via higher layer RRC signaling(s)/parameter(s) and/or MAC CE command(s) and/or dynamic DCI based L1 signaling(s), and/or (iii) UE's autonomous selection(s)/decision(s), which could also be sent to the network, e.g., in part of a beam/CSI report and/or UE's capability signaling(s).

Yet for another example, when/if the number of TCI fields used in a beam indication DCI (e.g., in part 1 of the beam indication DCI) for providing/indicating TCI codepoint(s) (and therefore, the corresponding TCI state(s)) for frequency-selective beam indication is greater than or equal to (or less than or equal to) a threshold, the UE could expect that the beam indication DCI could comprise two parts (i.e., part 1 and part 2 as specified herein in the present disclosure); otherwise, the UE could expect that the DCI for frequency-selective beam indication could comprise only one (or a single) part. Here, a TCI codepoint could point to a set of joint/DL/UL TCI states provided/indicated in/by a (unified) TCI state(s) activation/deactivation MAC CE command, which could correspond to a first MAC CE activation command or a second MAC CE activation command according to those specified herein in the present disclosure. Furthermore, the threshold could be determined according to (i) fixed value(s) specified/provided in system specification(s), (ii) network's configuration(s)/indication(s), e.g., via higher layer RRC signaling(s)/parameter(s) and/or MAC CE command(s) and/or dynamic DCI based L1 signaling(s), and/or (iii) UE's autonomous selection(s)/decision(s), which could also be sent to the network, e.g., in part of a beam/CSI report and/or UE's capability signaling(s).

In yet another example, when/if a UE receives from the network, e.g., via MAC CE signaling (such as a (unified) TCI state(s) activation/deactivation MAC CE providing/indicating one or more sets of TCI states with each set mapped to a TCI codepoint of a TCI field in a beam indication DCI) and/or dynamic DCI based L1 signaling (such as a beam indication DCI of format 1_1/1_2 with or without DL assignment), a dynamic configuration update such as activation(s)/indication(s)/update(s) of one or more sets of TCI states/one or more TCI states for frequency-selective beam indication for FSBM as specified herein in the present disclosure, activation(s)/indication(s)/update(s) of one or more TX frequency subbands for FSBM, and/or etc., the UE could expect that the DCI for frequency-selective beam indication could comprise both part 1 and part 2; otherwise, the UE could expect that the DCI for frequency-selective beam indication could comprise only one (or a single) part.

For the described design examples herein or the design examples specified herein in the present disclosure, a joint/DL/UL TCI state could correspond to (or could be replaced by) a joint/DL/UL TCI state dedicated for frequency-selective beam indication for FSBM according to those specified herein in the present disclosure, and/or a list/set/pool of joint/DL/UL TCI states could correspond to (or could be replaced by) a list/set/pool of joint/DL/UL TCI states dedicated for frequency-selective beam indication for FSBM according to those specified herein in the present disclosure, and/or a set of TCI state(s) indicated/provided by a (unified) TCI state(s) activation/deactivation MAC CE and used to map to a TCI codepoint of a TCI field in a beam indication DCI could correspond to (or could be replaced by) a set of TCI state(s) dedicated for frequency-selective beam indication for FSBM according to those specified herein in the present disclosure, and/or a TCI codepoint (comprising/corresponding to one or more TCI states) indicated by a TCI field in a beam indication DCI could correspond to (or could be replaced by) a TCI codepoint dedicated for frequency-selective beam indication for FSBM according those specified herein in the present disclosure.

Various means of signaling part 1 and/or part 2 of the two-part beam indication DCI for frequency-selective beam indication are provided, wherein as specified herein in the present disclosure, part 1 could be of fixed payload size, and/or could indicate/provide one or more first TCI states for frequency-selective beam indication and/or information (e.g., payload size) related to part 2 in the two-part beam indication DCI, and part 2 could be of flexible payload size, and/or could indicate/provide one or more second TCI states for frequency-selective beam indication. Furthermore, each of the one or more first TCI states in part 1 and/or each of the one or more second TCI states indicated in part 2 could correspond/map to one or more (TX) frequency subbands according to those specified herein in the present disclosure.

In one example, part 1 and part 2 of a two-part DCI for frequency-selective beam indication could be (transmitted/received) sequential in time and/or at the same time and/or within a time duration/window (e.g., in a/the same slot) and/or having a time offset. More specifically, PDCCH(s) that carries part 1 of the two-part beam indication DCI could start earlier or later in time or at the same time and/or within the time duration/window (e.g., in the same slot) and/or with a time offset than/as/to PDCCH(s) that carries part 2 of the two-part beam indication DCI, depending on, e.g., (i) fixed rule(s) specified/provided in system specification(s) and/or (ii) network's configuration(s)/indication(s), e.g., via higher layer RRC signaling(s)/parameter(s) and/or MAC CE command(s) and/or dynamic DCI based L1 signaling(s); alternatively, PDCCH(s) that carries part 1 of the two-part beam indication DCI could end earlier or later in time or at the same time and/or within the time duration/window (e.g., in the same slot) and/or with a time offset than/as/to PDCCH(s) that carries part 2 of the two-part beam indication DCI, depending on, e.g., (i) fixed rule(s) specified/provided in system specification(s) and/or (ii) network's configuration(s)/indication(s), e.g., via higher layer RRC signaling(s)/parameter(s) and/or MAC CE command(s) and/or dynamic DCI based L1 signaling(s); furthermore, the PDCCH(s) that carries part 1 of the two-part beam indication DCI may not overlap or may partially overlap or may fully overlap in time with the PDCCH(s) that carries part 2 of the two-part beam indication DCI. The UE could be indicated/provided/configured by the network, e.g., via higher layer RRC signaling(s)/parameter(s) and/or MAC CE command(s) and/or dynamic DCI based L1 signaling(s), the time duration/window or the time offset, wherein the time duration/window and/or the time offset could be in number of symbols, slots, etc. The time duration/window or the time offset, e.g., in number of symbols/slots/etc., could be fixed value(s) provided/specified in system specification(s).

In another example, part 1 and part 2 of a two-part DCI for frequency-selective beam indication could be (transmitted/received) on the same and/or in parallel on different frequency resources and/or within a frequency range/window and/or having a frequency offset, wherein a frequency resource could correspond to a frequency subband, a PRB and/or etc. More specifically, index/ID of starting frequency resource/RB of PDCCH(s) that carries part 1 of the two-part beam indication DCI could be lower or higher or the same than/as index/ID of starting/ending frequency resource/RB of PDCCH(s) that carries part 2 of the two-part beam indication DCI, and/or the starting frequency resource/RB of PDCCH(s) that carries part 1 of the two-part beam indication DCI could be within the frequency range/window or with a frequency offset relative to the starting/ending frequency resource/RB of PDCCH(s) that carries part 2 of the two-part beam indication DCI, depending on, e.g., (i) fixed rule(s) specified/provided in system specification(s) and/or (ii) network's configuration(s)/indication(s), e.g., via higher layer RRC signaling(s)/parameter(s) and/or MAC CE command(s) and/or dynamic DCI based L1 signaling(s); alternatively, index/ID of ending frequency resource/RB of PDCCH(s) that carries part 1 of the two-part beam indication DCI could be lower or higher or the same than/as index/ID of starting/ending frequency resource/RB of PDCCH(s) that carries part 2 of the two-part beam indication DCI, and/or the ending frequency resource/RB of PDCCH(s) that carries part 1 of the two-part beam indication DCI could be within the frequency range/window or with the frequency offset relative to the starting/ending frequency resource/RB of PDCCH(s) that carries part 2 of the two-part beam indication DCI, depending on, e.g., (i) fixed rule(s) specified/provided in system specification(s) and/or (ii) network's configuration(s)/indication(s), e.g., via higher layer RRC signaling(s)/parameter(s) and/or MAC CE command(s) and/or dynamic DCI based L1 signaling(s); here, the index/ID of the starting frequency resource/RB could be the highest or lowest among the indexes/IDs of the frequency resources/RBs of the corresponding channel (PDCCH(s) in this example), and the index/ID of the ending frequency/RB could be the lowest or highest among the indexes/IDs of the frequency resources/RBs of the corresponding channel (PDCCH(s) in this example). Furthermore, the PDCCH(s) that carries part 1 of the two-part beam indication DCI may not overlap or may partially overlap or may fully overlap in frequency with the PDCCH(s) that carries part 2 of the two-part beam indication DCI. The UE could be indicated/provided/configured by the network, e.g., via higher layer RRC signaling(s)/parameter(s) and/or MAC CE command(s) and/or dynamic DCI based L1 signaling(s), the frequency range/window or the frequency offset, wherein the frequency range/window and/or the frequency offset could be in number of PRBs, RBs, frequency subbands, etc. The frequency range/window or the frequency offset, e.g., in number of PRBs/RBs/frequency subbands/etc., could be fixed value(s) provided/specified in system specification(s).

In yet another example, part 1 and part 2 of a two-part DCI for frequency-selective beam indication could be (transmitted/received) sequential in time and/or at the same time and/or within a time duration/window (e.g., in a/the same slot) and/or having a time offset, and/or part 1 and part 2 of the two-part DCI for frequency-selective beam indication could be (transmitted/received) on the same and/or in parallel on different frequency resources and/or within a frequency range/window and/or having a frequency offset, according to those specified/described herein in the present disclosure (e.g., the two design examples described herein).

The PDCCH(s)/DCI that carries part 1 (and/or part 2) of the two-part DCI for frequency-selective beam indication as specified herein in the present disclosure could be transmitted in a search space and/or with a control resource set (CORESET). The UE could monitor a PDCCH/DCI channel in a search space and/or with a CORESET that includes/carries/provides part 1 (and/or part 2) of the two-part beam indication DCI. The search space (or the corresponding search space set) could be linked to another search space (or the corresponding search space set) via higher layer signaling(s)/parameter(s). In addition, the CORESET could be configured/provided with a value of coresetPoolIndex (e.g., 0 or 1).

In one example, the search space for the PDCCH(s)/DCI that carries part 1 (and/or part 2) of the two-part frequency-selective beam indication is a common search space (CSS).

In another example, the search space for the PDCCH(s)/DCI that carries part 1 (and/or part 2) of the two-part frequency-selective beam indication is a UE specific search space (USS).

In yet another example, the search space for the PDCCH(s)/DCI that carries part 1 (and/or part 2) of the two-part frequency-selective beam indication is a UE-group specific search space.

In yet another example, the CORESET in which the PDCCH(s)/DCI that carries part 1 (and/or part 2) of the two-part frequency-selective beam indication is received is a common CORESET.

In yet another example, the CORESET in which the PDCCH(s)/DCI that carries part 1 (and/or part 2) of the two-part frequency-selective beam indication is received is a UE-specific CORESET.

In yet another example, the CORESET in which the PDCCH(s)/DCI that carries part 1 (and/or part 2) of the two-part frequency-selective beam indication is received is a UE-group specific CORESET.

As specified herein in the present disclosure, the PDCCH(s)/DCI that carries part 1 (and/or part 2) of the two-part frequency-selective beam indication could be a DL-related DCI (e.g., a beam indication DCI of format 1_1/1_2 with or without DL assignment), a UL-related DCI (e.g., DCI format 0_1/0_2), or PDCCH(s)/DCI providing other L1 control information to the UE.

Optionally, the PDCCH(s)/DCI that carries part 1 (and/or part 2) of the two-part DCI for frequency-selective beam indication as specified herein in the present disclosure could be transmitted in multiple (i.e., more than one) search spaces and/or with multiple (i.e., more than one) control resource sets (CORESETs). The UE could monitor a PDCCH/DCI channel in multiple search spaces and/or with multiple CORESETs that include/carry/provide part 1 (and/or part 2) of the two-part beam indication DCI. One or more of the search spaces (or the corresponding search space sets) could be linked to one or more of another/other search spaces (or the corresponding search space sets) via higher layer signaling(s)/parameter(s). In addition, one or more of the CORESETs could be configured/provided with a value of coresetPoolIndex (e.g., 0 or 1). The payload size could be different for each of the search spaces and/or for each of the CORESETs. The UE could determine or could be indicated/provided by the network, e.g., via higher layer RRC signaling(s)/parameter(s) and/or MAC CE command(s) and/or dynamic DCI based L1 signaling(s), the payload size based on the search space(s) and/or CORESET(s) of the PDCCH(s)/DCI detected that contains/carries/provides part 1 (and/or part 2) of the two-part frequency-selective beam indication.

In one example, the multiple search spaces for the PDCCH(s)/DCI that carries part 1 (and/or part 2) of the two-part frequency-selective beam indication are common search spaces (CSSs).

In another example, the multiple search spaces for the PDCCH(s)/DCI that carries part 1 (and/or part 2) of the two-part frequency-selective beam indication are UE specific search spaces (USSs).

In yet another example, the multiple search spaces for the PDCCH(s)/DCI that carries part 1 (and/or part 2) of the two-part frequency-selective beam indication are UE-group specific search spaces.

In yet another example, the multiple search spaces for the PDCCH(s)/DCI that carries part 1 (and/or part 2) of the two-part frequency-selective beam indication are one or more CSSs and/or one or more USSs and/or one or more UE-group specific search spaces as specified herein in the present disclosure.

In yet another example, the multiple CORESETs in which the PDCCH(s)/DCI that carries part 1 (and/or part 2) of the two-part frequency-selective beam indication is received are common CORESETs.

In yet another example, the multiple CORESETs in which the PDCCH(s)/DCI that carries part 1 (and/or part 2) of the two-part frequency-selective beam indication is received are UE-specific CORESETs.

In yet another example, the multiple CORESETs in which the PDCCH(s)/DCI that carries part 1 (and/or part 2) of the two-part frequency-selective beam indication is received are UE-group specific CORESETs.

In yet another example, the multiple CORESETs in which the PDCCH(s)/DCI that carries part 1 (and/or part 2) of the two-part frequency-selective beam indication is received are one or more common CORESETs and/or one or more UE-specific CORESETs and/or one or more UE-group specific CORESETs as specified herein in the present disclosure.

As specified herein in the present disclosure, the PDCCH(s)/DCI that carries part 1 (and/or part 2) of the two-part frequency-selective beam indication could be a DL-related DCI (e.g., a beam indication DCI of format 1_1/1_2 with or without DL assignment), a UL-related DCI (e.g., DCI format 0_1/0_2), or PDCCH(s)/DCI providing other L1 control information to the UE.

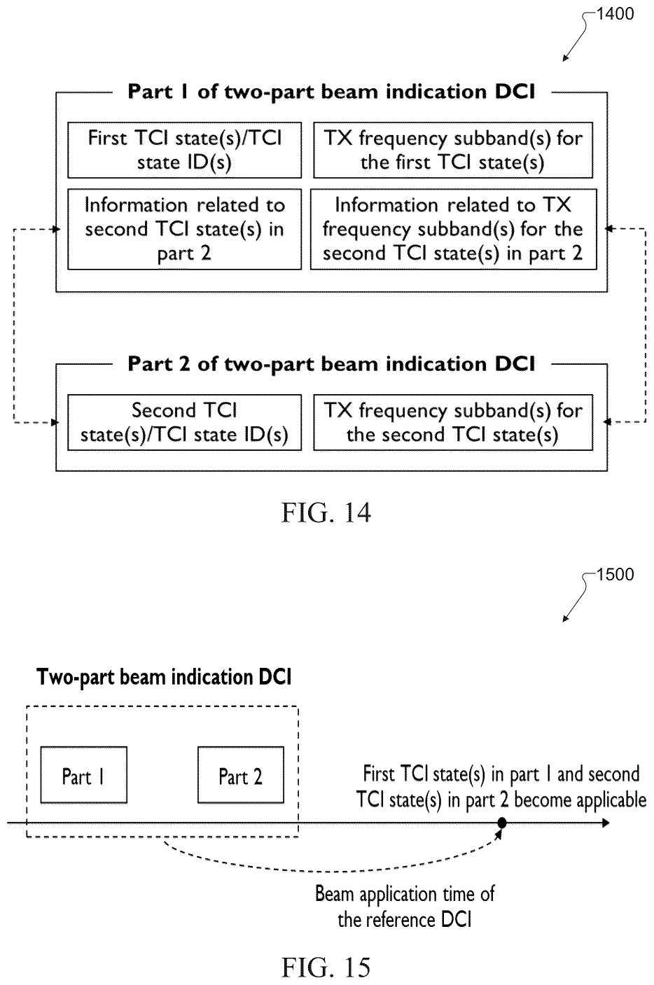

FIG. 14 illustrates a diagram of an example two-part beam indication DCI 1400 for frequency-selective beam indication according to embodiments of the present disclosure. For example, the two-part beam indication DCI 1400 for frequency-selective beam indication may be utilized by any of the UEs 111-116, such as the UE 114. This example is for illustration only and other embodiments can be used without departing from the scope of the present disclosure.

As specified herein in the present disclosure, a UE could be indicated/provided by the network, e.g., via one or more (denoted by Ncp≥1) TCI codepoints of one or more (denoted by Ntci≥1) TCI fields in a beam indication DCI (e.g., DCI format 1_1/1_2 with or without DL assignment), one or more (denoted by N≥1) TCI states/pairs of TCI states, wherein each of the indicated TCI states/pairs of TCI states could be associated/corresponding to one or more TX frequency subbands for frequency-selective beam indication according to those specified herein in the present disclosure. The value(s) of Ncp and/or Ntci and/or N could be: (1) fixed in system specification(s) and/or (2) flexible and configured/provided/indicated by the network, e.g., via higher layer RRC signaling(s)/parameter(s) and/or MAC CE command(s) and/or dynamic DCI based L1 signaling(s). Optionally, Ncp could be less than or equal to Ncp_max (i.e., Ncp Ncp_max), and/or Ntci could be less than or equal to Ntci_max (i.e., Ntci≤Ntci_max), and/or N could be less than or equal to N_max (i.e., N≤N_max), wherein the value(s) of Ncp_max and/or Ntci_max and/or N_max could be: (1) fixed in system specification(s) and/or (2) flexible and configured/provided/indicated by the network, e.g., via higher layer RRC signaling(s)/parameter(s) and/or MAC CE command(s) and/or dynamic DCI based L1 signaling(s). Furthermore, as specified herein in the present disclosure, the beam indication DCI could comprise two parts—i.e., part 1 and part 2—according to those specified herein in the present disclosure. Specifically, the UE could be indicated/provided by the network, e.g., via one or more (denoted by Ncp1≥1) first TCI codepoints of one or more (denoted by Ntci1≥1) first TCI fields in part 1 of the beam indication DCI (e.g., DCI format 1_1/1_2 with or without DL assignment), one or more (denoted by N1≥1) first TCI states/pairs of TCI states, wherein each of the indicated first TCI states/pairs of TCI states could be associated/corresponding to one or more TX frequency subbands for frequency-selective beam indication according to those specified herein in the present disclosure, and/or the UE could be indicated/provided by the network, e.g., via one or more (denoted by Ncp2≥1) second TCI codepoints of one or more (denoted by Ntci2≥1) second TCI fields in part 2 of the beam indication DCI (e.g., DCI format 1_1/1_2 with or without DL assignment), one or more (denoted by N2≥1) second TCI states/pairs of TCI states, wherein each of the indicated second TCI states/pairs of TCI states could be associated/corresponding to one or more TX frequency subbands for frequency-selective beam indication according to those specified herein in the present disclosure. Here, Ncp=Ncp1+Ncp2, Ntci=Ntci1+Ntci2 and N=N1+N2. In addition, the value(s) of Ncp1 and/or Ntci1 and/or N1 for part 1 of the two-part DCI for frequency-selective beam indication could be: (1) fixed in system specification(s) and/or (2) flexible and configured/provided/indicated by the network, e.g., via higher layer RRC signaling(s)/parameter(s) and/or MAC CE command(s) and/or dynamic DCI based L1 signaling(s); and, Ncp1 could be less than or equal to Ncp1_max (i.e., Ncp1≤Ncp1_max), and/or Ntci1 could be less than or equal to Ntci1_max (i.e., Ntci1≤Ntci1_max), and/or N1 could be less than or equal to N1_max (i.e., N1≤N1_max), wherein the value(s) of Ncp1_max and/or Ntci1_max and/or N1_max could be: (1) fixed in system specification(s) and/or (2) flexible and configured/provided/indicated by the network, e.g., via higher layer RRC signaling(s)/parameter(s) and/or MAC CE command(s) and/or dynamic DCI based L1 signaling(s). The value(s) of Ncp2 and/or Ntci2 and/or N2 for part 2 of the two-part DCI for frequency-selective beam indication could be: (1) fixed in system specification(s) and/or (2) flexible and configured/provided/indicated by the network, e.g., via higher layer RRC signaling(s)/parameter(s) and/or MAC CE command(s) and/or dynamic DCI based L1 signaling(s); and, Ncp2 could be less than or equal to Ncp2_max (i.e., Ncp2≤Ncp2_max), and/or Ntci2 could be less than or equal to Ntci2_max (i.e., Ntci2≤Ntci2_max), and/or N2 could be less than or equal to N2_max (i.e., N2≤N2_max), wherein the value(s) of Ncp2_max and/or Ntci2_max and/or N2_max could be: (1) fixed in system specification(s) and/or (2) flexible and configured/provided/indicated by the network, e.g., via higher layer RRC signaling(s)/parameter(s) and/or MAC CE command(s) and/or dynamic DCI based L1 signaling(s). In one example, N1=0, i.e., N2=N; for this case, each of the (second) TCI states/TCI state IDs are provided/indicated in part 2 of the two-part beam indication DCI. In another example, N2=0, i.e., N1=N; for this case, each of the (first) TCI states/TCI state IDs are provided/indicated in part 1 of the two-part beam indication DCI. As the value(s) of N (Ncp, Ntci) and/or N1 (Ncp1, Ntci1) and/or N2 (Ncp2, Ntci2) could be flexible/dynamically changed, when/if, e.g., the size/resolution of the TX frequency subband(s)—e.g., the frequency-domain resource(s) allocation of the TX frequency subband(s), e.g., via FD-RA in the corresponding DCI in number of PRBs/RBs/etc.—corresponding/associated to each of the TCI states and/or each of the first TCI state(s) and/or each of the second TCI state(s) is the same/identical, the UE could identify/determine the value(s) of N (Ncp, Ntci) and/or N1 (Ncp1, Ntci1) and/or N2 (Ncp2, Ntci2) according to/from the number and/or size/resolution of the TX frequency subband(s) corresponding/associated to the (first/second) TCI state(s) according to those specified herein in the present disclosure. Optionally, the UE could be indicated/provided by the network (e.g., the network 130) or could identify/determine the value(s) of N (Ncp, Ntci) and/or N1 (Ncp1, Ntci1) and/or N2 (Ncp2, Ntci2) in/from part 1 and/or part 2 of the two-part beam indication DCI. In particular, part 1 of the two-part DCI for frequency-selective beam indication could provide/contain/comprise/include/indicate one or more of the following.

Part 1 of the two-part beam indication DCI could comprise/provide/indicate first information related to the first TCI state(s) and/or the first TCI codepoint(s) and/or the first TCI field(s) as specified herein in the present disclosure, wherein the first information could include/contain/comprise one or more of the following.
The (maximum) number of the first TCI state(s) in part 1, e.g., N1 (N1_max) here;
The (maximum) number of the first TCI codepoint(s) in part 1, e.g., Ncp1 (Ncp1_max) here;
The (maximum) number of the first TCI field(s) in part 1, e.g., Ntci1 (Ntci1_max) here;
The first TCI state(s) and/or index(es)/ID(s) of the first TCI state(s)—e.g., among the TCI states configured (e.g., via higher layer RRC signaling(s)/parameter(s)) and/or activated (e.g., via MAC CE activation command(s)) and/or indicated (e.g., via dynamic DCI based L1 signaling(s) such as beam indication DCI) to the UE, e.g., for frequency-selective beam indication for FSBM;
The first TCI codepoint(s) and/or index(es)/ID(s) of the first TCI codepoint(s) that provides/indicates the first TCI state(s); and/or
A bitmap with each bit/bit position of the bitmap corresponding/associated to a TCI state/TCI state ID or a pair of TCI states/TCI state IDs—e.g., among the TCI states configured (e.g., via higher layer RRC signaling(s)/parameter(s)) and/or activated (e.g., via MAC CE activation command(s)) and/or indicated (e.g., via dynamic DCI based L1 signaling(s) such as beam indication DCI) to the UE, e.g., for frequency-selective beam indication for FSBM according to those specified herein in the present disclosure. When/if a bit/bit position of the bitmap is set to ‘1’ (or ‘0’), the TCI state(s) corresponding/associated to the bit/bit position belongs to the first TCI state(s) in part 1 of the two-part beam indication DCI.

The first TCI state(s)/TCI codepoint(s)/TCI field(s) in part 1 could have the following properties/characteristics.

For example, the one or more first TCI states could correspond to one or more TCI states configured (e.g., via higher layer RRC signaling(s)/parameter(s)) and/or activated (e.g., via MAC CE activation command(s)) and/or indicated (e.g., via dynamic DCI based L1 signaling(s) such as beam indication DCI) for the entire (wide) frequency band comprising (all of) the TX frequency subbands for FSBM.

For another example, the one or more first TCI states could correspond to the TCI state(s) with the lowest/highest TCI state ID(s) among the TCI states configured (e.g., via higher layer RRC signaling(s)/parameter(s)) and/or activated (e.g., via MAC CE activation command(s)) and/or indicated (e.g., via dynamic DCI based L1 signaling(s) such as beam indication DCI) to the UE, e.g., for frequency-selective beam indication for FSBM. Optionally, the one or more first TCI states could correspond to the TCI state(s) associated/corresponding to the TX frequency subband(s) with the lowest/highest frequency subband index(es)/ID(s)—e.g., the first/last TX frequency subband(s)—among (all of) the TX frequency subbands configured/indicated/activated/provided to the UE (e.g., the UE 116) for FSBM.

Yet for another example, the one or more first TCI codepoints that provide/indicate/comprise/correspond to the one or more first TCI states could correspond to the TCI codepoint(s) with the lowest/highest TCI codepoint index(es)/ID(s) among of the TCI codepoints or among of the TCI codepoints each providing/indicating/comprising/corresponding to a single TCI state/pair of TCI states or among of the TCI codepoints each providing/indicating/comprising/corresponding to multiple (i.e., more than one) TCI states/pairs of TCI states activated/indicated/provided in the (unified) TCI state(s) activation/deactivation MAC CE. Or equivalently, the one or more first TCI codepoints that provide/indicate/comprise/correspond to the one or more first TCI states could correspond to the set(s) of TCI state(s) with the lowest/highest TCI state set index(es)/ID(s) among of the TCI state sets or among of the TCI state sets each providing/indicating/comprising a single TCI state/pair of TCI states or among of the TCI state sets each providing/indicating/comprising multiple (i.e., more than one) TCI states/pairs of TCI states activated/indicated/provided in the (unified) TCI state(s) activation/deactivation MAC CE. Each set of TCI state(s) or each TCI state set could be mapped to a TCI codepoint of a TCI field in a beam indication DCI.

Part 1 of the two-part beam indication DCI could comprise/provide/indicate second information related to the TX frequency subband(s) corresponding/associated to the first TCI state(s) according to those specified herein in the present disclosure, wherein the second information could include/contain/comprise one or more of the following.
The number of the TX frequency subband(s) corresponding/associated to the first TCI state(s);
Index(es)/ID(s) of the TX frequency subbands associated/corresponding to the first TCI state(s)—e.g., among (all of) the TX frequency subbands configured/indicated/activated/provided to the UE for FSBM; the UE could then identify/determine the first TCI state(s), e.g., when/if the first information related to the first TCI state(s)/TCI codepoint(s)/TCI field(s) is not provided/indicated in part 1, from the indicated/provided/configured index(es)/ID(s) of the TX frequency subbands; and/or
A bitmap with each bit/bit position of the bitmap corresponding/associated to a TX frequency subband—e.g., among (all of) the TX frequency subbands configured/indicated/activated/provided to the UE for FSBM; the UE could first determine/identify one or more TX frequency subbands with their associated/corresponding bits/bit positions in the bitmap set to ‘1’s (or ‘0’s). When/if the first information related to the first TCI state(s)/TCI codepoint(s)/TCI field(s) is not provided/indicated in part 1, the UE could further identify/determine that the TCI state(s) associated/corresponding to the determined/identified one or more TX frequency subbands according to those specified herein in the present disclosure belongs to the first TCI state(s).

Part 1 of the two-part beam indication DCI could comprise/provide/indicate third information related to (general information, settings, configurations of) part 2 of the two-part beam indication DCI, wherein the third information could include/contain/comprise one or more of the following.
Payload size of part 2 of the two-part beam indication DCI;
Time (e.g., in number of symbols/slots/etc.) and/or frequency (e.g., in number of frequency subbands/PRBs/etc.) resource(s) allocation for the PDCCH(s)/DCI that carries part 2 of the two-part beam indication DCI;
Time (e.g., in form/terms of slot index(es), symbol index(es) and/or etc.) and/or frequency (e.g., in form/terms of frequency subband index(es)/ID(s), PRB/RB index(es)/ID(s) and/or etc.) resource(s) location(s) for the PDCCH(s)/DCI that carries part 2 of the two-part beam indication DCI;
Time (e.g., in form/terms of a time duration/window and/or a time offset, wherein the time duration/window and/or the time offset could be in number of slots/symbols/etc. as specified herein in the present disclosure) and/or frequency (e.g., in form/terms of a frequency range/window and/or a frequency offset, wherein the frequency range/window and/or the frequency offset could be in number of frequency subbands/PRBs/etc. as specified herein in the present disclosure) resource(s) location(s) for the PDCCH(s)/DCI that carries part 2 of the two-part beam indication DCI relative to the PDCCH(s)/DCI that carries part 1 of the two-part beam indication DCI;
Starting and/or ending time (e.g., starting and/or ending symbol index(es)/slot index(es)/etc.) of the PDCCH(s)/DCI that carries part 2 of the two-part beam indication DCI;
Starting and/or ending frequency (e.g., starting and/or ending frequency subband index(es)/PRB index(es)/RB index(es)) of the PDCCH(s)/DCI that carries part 2 of the two-part beam indication DCI; and/or
An indicator to indicate whether part 2 is present or not in the two-part beam indication DCI; for instance, the indicator could be a one-bit indicator with ‘1’ (or ‘0’) indicating that part 2 is absent.

Part 1 of the two-part beam indication DCI could comprise/provide/indicate fourth information related to the second TCI state(s) and/or the second TCI codepoint(s) and/or the second TCI field(s) in part 2 as specified herein in the present disclosure, wherein the fourth information could include/contain/comprise one or more of the following.
The (maximum) number of the second TCI state(s) in part 2, e.g., N2 (N2 max) here;
The (maximum) number of the second TCI codepoint(s) in part 2, e.g., Ncp2 (Ncp2_max) here;
The (maximum) number of the second TCI field(s) in part 2, e.g., Ntci2 (Ntci2_max) here;
Index(es)/ID(s) of one or more candidate TCI states—e.g., among the TCI states configured (e.g., via higher layer RRC signaling(s)/parameter(s)) and/or activated (e.g., via MAC CE activation command(s)) and/or indicated (e.g., via dynamic DCI based L1 signaling(s) such as beam indication DCI) to the UE, e.g., for frequency-selective beam indication for FSBM according to those specified herein in the present disclosure—for indicating/providing/determining/identifying the second TCI state(s) in part 2;
A bitmap with each bit/bit position of the bitmap corresponding/associated to a TCI state/TCI state ID or a pair of TCI states/TCI state IDs—e.g., among the TCI states configured (e.g., via higher layer RRC signaling(s)/parameter(s)) and/or activated (e.g., via MAC CE activation command(s)) and/or indicated (e.g., via dynamic DCI based L1 signaling(s) such as beam indication DCI) to the UE, e.g., for frequency-selective beam indication for FSBM according to those specified herein in the present disclosure. When/if a bit/bit position of the bitmap is set to ‘1’ (or ‘0’), the TCI state(s) corresponding/associated to the bit/bit position belongs to the candidate TCI state(s) for indicating/providing/determining/identifying the second TCI state(s) in part 2;
One or more candidate sets of TCI states/TCI state IDs for providing/indicating/identifying/determining the second TCI state(s) in part 2;
Index(es)/ID(s) of one or more (candidate) sets of TCI states/TCI state IDs—among the sets of TCI states/TCI state IDs provided/indicated/activated in/by a (unified) TCI state(s) activation/deactivation MAC CE—for indicating/providing/determining/identifying the second TCI state(s) in part 2; and/or
A bitmap with each bit/bit position of the bitmap associated/corresponding to a set of TCI states/TCI state IDs provided/indicated/activated in/by a (unified) TCI state(s) activation/deactivation MAC CE; when/if a bit/bit position of the bitmap is set to ‘1’ (or ‘0’), the set of TCI states/TCI state IDs corresponding/associated to the bit/bit position belongs to the candidate set(s) of TCI states/TCI state IDs for indicating/providing/determining/identifying the second TCI state(s) in part 2.

Part 1 of the two-part beam indication DCI could comprise/provide/indicate fifth information related to the TX frequency subband(s) corresponding/associated to the second TCI state(s) in part 2 according to those specified herein in the present disclosure, wherein the fifth information could include/contain/comprise one or more of the following.
The number of the TX frequency subband(s) corresponding/associated to the second TCI state(s) in part 2;
Index(es)/ID(s) of the TX frequency subbands associated/corresponding to the second TCI state(s)—e.g., among (all of) the TX frequency subbands configured/indicated/activated/provided to the UE for FSBM; the UE could then identify/determine the second TCI state(s), e.g., when/if the second TCI state(s)/TCI codepoint(s)/TCI field(s) is not provided/indicated in part 2, from the indicated/provided/configured index(es)/ID(s) of the TX frequency subbands;
Index(es)/ID(s) of one or more candidate TX frequency subbands—e.g., among (all of) the TX frequency subbands configured/indicated/activated/provided to the UE for FSBM—for providing/indicating/determining/identifying the TX frequency subband(s) associated/corresponding to the second TCI state(s) in part 2;
A bitmap with each bit/bit position of the bitmap corresponding/associated to a TX frequency subband—e.g., among (all of) the TX frequency subbands configured/indicated/activated/provided to the UE for FSBM; the UE could first determine/identify one or more TX frequency subbands with their associated/corresponding bits/bit positions in the bitmap set to ‘1’s (or ‘0’s). When/if the second TCI state(s)/TCI codepoint(s)/TCI field(s) is not provided/indicated in part 2, the UE could further identify/determine that the TCI state(s) associated/corresponding to the determined/identified one or more TX frequency subbands according to those specified herein in the present disclosure belongs to the second TCI state(s); and/or
A bitmap with each bit/bit position of the bitmap corresponding/associated to a TX frequency subband—e.g., among (all of) the TX frequency subbands configured/indicated/activated/provided to the UE for FSBM; when/if a bit/bit position in the bitmap is set to ‘1’ (or ‘0’), the TX frequency subband corresponding/associated to the bit/bit position belongs to the candidate TX frequency subband(s) for providing/indicating/determining/identifying the TX frequency subband(s) associated/corresponding to the second TCI state(s) in part 2.

Part 1 of the two-part beam indication DCI could comprise/provide/indicate sixth information including/comprising/containing one or more of the following.
The (maximum) total number of the TCI state(s) in the (two-part) DCI for frequency-selective beam indication, e.g., N (N_max) here;
The (maximum) total number of the TCI codepoint(s) in the (two-part) DCI for frequency-selective beam indication, e.g., Ncp (Ncp_max) here; and/or
The (maximum) total number of the TCI field(s) in (two-part) DCI for frequency-selective beam indication, e.g., Ntci (Ntci_max) here.

The first information and/or the second information and/or the third information and/or the fourth information and/or the fifth information and/or the sixth information as specified herein in the present disclosure could be provided/indicated by one or more new/dedicated DCI fields in part 1 of the two-part beam indication DCI. Optionally, the first information and/or the second information and/or the third information and/or the fourth information and/or the fifth information and/or the sixth information as specified herein in the present disclosure could be provided/indicated by repurposing one or more bits/codepoints of one or more existing DCI fields such as TCI field(s), TCI selection field(s), SRS resource indicator (SRI) field(s), SRS resource set indicator field(s) and/or etc. in part 1 of the two-part DCI for frequency-selective beam indication. Furthermore, part 2 of the two-part DCI for frequency-selective beam indication could provide/contain/comprise/include/indicate one or more of the following.

Part 2 of the two-part beam indication DCI could comprise/provide/indicate seventh information related to the second TCI state(s) and/or the second TCI codepoint(s) and/or the second TCI field(s) as specified herein in the present disclosure, wherein the seventh information could include/contain/comprise one or more of the following.
The second TCI state(s) and/or index(es)/ID(s) of the second TCI state(s)—e.g., among the TCI states configured (e.g., via higher layer RRC signaling(s)/parameter(s)) and/or activated (e.g., via MAC CE activation command(s)) and/or indicated (e.g., via dynamic DCI based L1 signaling(s) such as beam indication DCI) to the UE, e.g., for frequency-selective beam indication for FSBM, or among the candidate TCI states provided/indicated in part 1 of the two-part beam indication DCI;
A bitmap with each bit/bit position of the bitmap corresponding/associated to a TCI state/TCI state ID or a pair of TCI states/TCI state IDs—e.g., among the TCI states configured (e.g., via higher layer RRC signaling(s)/parameter(s)) and/or activated (e.g., via MAC CE activation command(s)) and/or indicated (e.g., via dynamic DCI based L1 signaling(s) such as beam indication DCI) to the UE, e.g., for frequency-selective beam indication for FSBM according to those specified herein in the present disclosure. When/if a bit/bit position of the bitmap is set to ‘1’ (or ‘0’), the TCI state(s) corresponding/associated to the bit/bit position belongs to the second TCI state(s) in part 2 of the two-part beam indication DCI;
A bitmap with each bit/bit position of the bitmap corresponding/associated to a TCI state/TCI state ID or a pair of TCI states/TCI state IDs—e.g., among the candidate TCI states provided/indicated in part 1 of the two-part beam indication DCI. When/if a bit/bit position of the bitmap is set to ‘1’ (or ‘0’), the TCI state(s) corresponding/associated to the bit/bit position belongs to the second TCI state(s) in part 2 of the two-part beam indication DCI;
Index(es)/ID(s) of one or more sets of TCI states/TCI state IDs (corresponding to the second TCI state(s))—e.g., among the sets of TCI states/TCI state IDs provided/indicated in the (unified) TCI state(s) activation/deactivation MAC CE command as specified herein in the present disclosure, or among the candidate sets of TCI states/TCI state IDs provided/indicated in part 1 of the two-part beam indication DCI;
A bitmap with each bit/bit position of the bitmap corresponding/associated to a set of TCI states/TCI state IDs—e.g., among the sets of TCI states/TCI state IDs provided/indicated in the (unified) TCI state(s) activation/deactivation MAC CE command as specified herein in the present disclosure. When/if a bit/bit position of the bitmap is set to ‘1’ (or ‘0’), the set of TCI state(s) corresponding/associated to the bit/bit position belongs to the second TCI state(s) in part 2 of the two-part beam indication DCI;
A bitmap with each bit/bit position of the bitmap corresponding/associated to a set of TCI states/TCI state IDs—e.g., among the candidate sets of TCI states/TCI state IDs provided/indicated in part 1 of the two-part beam indication DCI. When/if a bit/bit position of the bitmap is set to ‘1’ (or ‘0’), the set of TCI state(s) corresponding/associated to the bit/bit position belongs to the second TCI state(s) in part 2 of the two-part beam indication DCI;
The second TCI codepoint(s) and/or index(es)/ID(s) of the second TCI codepoint(s) that provides/indicates the second TCI state(s), wherein each second TCI codepoint here could point to a set of TCI states/TCI state IDs—e.g., among the sets of TCI states/TCI state IDs provided/indicated in the (unified) TCI state(s) activation/deactivation MAC CE command as specified herein in the present disclosure; and/or
The second TCI codepoint(s) and/or index(es)/ID(s) of the second TCI codepoint(s) that provides/indicates the second TCI state(s), wherein each second TCI codepoint here could point to a set of TCI states/TCI state IDs—e.g., among the candidate sets of TCI states/TCI state IDs provided/indicated in part 1 of the two-part DCI for frequency-selective beam indication.

Part 2 of the two-part beam indication DCI could comprise/provide/indicate eighth information related to the TX frequency subband(s) corresponding/associated to the second TCI state(s) according to those specified herein in the present disclosure, wherein the eighth information could include/contain/comprise one or more of the following.
The number of the TX frequency subband(s) corresponding/associated to the second TCI state(s) in part 2;
Index(es)/ID(s) of the TX frequency subbands associated/corresponding to the second TCI state(s)—e.g., among (all of) the TX frequency subbands configured/indicated/activated/provided to the UE for FSBM; the UE could then identify/determine the second TCI state(s), e.g., when/if the seventh information related to the second TCI state(s)/TCI codepoint(s)/TCI field(s) is not provided/indicated in part 2, from the indicated/provided/configured index(es)/ID(s) of the TX frequency subbands;
Index(es)/ID(s) of the TX frequency subbands associated/corresponding to the second TCI state(s)—e.g., among (all of) the candidate TX frequency subbands provided/indicated in part 1 of the two-part beam indication DCI; the UE could then identify/determine the second TCI state(s), e.g., when/if the seventh information related to the second TCI state(s)/TCI codepoint(s)/TCI field(s) is not provided/indicated in part 2, from the indicated/provided/configured index(es)/ID(s) of the TX frequency subbands;
A bitmap with each bit/bit position of the bitmap corresponding/associated to a TX frequency subband—e.g., among (all of) the TX frequency subbands configured/indicated/activated/provided to the UE for FSBM; the UE could first determine/identify one or more TX frequency subbands with their associated/corresponding bits/bit positions in the bitmap set to ‘1’s (or ‘0’s). When/if the seventh information related to the second TCI state(s)/TCI codepoint(s)/TCI field(s) is not provided/indicated in part 2, the UE could further identify/determine that the TCI state(s) associated/corresponding to the determined/identified one or more TX frequency subbands according to those specified herein in the present disclosure belongs to the second TCI state(s); and/or
A bitmap with each bit/bit position of the bitmap corresponding/associated to a TX frequency subband—e.g., among (all of) the candidate TX frequency subbands provided/indicated in part 1 of the two-part beam indication DCI; the UE could first determine/identify one or more TX frequency subbands with their associated/corresponding bits/bit positions in the bitmap set to ‘1’s (or ‘0’s). When/if the seventh information related to the second TCI state(s)/TCI codepoint(s)/TCI field(s) is not provided/indicated in part 2, the UE could further identify/determine that the TCI state(s) associated/corresponding to the determined/identified one or more TX frequency subbands according to those specified herein in the present disclosure belongs to the second TCI state(s).

The seventh information and/or the eighth information as specified herein in the present disclosure could be provided/indicated by one or more new/dedicated DCI fields in part 2 of the two-part beam indication DCI. Optionally, the seventh information and/or the eighth information as specified herein in the present disclosure could be provided/indicated by repurposing one or more bits/codepoints of one or more existing DCI fields such as TCI field(s), TCI selection field(s), SRI field(s), SRS resource set indicator field(s) and/or etc. in part 2 of the two-part DCI for frequency-selective beam indication. Furthermore, component(s)/information provided/indicated in part 1 could also be indicated/provided in part 2; likewise, component(s)/information provided/indicated in part 2 could also be indicated/provided in part 1. With reference to FIG. 14, a conceptual example of part 1 and part 2 of a two-part DCI for frequency-selective beam indication is shown.

FIG. 15 illustrates a diagram of an example beam application time for a two-part beam indication DCI 1500 for frequency-selective beam indication according to embodiments of the present disclosure. For example, the beam application time for the two-part beam indication DCI 1500 for frequency-selective beam indication may be utilized by any of the UEs 111-116, such as the UE 115. This example is for illustration only and other embodiments can be used without departing from the scope of the present disclosure.

For the two-part DCI based frequency-selective beam indication for FSBM, when the UE could start to use/apply the first TCI state(s) in part 1 and/or the second TCI state(s) in part 2 for transmitting/receiving UL/DL channels/signals in/on the corresponding/associated TX frequency subband(s) according to those specified herein in the present disclosure could be based on beam application time determined/identified/specified/defined for/according to one or more reference DCIs, wherein the reference DCI(s) could correspond to the PDCCH(s)/DCI that carries part 1 and/or the PDCCH(s)/DCI that carries part 2 of the two-part beam indication DCI.

In one example, the beam application time could be jointly determined/identified/specified/defined for/according to both part 1 and part 2 of the two-part beam indication DCI. For this case, the reference DCI could correspond to the two-part DCI of its entirety that comprises both part 1 and part 2 for frequency-selective beam indication. For this case, the UE could start to use/apply the first TCI state(s) in part 1 and the second TCI state(s) in part 2 for transmitting/receiving UL/DL channels/signals in/on the corresponding/associated TX frequency subband(s) based on the beam application time determined/identified for/according to the reference DCI. With reference to FIG. 15, a conceptual example characterizing this design example is shown.

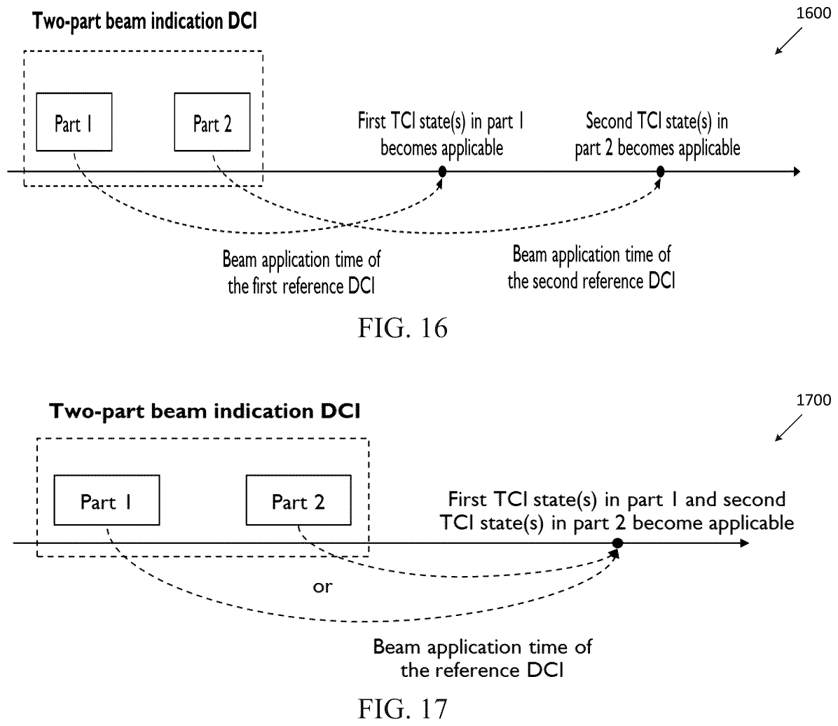

FIG. 16 illustrates a diagram of an example beam application time for a two-part beam indication DCI 1600 for frequency-selective beam indication according to embodiments of the present disclosure. For example, the beam application time for the two-part beam indication DCI 1600 for frequency-selective beam indication may be utilized by any of the UEs 111-116, such as the UE 116. This example is for illustration only and other embodiments can be used without departing from the scope of the present disclosure.

In another example, the beam application time could be separately determined/identified/specified/defined for/according to part 1 and part 2 of the two-part beam indication DCI. For this case, a first reference DCI could correspond to the PDCCH(s)/DCI that carries part 1 of the two-part beam indication DCI; the UE could then start to use/apply the first TCI state(s) in part 1 for transmitting/receiving UL/DL channels/signals in/on the corresponding/associated TX frequency subband(s) based on first beam application time determined/identified for/according to the first reference DCI. In addition, a second reference DCI could correspond to the PDCCH(s)/DCI that carries part 2 of the two-part beam indication DCI; the UE could then start to use/apply the second TCI state(s) in part 2 for transmitting/receiving UL/DL channels/signals in/on the corresponding/associated TX frequency subband(s) based on second beam application time determined/identified for/according to the second reference DCI. With reference to FIG. 16, a conceptual example characterizing this design example is shown.

FIG. 17 illustrates a diagram of an example beam application time for a two-part beam indication DCI 1700 for frequency-selective beam indication according to embodiments of the present disclosure. For example, the beam application time for the two-part beam indication DCI 1700 for frequency-selective beam indication may be utilized by the UE 116 of FIG. 3. This example is for illustration only and other embodiments can be used without departing from the scope of the present disclosure.

In yet another example, the beam application time could be determined/identified/specified/defined for/according to either part 1 or part 2 of the two-part beam indication DCI. For this case, the reference DCI could correspond to either the PDCCH(s)/DCI that carries part 1 or the PDCCH(s)/DCI that carries part 2 of the two-part DCI for frequency-selective beam indication according to one or more of the following.
For example, the reference DCI could correspond to the PDCCH(s)/DCI that carries part 1.
For another example, the reference DCI could correspond to the PDCCH(s)/DCI that carries part 2.
Yet for another example, the reference DCI could correspond to the PDCCH(s)/DCI that carries either part 1 or part 2 that is received earlier in time.
Yet for another example, the reference DCI could correspond to the PDCCH(s)/DCI that carries either part 1 or part 2 that is received later in time.
Yet for another example, the reference DCI could correspond to the PDCCH(s)/DCI(s) that carries either part 1 or part 2 that is transmitted earlier in time.
Yet for another example, the reference DCI could correspond to the PDCCH(s)/DCI(s) that carries either part 1 or part 2 that is transmitted later in time.
Yet for another example, the reference DCI could correspond to the PDCCH(s)/DCI(s) that carries either part 1 or part 2 that has a lower starting or ending frequency(-domain) resource index/ID, wherein the starting/ending frequency(-domain) resource index/ID could be the starting/ending RB or PRB index/ID, the starting/ending frequency subband index/ID and/or etc.
Yet for another example, the reference DCI could correspond to the PDCCH(s)/DCI(s) that carries either part 1 or part 2 that has a larger starting or ending frequency(-domain) resource index/ID, wherein the starting/ending frequency(-domain) resource index/ID could be the starting/ending RB or PRB index/ID, the starting/ending frequency subband index/ID and/or etc.
Yet for another example, the reference DCI could correspond to the PDCCH(s)/DCI(s) that carries either part 1 or part 2 that has DL assignment.
Yet for another example, the reference DCI could correspond to the PDCCH(s)/DCI(s) that carries either part 1 or part 2 that does not have DL assignment.
Yet for another example, the reference DCI could correspond to the PDCCH(s)/DCI(s) that carries either part 1 or part 2 that indicates/provides update(s) of one or more TCI states.
Yet for another example, the reference DCI could correspond to the PDCCH(s)/DCI(s) that carries either part 1 or part 2 that indicates/provides TCI selection field and/or SRS resource set indicator field.
Yet for another example, the reference DCI could correspond to the PDCCH(s)/DCI(s) that carries either part 1 or part 2 that indicates/provides one or more particular DCI fields, based on, e.g., network's configuration(s)/indication(s) via higher layer RRC signaling(s)/parameter(s) and/or MAC CE command(s) and/or dynamic DCI based L1 signaling(s), and/or fixed rule(s) provided/specified in system specification(s).

For this case, the UE could start to use/apply the first TCI state(s) in part 1 and the second TCI state(s) in part 2 for transmitting/receiving UL/DL channels/signals in/on the corresponding/associated TX frequency subband(s) based on the beam application time determined/identified for/according to the reference DCI. With reference to FIG. 17, a conceptual example characterizing this design example is shown.

For a reference DCI determined/identified according to those specified herein in the present disclosure, when a UE would transmit a PUCCH with hybrid automatic repeat request acknowledgement (HARQ-ACK) information or a PUSCH with HARQ-ACK information corresponding to the reference DCI (e.g., carrying the first and/or second TCI state(s) and without DL assignment) or corresponding to the PDSCH scheduled by the reference DCI (e.g., carrying the first and/or second TCI state(s) and with DL assignment), the indicated first and/or second TCI state(s) could be applied starting from the first slot that is at least beamAppTime symbols after the last symbol of the PUCCH or the PUSCH. The first slot and the beamAppTime symbols could be both determined on the active BWP with the smallest subcarrier spacing (SCS) among the BWP(s) from the CCs applying the indicated first and/or second TCI state(s) that are active at the end of the PUCCH or the PUSCH carrying the HARQ-ACK information.

For a first reference DCI determined/identified according to those specified herein in the present disclosure, when a UE would transmit a PUCCH with HARQ-ACK information or a PUSCH with HARQ-ACK information corresponding to the first reference DCI (e.g., carrying the first TCI state(s) and without DL assignment) or corresponding to the PDSCH scheduled by the first reference DCI (e.g., carrying the first TCI state(s) and with DL assignment), the indicated first TCI state(s) could be applied starting from the first slot that is at least beamAppTime symbols after the last symbol of the PUCCH or the PUSCH. The first slot and the beamAppTime symbols could be both determined on the active BWP with the smallest SCS among the BWP(s) from the CCs applying at least the indicated first TCI state(s) that are active at the end of the PUCCH or the PUSCH carrying the HARQ-ACK information.

For a second reference DCI determined/identified according to those specified herein in the present disclosure, when a UE would transmit a PUCCH with HARQ-ACK information or a PUSCH with HARQ-ACK information corresponding to the second reference DCI (e.g., carrying the second TCI state(s) and without DL assignment) or corresponding to the PDSCH scheduled by the second reference DCI (e.g., carrying the second TCI state(s) and with DL assignment), the indicated second TCI state(s) could be applied starting from the first slot that is at least beamAppTime symbols after the last symbol of the PUCCH or the PUSCH. The first slot and the beamAppTime symbols could be both determined on the active BWP with the smallest SCS among the BWP(s) from the CCs applying at least the indicated second TCI state(s) that are active at the end of the PUCCH or the PUSCH carrying the HARQ-ACK information.

As specified herein in the present disclosure, the frequency-selective beam indication for FSBM including association/mapping between the configured/activated/indicated joint/DL/UL TCI state(s) and the TX frequency subband(s), and the corresponding signaling design/support including the two-part DCI structure/format for frequency-selective beam indication, could be extended/applied to associating/signaling the configured/activated/indicated joint/DL/UL TCI state(s) to/for one or more different/separate sets of time-domain resources. For instance, in/for the one or more discussed design examples herein and the corresponding two-part DCI design for frequency-selective beam indication, a TX frequency subband can be replaced by a set of one or more continuous and/or non-continuous time-domain resources, wherein a time-domain resource could correspond to a symbol, a slot and/or etc., and each set of the time-domain resources could be provided/indicated/configured to the UE via higher layer RRC signaling(s)/parameter(s) and/or MAC CE command(s) and/or dynamic DCI based L1 signaling(s)—e.g., via/by the TD-RA field in the corresponding DCI format; for this case, each of the configured/activated/indicated joint/DL/UL TCI state/set of TCI states as specified herein in the present disclosure could be corresponding/associated to one or more sets of time-domain resources following the method(s)—and therefore, the corresponding signaling(s) support such as the two-part beam indication DCI design and/or etc.—specified herein in the present disclosure for associating the configured/activated/indicated joint/DL/UL TCI state(s) to the TX frequency subband(s).

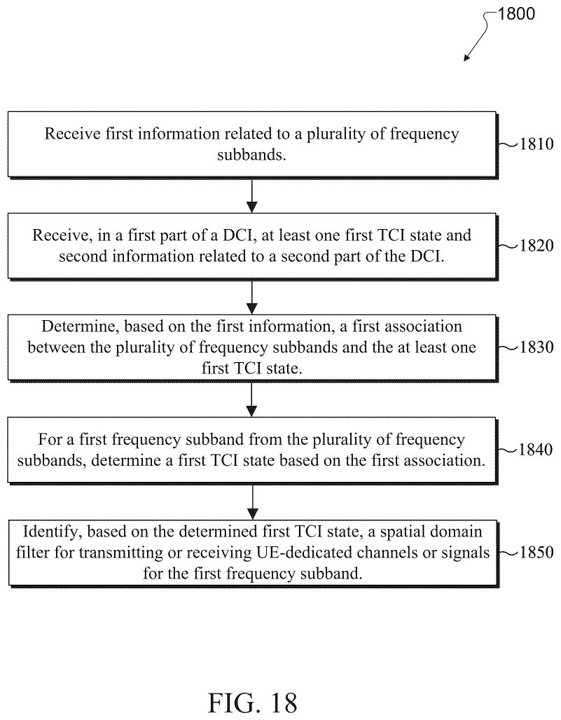

FIG. 18 illustrates a flowchart of an example method 1800 performed by UE according to embodiments of the present disclosure. For example, the method 1800 can be performed by the UE 116 of FIG. 3 and an analogous or commentary procedure may be performed by a BS such as BS 102 of FIG. 2. This example is for illustration only and other embodiments can be used without departing from the scope of the present disclosure.

The method 1800 begins with the UE receiving first information related to a plurality of frequency subbands (1810). In various embodiments, the first information comprises at least one of a number of the plurality of frequency subbands; time or frequency domain resources for each of the plurality of frequency subbands; a number of PRBs for each of the plurality of frequency subbands; at least one indicators indicating frequency domain locations of the plurality of frequency subbands; and at least one indexes indicating each of the plurality of frequency subbands.

The UE then receives, in a first part of a DCI, at least one first TCI state and second information related to a second part of the DCI (1820). For example, in 1810, the at least one first TCI state is indicated by a TCI codepoint of a TCI field or by separate TCI fields.

In various embodiments, the second information includes at least one of a one-bit indicator indicating a presence or absence of the second part, a payload size of the second part, a number of at least one second TCI states in the second part, information related to time or frequency domain resources of the second part, and a minimum time offset. In various embodiments, when the second information includes the minimum time offset, the UE monitors the second part after the minimum time offset starting from a last symbol or slot from reception of the first part. In various embodiments, the UE receives the first and second parts of the DCI in a slot. In various embodiments, the UE monitors the first and second parts of the DCI, in same or separate PDCCH candidates, in same or separate search space sets, or in same or separate CORESETs.

The UE then determines, based on the first information, a first association between the plurality of frequency subbands and the at least one first TCI state (1830). The UE then determines, for a first frequency subband from the plurality of frequency subbands, a first TCI state based on the first association (1840). The UE then identifies, based on the determined first TCI state, a spatial domain filter for transmitting or receiving UE-dedicated channels or signals for the first frequency subband (1850).

In various embodiments, the UE receives, in the second part of the DCI, at least one second TCI state; determines, based on the first information, a second association between the plurality of frequency subbands and the at least one second TCI state; for a second frequency subband from the plurality of frequency subbands; determines a second TCI state based on the second association; and identifies, based on the determined second TCI state, a spatial domain filter for transmitting or receiving UE-dedicated channels or signals for the second frequency subband. The at least one second TCI state is indicated by a TCI codepoint of a TCI field or by separate TCI fields.

The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the figures illustrate different examples of user equipment, various changes may be made to the figures. For example, the user equipment can include any number of each component in any suitable arrangement. In general, the figures do not limit the scope of the present disclosure to any particular configuration(s). Moreover, while figures illustrate operational environments in which various user equipment features disclosed in this patent document can be used, these features can be used in any other suitable system.

Although the present disclosure has been described with exemplary embodiments, various changes and modifications may be suggested to one skilled in the art. It is intended that the present disclosure encompass such changes and modifications as fall within the scope of the appended claims. None of the descriptions in this application should be read as implying that any particular element, step, or function is an essential element that must be included in the claims scope. The scope of patented subject matter is defined by the claims.

What is claimed is:

1. A user equipment (UE), comprising:
a transceiver configured to:
receive first information related to a plurality of frequency subbands; and
receive, in a first part of a downlink control information (DCI), at least one first transmission configuration indication (TCI) state and second information related to a second part of the DCI; and
a processor operably coupled with the transceiver, the processor configured to:
determine, based on the first information, a first association between the plurality of frequency subbands and the at least one first TCI state;
for a first frequency subband from the plurality of frequency subbands, determine a first TCI state based on the first association; and
identify, based on the determined first TCI state, a spatial domain filter for transmitting or receiving UE-dedicated channels or signals for the first frequency subband,
wherein the at least one first TCI state is indicated by a TCI codepoint of a TCI field or by separate TCI fields.

2. The UE of claim 1, wherein the first information comprises at least one of:
a number of the plurality of frequency subbands;
time or frequency domain resources for each of the plurality of frequency subbands;
a number of physical resource blocks (PRBs) for each of the plurality of frequency subbands;
at least one indicators indicating frequency domain locations of the plurality of frequency subbands; and
at least one indexes indicating each of the plurality of frequency subbands.

3. The UE of claim 1, wherein the second information includes at least one of:
a one-bit indicator indicating a presence or absence of the second part;
a payload size of the second part;
a number of at least one second TCI states in the second part;
information related to time or frequency domain resources of the second part; and
a minimum time offset.

4. The UE of claim 3, wherein, when the second information includes the minimum time offset, the processor is further configured to monitor the second part after the minimum time offset starting from a last symbol or slot from reception of the first part.

5. The UE of claim 1, wherein the transceiver is further configured to receive the first and second parts of the DCI in a slot.

6. The UE of claim 1, wherein the processor is further configured to monitor the first and second parts of the DCI:
in same or separate physical downlink control channel (PDCCH) candidates;
in same or separate search space sets; or
in same or separate control resource sets (CORESETs).

7. The UE of claim 1, wherein:
the transceiver is further configured to receive, in the second part of the DCI, at least one second TCI state; and
the processor is further configured to:
determine, based on the first information, a second association between the plurality of frequency subbands and the at least one second TCI state;
for a second frequency subband from the plurality of frequency subbands, determine a second TCI state based on the second association; and
identify, based on the determined second TCI state, a spatial domain filter for transmitting or receiving UE-dedicated channels or signals for the second frequency subband,
the at least one second TCI state is indicated by a TCI codepoint of a TCI field or by separate TCI fields.

8. A base station (BS), comprising:
a transceiver configured to:
transmit first information related to a plurality of frequency subbands; and
transmit, in a first part of a downlink control information (DCI), at least one first transmission configuration indication (TCI) state and second information related to a second part of the DCI; and
a processor operably coupled with the transceiver, the processor configured to:
determine, based on the first information, a first association between the plurality of frequency subbands and the at least one first TCI state;
for a first frequency subband from the plurality of frequency subbands, determine a first TCI state based on the first association; and
identify, based on the determined first TCI state, a spatial domain filter for transmitting or receiving user equipment (UE)-dedicated channels or signals for the first frequency subband,
wherein the at least one first TCI state is indicated by a TCI codepoint of a TCI field or by separate TCI fields.

9. The BS of claim 8, wherein the first information comprises at least one of:
a number of the plurality of frequency subbands;
time or frequency domain resources for each of the plurality of frequency subbands;
a number of physical resource blocks (PRBs) for each of the plurality of frequency subbands;
at least one indicators indicating frequency domain locations of the plurality of frequency subbands; and
at least one indexes indicating each of the plurality of frequency subbands.

10. The BS of claim 8, wherein the second information includes at least one of:
a one-bit indicator indicating a presence or absence of the second part;
a payload size of the second part;
a number of at least one second TCI states in the second part;
information related to time or frequency domain resources of the second part; and
a minimum time offset.

11. The BS of claim 10, wherein, when the second information includes the minimum time offset, the transceiver is further configured to transmit the second part after the minimum time offset starting from a last symbol or slot from transmission of the first part.

12. The BS of claim 8, wherein the transceiver is further configured to transmit the first and second parts of the DCI in a slot.

13. The BS of claim 8, wherein the transceiver is further configured to transmit the first and second parts of the DCI:
in same or separate physical downlink control channel (PDCCH) candidates;
in same or separate search space sets; or
in same or separate control resource sets (CORESETs).

14. The BS of claim 8, wherein:
the transceiver is further configured to transmit, in the second part of the DCI, at least one second TCI state; and
the processor is further configured to:
determine, based on the first information, a second association between the plurality of frequency subbands and the at least one second TCI state;
for a second frequency subband from the plurality of frequency subbands, determine a second TCI state based on the second association; and
identify, based on the determined second TCI state, a spatial domain filter for transmitting or receiving UE-dedicated channels or signals for the second frequency subband,
the at least one second TCI state is indicated by a TCI codepoint of a TCI field or by separate TCI fields.

15. A method performed by a user equipment (UE), the method comprising:
receiving first information related to a plurality of frequency subbands;
receiving, in a first part of a downlink control information (DCI), at least one first transmission configuration indication (TCI) state and second information related to a second part of the DCI;
determining, based on the first information, a first association between the plurality of frequency subbands and the at least one first TCI state;
for a first frequency subband from the plurality of frequency subbands, determining a first TCI state based on the first association; and
identifying, based on the determined first TCI state, a spatial domain filter for transmitting or receiving UE-dedicated channels or signals for the first frequency subband,
wherein the at least one first TCI state is indicated by a TCI codepoint of a TCI field or by separate TCI fields.

16. The method of claim 15, wherein the first information comprises at least one of:
a number of the plurality of frequency subbands;
time or frequency domain resources for each of the plurality of frequency subbands;
a number of physical resource blocks (PRBs) for each of the plurality of frequency subbands;
at least one indicators indicating frequency domain locations of the plurality of frequency subbands; and
at least one indexes indicating each of the plurality of frequency subbands.

17. The method of claim 15, wherein the second information includes at least one of:
a one-bit indicator indicating a presence or absence of the second part;
a payload size of the second part;
a number of at least one second TCI states in the second part;
information related to time or frequency domain resources of the second part; and
a minimum time offset.

18. The method of claim 17, further comprising, when the second information includes the minimum time offset, monitoring the second part after the minimum time offset starting from a last symbol or slot from reception of the first part.

19. The method of claim 15, wherein the first and second parts of the DCI are received in a slot.

20. The method of claim 15, further comprising monitoring the first and second parts of the DCI:
in same or separate physical downlink control channel (PDCCH) candidates;
in same or separate search space sets; or
in same or separate control resource sets (CORESETs).
